(19) United States
(12) Patent Application Publication
(10) Pub. No.: US 2009/0199113 A1
(43) Pub. Date: Aug. 6, 2009

(54) Graphical user interfaces

(75) Inventors: Peter Malcolm McWhinnie, London (GB); Michael Patrick Scott, London (GB)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Torridon Solutions Limited, London (GB)

(21) Appl. No.: 12/286,610

(22) Filed: Oct. 1, 2008

(30) Foreign Application Priority Data
Oct. 1, 2007 (GB) 0719129.9

(51) Int. Cl. G06F 3/048

(52) U.S. Cl. 715/762

(57) ABSTRACT

A Graphical User Interface (GUI) for use in project management is described. The GUI comprises: an interface module arranged to receive low-level user information relating to project events and high-level information relating to at least one project overview attribute; and a page generation module arranged to generate on a single hierarchical display page of the GUI: a structured detailed view portion for displaying editable project details within a data compilation with the low-level event-related user information represented as graphical components within the data compilation; and a management overview portion for displaying an editable project overview with the high-level information provided therein.

### FIELD OF THE INVENTION

The present invention concerns improvements relating to Graphical User Interfaces (GUIs) and more particularly, though not exclusively, to the manner in which non-predetermined quantities of information are handled efficiently and effectively by information handling procedures in a GUI. The present invention which has several aspects also concerns obtaining low-cost accurate representations of the GUI images and to reporting on dynamic elements of the components of the GUI at various time intervals. The present invention is described in the context of a project management application and has specific advantages in this context. However, it is to be appreciated that certain aspects of the present invention are application independent and can be applied to the management of any multiple-event process.

### BACKGROUND OF THE INVENTION

Project management capabilities are seen by many as critical to the success of companies and institutions of all sizes. While there is an abundance of project management software in the market, there remain a number of issues with its design. While much of the available software is well suited to the needs of complex IT or engineering projects, there is nothing that effectively targets the needs of middle/junior managers and their superiors. For this audience, at a high level the available software tends to: be over complicated given the scale and complexity of the projects that these people get involved in; require significant training (often a few days) for the user to grasp how to work around the complexity of the software; and be focused on the planning, scheduling and resourcing of activities, versus other important aspects of project management.

As a result, the majority of these managers use Microsoft Excel® or PowerPoint® for project management and communication, and others may be dedicated project management software in combination with Microsoft PowerPoint®.

With the available tools, project managers (and more specifically middle/junior managers who are running projects), face a number of issues when they are planning, implementing and communicating about their projects which are listed below:

1. Losing Sight of the Big Picture and Focusing on Activities Rather than Deliverables.

Project plans, and project management software, generally focus on the activities that are required to deliver the desired result and a key output is typically a GANTT chart detailing the start and end dates of the key activities (see FIG. 1).

FIG. 1 shows a screen print from a project management program, Microsoft Project®. This program is used to receive and present information relating to project scheduling and management in the form of a GANTT chart 1. A GANTT chart is a type of bar chart that is commonly used to illustrate a project schedule. It comprises a list of tasks (events) 2 along a y-axis and a timeline 3 along an x-axis. Different sized graphical components 4 are provided along the timeline 3 indicating the duration of each task (event) 2. One task is provided per row and the interaction dependence between tasks can be seen through the use of linking arrows 5. Textual information 6 is also provided to indicate who is responsible for the task. The start and finish dates and the duration values of each task are also provided numerically 7 with each task.

A problem with GANTT charts is that they become quite unwieldy for projects having a large number of activities. This is because there is a large amount of information on display, per page, at any one time, and so to fit all this information in, the size of the graphical components 4 displayed on screen/printed out need to be very small. In particular, larger GANTT charts tend not to be suitable for most computer displays, and projects are often more complicated than can be communicated effectively with a GANTT chart. This is a well documented problem—see for example a Wikipedia article in Annex A.

Whilst breaking down and scheduling activities is clearly important, this focus on activities does not touch on one of the most important factors driving the success of any project or initiative, which is to have clarity about the objectives, deliverables and measures of success. More specifically, this activity emphasis in project plans and project management software has two significant problems:
a. It contributes to a lack of clarity about “the big picture” since firstly, the projects objectives, deliverables and measures of success may not be “kept in mind” (or developed at all) when the project manager works on the timeline of activities, and secondly, the tendency is to develop a detailed list of activities, and get lost in the detail, rather than develop something at a higher level which conveys the overall picture of what needs to get done.
b. It encourages an activity mindset rather than a “deliverables” or output-focused mindset. At the level below the overall project, it is very important that project managers have a clear idea about the physical (or intangible) deliverables from each broad activity and how these fit together. This deliverable focus, or “product based planning”, is present in some software tools as a WBT (Work Breakdown Structure), but the tools tend to be too complex for the target users and they don't tie the activities to the deliverables in one view to ensure they are kept in mind.

2. Challenges with the Communication of Plans and Progress.

There is a “disconnect” between the world of project management software and the world of communication and communication software. With bespoke project management software (or with Microsoft Excel®, which is used by many managers to create GANTT charts and plans), typically the user first creates the plan, and then they have to figure out how to format it to fit to a page for printing out, or how to adapt it to fit into Microsoft PowerPoint® which is typically used for communication. This dual focus on content (what should we be doing?) and formatting (how can I make this fit on a page/look good?) distracts from clear thinking when creating a plan and the formatting requirements can be very time consuming. For example, many managers resort to doing things twice: once in project management software of some form (or Microsoft Excel®) and a second time creating a more succinct (and better looking) plan in PowerPoint®.

3. Plans are Hard and Time-Consuming to Update.

It is very common for the scope and timing of projects to change once they are underway, which in theory requires that the project manager update their plan or create a new one. Many managers find GANTT charts (either in software tools or if made in Excel® or PowerPoint®) hard to update quickly, often because the original plans have been quite detailed, and it is very common for the plan to fall into disuse as a project progresses. When plans are updated, it can be very time-consuming especially if the project manager is using both a GANTT chart in Excel® (or other software) and PowerPoint®. For example, in the situation where one month gets added to the project duration and a couple of new activities are added to the plan:
a. If the project manager has an Excel® GANTT chart and is using PowerPoint® for communication: first they have to update the GANTT chart, adding extra columns to the right of the timeline; then they would need to move around the timing of existing activities and add the new ones which is done by unshading/shading individual or groups of cells, and then they would need to either copy/paste the Excel® GANTT chart into PowerPoint® (or create a simpler version in PowerPoint®). By adding extra columns to the timeline to add the extra month, the horizontal vs vertical dimensions of the GANTT chart will have changed which may lead to formatting issues when pasted into PowerPoint®, and therefore require additional work to get it to look “right”.
b. If the project timeline/GANTT chart has been created in PowerPoint®, then the user will likely have to resize and move every element on the chart which, for a timeline of any complexity, can literally take hours.

4. Adapting the Plan to the Needs of Different Audiences.

Project managers typically need to deal with a variety of different stakeholders, each of which has a different perspective and different needs. The need to tailor a plan (or presentations) for different audiences places a significant burden on the project manager. For example:
a. Stakeholders are likely to need a high level plan which communicates the objectives and broad scope of the project (the “big picture”);
b. Senior management also need a high-level plan and a focus on any actions that they may need to take to drive/support the project;
c. The project team need something much more specific which focuses on the actions required to move things forward, responsibilities and deadlines.

As a result, Excel® (or other software) GANTT charts or PowerPoint® slides may be worked and reworked to get something to the right level of detail, or, more commonly perhaps, an output is used that is not well tailored to the needs of the audience.

5. Connecting the Plan to Meetings.

In many organisations, it is in meetings that many projects are driven forward. For example, the project team will meet, review progress, agree actions and when to meet again. If the team is being diligent, meetings are minuted and action points are circulated either in an email or often in a Word document attached to an email. The project manager then has to update his plan with the new actions to keep the plan up to date, or, more commonly the project plan falls into disuse and the project is driven forward through the meeting agendas and minutes etc. There are several problems with this approach. Firstly, if the project manager is keeping the plan up to date the retyping of meeting action points is “double work” and a waste of valuable time. Secondly, where the plan falls into disuse, the team may lose sight of the big picture, start to overlook other things they should be doing and generally go off track. Thirdly, it also becomes harder and harder for management to provide effective oversight.

6. Printing Colour Charts in Black and White.

When people create Timeline charts in PowerPoint® they often use colours to distinguish between different activities/or stages of a project. The chart may look good on the screen and on a colour printer, but when it gets photocopied or printed out in Monochrome (typically black and white), the colour distinctions are lost and the project manager either has to proceed with printed output, which does not communicate what they want, or they have to go back to PowerPoint® and shade things differently which takes additional time and re-work.

Aside from the above-described specific problems, there is an overarching need for simplicity and flexibility in providing a project management tool. In many, and probably most, “management projects” (as opposed to engineering or IT projects), the project direction and the work required are apt to change as the project unfolds and as the team's and management's thinking evolves. This invalidates the concept of “detailed planning” from the beginning to end of a project and places a premium on having a simple and flexible plan which focuses on objectives and deliverables and which can be easily updated and communicated, highlighting the importance of points 1 to 6 above. Further, given pressures on management time, a software tool that requires very little training would offer benefits over existing software tools.

The currently available software solutions, which clearly have some advantages but which do not address the issues set out above, are now described in greater detail below.

Microsoft Project® which is regarded by many as the market leader, is a heavily featured product with lots of functionality around activity scheduling and resourcing. Whilst clearly a great product for complex IT or engineering projects and many other situations, it generally considered to be over-complex and not well suited to middle/junior management needs. There are several disadvantages which are described below:
a. It has a strong focus on activity scheduling and resourcing but it does not directly address project level objectives, deliverables and success metrics, nor does it directly focus on the deliverables from key activities.
b. Its main output, the GANTT chart, tends to be made over-detailed by users, it does not fit to a page automatically, it is not in a format that many people find great for communication, and there is limited flexibility to tailor the outputs for different audiences. As a result, typically, users will have to produce their Microsoft Project® plan and also spend time creating PowerPoint® charts to communicate their plans and progress
c. There is no functionality around meeting agendas/minutes.
d. It requires at least one day training, and is seen by many as a tool that needs to be used relatively frequently for skills to stay fresh.

As a result, with this software tool, users run into most of the problems highlighted earlier. Overall, it is regarded by most people as “too much” and “too complicated” for the kind of projects they get involved in.

Much of the other desktop project management software (e.g. P2Ware®, @Task®, Fasttrack Schedule 9®, etc) is generally derivative of Microsoft Project® either adding more functionality and complexity, or aiming to simplify aspects of its resource planning and scheduling functionality. As a rule, this software is pretty similar in scope and complexity to Microsoft Project® and therefore suffers from the same associated problems, from the perspective of middle/junior managers.

Web-based software (e.g. BaseCamp®, E-Project®, Centraldesktop®, Quickbase® etc) comes in a variety of forms ranging from simple to-do lists to “Microsoft Project® on the web”. These tools are good for collaboration and sharing content with users in different geographic locations, but the format of the content is very traditional: GANTT charts, to do lists, resourcing spreadsheets etc. Again, typically there isn't a focus on objectives and deliverables so it is easy for users to lose sight of the big picture, they are not well set up for delivering content into PowerPoint® (which is the presentation tool of choice) and so users need to work separately in PowerPoint® to communicate to different audiences, and there is no tie-in to meeting agendas and minutes.

Considering Microsoft Excel® and PowerPoint® (since most managers are using a combination of them for creating, communicating and managing their project plans), these tools are completely flexible and can be “made to work”. However, there are many inefficiencies with their use. For example: Excel® and PowerPoint® lack an “in built” project management structure to guide peoples' thinking, so the user is reliant on their own capabilities and significant time can be spent even on very basic formatting issues. Time is often wasted in creating plans in Excel®, and then recreating elements of them in PowerPoint® for communication to the team or to management; Plans made in Excel® can be hard to integrate into other products such as Word or PowerPoint® as copy/paste can lead to formatting issues (i.e. how do I get it to fit on a page?). Further, GANTT charts made in Excel® are often too detailed and are hard to update when events during a project change, as they inevitably do.

Overall, alone, or in combination, using Excel® and PowerPoint® for project plans leads to all of the problems highlighted earlier.

It is desired to overcome or at least substantially reduce at least some of the above described different problems.

### SUMMARY OF THE INVENTION

In order to address these needs and to overcome at least some of the above-described problems, the present invention has been developed and is embodied, within the field of project management, in a simple, visually compelling and powerful project management software product specifically targeting the needs of managers (from junior/middle up to executives) and the small, fast changing projects that they typically get involved in. There are several different aspects of the present invention which each in turn address at least one of the above described problems.

More specifically, according to one aspect of the present invention there is provided a Graphical User Interface (GUI) for use in project management, the GUI comprising: an interface module arranged to receive low-level user information relating to project events and high-level information relating to at least one project overview attribute; and a page generation module arranged to generate on a single hierarchical display page of the GUI: a structured detailed view portion for displaying editable project details within a data compilation with the low-level event-related user information represented as graphical components within the data compilation; and a management overview portion for displaying an editable project overview with the high-level information provided therein.

The benefits of this hierarchical display of information within a single page of the GUI are multiple. For example, when in a timeline view, it gives the user a conceptual framework within which they can quickly and easily think about and create the “big picture view” of what needs to be achieved and how. Also it allows the user to keep the high-level information about the project's direction in sight and in mind as they work to create more detailed elements of the project (e.g. the timeline, the action points etc). Further it facilitates upward and downward communication to give clarity about the overall project direction, thereby improving management oversight, and stakeholder and team member understanding. Finally, from a senior manager's perspective, the timeline gives them a view which allows them to see and understand the project at the right level of detail, and then track and control progress. They can also drill in to see more detail as desired by looking at other views.

According to a second aspect of the present invention there is provided a Graphical User Interface (GUI) arranged to receive user information and display graphical components corresponding to the received user information, the GUI comprising: a page display module for displaying at least one page, each page being directly representative of a corresponding output page and comprising a plurality of existing graphical components; an interface module arranged to receive user information generated by user interaction with the GUI; and a presentation module arranged, in response to the received user information, to generate new graphical components to be displayed on the at least one page and to size and arrange the new and existing graphical components in a display configuration on the at least one page, the presentation module being arranged to: calculate a minimum number of pages required to accommodate the new and existing graphical components to be displayed in the display configuration, the graphical components having size attributes at a chosen minimum limit; and set the size attributes of the new and existing graphical components from between the minimum limit and a chosen maximum limit to maximise the space occupied by the graphical components on the calculated minimum number of pages; wherein the page display module is further arranged to display all the graphical components with the size attributes, determined by the presentation module, on the minimum number of pages.

Thus, the GUI provides the advantage of maximising the visual effectiveness of user-inputted information which is automatically sized and arranged into a presentable format. This is because the GUI displays graphical information page-wise, and performs checks to simultaneously ensure that the number of display pages are minimised, the displayed set of graphic components fall between minimum and maximum size constraints and that the displayed set of graphical components take up as much room within the minimum number of pages as possible.

Clearly, one objective it to avoid overlapping of graphical components whilst presenting the desired information a concisely and clearly on a page as possible without the user being required to re-format the presented information for each change. The automatic handling of the presentational aspects obviates the need for a user inputting information to have to consider or spend time on presentational aspects of that information, and so makes information input and subsequent information review easier, thus leading to an improved interface between the user and the system.

Furthermore, because each GUI displayed page is directly representative of (exactly proportional to) a corresponding output page, the problems of using different software applications for generating suitable presentation output is overcome. The GUI shows the user an exact proportional image of what the output on a different medium such as a printer or projector will look like.

In one embodiment, the interface module is arranged to receive user information having user-defined numerical attributes and, in response, the page display module is arranged to generate corresponding graphical components each having a graphical attribute corresponding to the numerical attribute of the received information. The graphical attributes are calculated by the presentation module. In one embodiment, the numerical attribute is representative of time. In one embodiment, the GUI comprises a timeline such that the GUI can be used for the scheduling of events. In one embodiment, the graphical attribute corresponds to position along the timeline. In one embodiment, the GUI comprises a relational database arranged to store the received user information according to the user-defined numerical attributes.

Advantageously, the received user information containing numerical attributes improves the functionality of the GUI. This is because logical and numerically-based operations can be carried out on the information to provide the user with insight into the interaction between different events. For example, when the numerical attributes relate to time, scheduling calculations can reveal potential scheduling conflicts and event durations. Furthermore, graphical components representing user inputted information can be set out in non-overlapping positions relative to one another according to the associated numerical information, thereby presenting numerical data to a user in a way that can be intuitively interpreted.

In one embodiment, the graphical components comprise two-dimensional images. The graphical components may be sizable along first and/or second transversely extending axes. In one embodiment, the graphical attribute of at least one of the graphical components comprises the length of the graphical component along the first axis. In one embodiment, the size attribute of at least one of the graphical components comprises the length of the graphical component along the second axis. Advantageously, the graphical components being sizable along a first axis in response to a user-defined numerical attribute means that the visual arrangement of the graphical components along one axis is controlled by user input. This is particularly useful when considered alongside the arrangement of the graphical components being sizable along a second axis, transverse to the first, in response to size attributes set by the presentation module—in other words controlled In one embodiment in real time by the GUI, within constraints that are often controlled by the user Thus the first axis is in the domain of the user, and the second axis is primarily in the domain of the GUI. This promotes automatic sizing and arrangement of the graphical components to maximise the effectiveness of the information displayed (and minimising the time needed to be devoted by the user to presentational aspects) whilst at the same time granting the user control over the information. Here it is to be appreciated that in the embodiment described herein, the term ‘in real time’ has the meaning of being carried out in a fraction of a second.

In one embodiment, the presentation module is arranged to continuously size and arrange graphical components in response to user-inputted information. This has the advantage of dynamically formatting graphical components as more information is added or updated to provide a real-time view of the formatted graphical information.

In one embodiment, the GUI comprises an output module arranged to transmit selected output pages containing the first set of graphical components thereon in the display configuration as a data file for processing external to the GUI. In one embodiment, the output module comprises a print module arranged to transmit print instructions to a printer to print out the selected output pages. The output module thus provides a way of outputting the pages formatted to be suitable for presenting to a number of systems external to the GUI so as to assist information distribution. For example, the output module could export to a file compatible with a presentation show such as Microsoft PowerPoint® to be displayed as a slide show. Alternatively, the output module could write information directly to a printer to print the output pages onto hard copy.

At least two of the pages displayed by the page display module may comprise a formatting scale equal to one another. Thus when considering two output pages they will have the same scale and can be compared directly. In one embodiment, every page displayed by the page display module comprises a matching formatting scale. Advantageously, a uniform formatting scale for every page aids transition to other multiple page mediums which tend to be of the same size—for example printed media.

The graphical components may be one of a plurality of graphical component types, each component type being graphically distinguishable from another. Each graphical component type may represent a different type of information to be displayed. Each graphical component type may represent an event type, for example, an Activity Group, a meeting, a milestone, an action, an issue or a contact.

The presentation module may be arranged to allocate an individual display region for each graphical component type.

Each display region may be distributed along the length of the timeline. The interface module may comprise a controller arranged to receive and control input from a user and, in response thereto, to pass on information to other modules to control the display of each display region. The controller may be arranged to hide or reveal selected display regions.

The interface module may comprise a view selector arranged to receive a user view selection and present a view of a selected set of graphical components corresponding to a selection of the user inputted information. Advantageously, this allows selected information to be displayed, thereby promoting user focus onto the selected information. Minimising and compartmenting associated groups of information on one page, or series of pages in this way increases intelligibility of the presented information. It will be understood that a view may comprise one or a series of pages.

The view selector may be arranged to present a plurality of views. In one embodiment, the plurality of views are arranged in a hierarchy with at least one view being a generalised view, and another view being a specific view. The generalised view may be of a selected set of graphical components corresponding to a selection of user inputted information relating to general information. The specific view may be of a selected set of graphical components corresponding to a selection of user inputted information relating to information specific about selected general information.

The interface module may be arranged to receive only user information relating to general information when in the generalised view. The interface module may be arranged to receive only user information relating to a specific selection of the general information.

Advantageously, the receiving and/or presenting information in a hierarchical manner is more intuitive to a user inputting or considering the information. This improves the speed and effectiveness at which a user can input information into or understand information from the GUI.

In one embodiment, one or more graphical components may comprise a view selector. In one embodiment, a graphical component representing a piece of general information comprises a view selector which, when selected, triggers the page display module to generate a new page comprising a set of graphical components corresponding to specific information associated with the piece of general information.

According to a third aspect of the present invention there is provided a graphical user interface (GUI) arranged to receive user information about events and display graphical components relating to the information about events, the GUI comprising: a page display module arranged to display one or more pages each of a uniform predetermined dimension, each page comprising a timeline extending along a first axis; an interface module arranged to receive the user information relating to events having a time-related attribute and to generate graphical components corresponding to the received user information; and a presentation module arranged to position and size the graphical components along the timeline in dependence on the time-related attribute, and also position and size the graphical components along a second axis, in dependence on the number of graphical components and predetermined minimum and maximum size constraints associated with each of the graphical components so that the graphical components occupy maximum space within the one or more pages without exceeding the minimum and maximum size constraints.

According to a fourth aspect of the present invention there is provided a Graphical User Interface (GUI) for use in project management, the GUI comprising: an interface module arranged to receive user information relating to project events and user GUI control commands; a page generation module arranged to generate, on a first display page of the GUI, a timeline portion for displaying an editable project management timeline with the event-related user information represented as graphical components along the timeline; and an expanded detailed view module arranged to detect user-selection of a particular graphical component along the timeline via the interface module and to generate, for display on a second new display page relating to the specific event of the selected graphical component, an expanded timeline relating to the selected event and detailed user information items relating to the event not previously displayed by the first page.

There are various benefits to this aspect of the present invention, in that this hierarchical and configurable approach allows the user to have a timeline which communicates the big picture separately from more detailed information. Also by separating the lower level (the Activity Group Detail for example) from the timeline, it allows the user to get into more detail here than with other tools. For example, by enabling a focus on the activity's objectives and deliverables alongside the specifics of who needs to do what by when.

A further advantage is that it helps the user tailor their thinking and outputs for different situations and different audiences. For example the timeline is a great module/view for developing or communicating a high level/big picture view of the project plan and what needs to be achieved. This may be useful for senior management or stakeholder audiences. Also the Activity Group Detail maybe more helpful for working with the project team to ensure people are clear on exactly what needs to be achieved.

Overall the hierarchical and configurable approach simplifies the user interface at each level which contributes to ease of use and results in a low training requirement.

According to a fifth aspect of the present invention there is provided a Graphical User Interface (GUI) for use in project management, the GUI comprising: a displaying module arranged to display a plurality of different options for selecting a desired display view; an interface module arranged to receive a user-selected option for a desired display view; a database storing information regarding a plurality of different types of events, each type of event having a time-related attribute; a presentation module arranged to use the selected option to construct the selected display view from the stored information and to display the view; the view comprising one or more pages with each page including a timeline and graphical components representing the type of events related to the selected display view positioned along the timeline in dependence upon the time-related attribute.

The over-arching benefit of this function is that it allows quick and easy tailoring of the data display for different audiences and situations, and the ability to edit/add data in these different situations. For example: a four-week display by Activity Group can create clarity for the team and for over-seeing managers on what has to happen over the next few weeks. Alternatively, a four-week display by person is useful in a team context or in a one-to-one meeting to focus on the specific tasks and deliverables of each individual. Also the one-week display by person or by Activity Group for example allows a drill down into a shorter time period when a day-by-day focus is required.

According to a sixth aspect of the present invention there is provided a Graphical User Interface (GUI) for use in project management, the GUI comprising: a page display module arranged to display one or more pages, each page comprising a timeline extending along a first axis; an interface module arranged to receive user information relating to a plurality of different types of events, each type of event having a time-related attribute, and to generate graphical components corresponding to the received user information and identifying each of the plurality of different types of event; and a presentation module arranged to position the graphical components along the timeline in dependence on the time-related attribute, and also to position the graphical components along a second axis to avoid overlap of components having overlapping time-related attributes, wherein the presentation module is further arranged to position graphical components of different types of event in an interlaced manner along the second axis.

There are various benefits derived from the flexibility of having multiple configurable views of data from different levels of the project hierarchy. For example it makes it very easy for the user to change the “big picture” display of the timeline either according to their own taste, or to tailor the content for different audiences and different communication objectives. For example: some users may like the Standard timeline view with the key meetings and milestones at the top of the activity groups. Others may prefer not to separate out and display the key milestones and meetings and instead to show a timeline with meetings and milestones interlaced with the activity groups.

Also the standard timeline display may be used to convey the big picture to a senior audience, and the various interlaced views may be more useful for the project manager in developing the plan and making sure it all fits together, or in communicating and working with the project team. It allows the user to “drill in” or move back out to different levels of detail on an as needed basis, whilst still retaining a view of the overall “big picture” timeline. This makes it easier to add/edit lower level information than going somewhere else in a tool and then having to come back to the timeline.

The timeline view interlaced with deliverables is an example of how the application encourages users to be “output focused” in the development, communication and management of their plans.

According to a seventh aspect of the present invention there is provided a Graphical User Interface (GUI) for use in project management, the GUI comprising: a page display module arranged to display one or more pages; an interface module arranged to receive a plurality of user information items relating to project meetings and user GUI control commands; a presentation module arranged, to operate with the interface and display modules, to generate on a first display page a meeting agenda template or a minutes template for recording the information user items relating to project meetings, each template having a plurality of predefined regions for recording each different user information item; and recordal means for recording the plurality of information items to a database model, wherein the recordal means is arranged to map the information item recorded at each different predefined region to a corresponding predefined portion of the data model.

This function delivers various benefits. The main benefit is that is creates a strong link between meetings and the project plan which means that the project plan can be kept up-to-date without rework from the project manager, which in turn makes it more likely that the project plan will be kept up-to-date at all. Also with all the meetings agendas and minutes in the project file, they are also all in one place and are easy for the project manager or others to find. Furthermore, it also provides a simple way for users to create agendas and minutes, in a standard format, which will help people use these basic tools of meeting management more easily than creating them from scratch in word/email.

According to an eighth aspect of the present invention there is provided a report generation system arranged automatically to generate a status report regarding the management of a multiple event process occurring over time, the system comprising: a database storing a plurality of different event items, each item having a date and/or date range associated therewith, together with status information regarding the state of execution of the event; a timeframe determining means for determining a first timeframe from the time of generation of a previous status report to a present time, and a second timeframe from a present time to a next scheduled reporting time; an event item selection means for selecting a subset of events of the plurality of different event items stored in the database, which are required for the status report, the event item selection means being arranged to automatically select events from the relational database which have an end date within the first or second timeframes; a report generator arranged to extract information related to the selected events from the database that fall within the first or second timeframes and to generate a status report on the selected event items.

The above aspect of the present invention advantageously enables status report generation to be much simpler than before. The automated nature of the invention enables regular reports to be generated each of which is automatically directed to the relevant issues. Where the number of events is high, reporting becomes very complex and time consuming. The present invention greatly simplifies this often difficult task.

In the field of project management the in-built status reporting has a number of benefits. It encourages ongoing review of project performance and status which is a key factor in project management success and it creates an incentive to keep the project file up to date. Further the dynamic filtering function makes it quicker and easier for the user to identify topics that should be reported on, and thereby eases any perceived burden inherent in reporting on project status. Helpfully, the automated report generation makes sensible suggestions to the user.

Also by providing status reports in a consistent format, the present invention also facilitates management review and oversight.

The timeframe selection means may be arranged to generate a graphical user interface for user input and to present the determined timeframe to the GUI. Also the frame selection means may be arranged to enable the user via the GUI to adjust the first or second timeframes. This facilitates user interaction with the report before it is finalised and adjustment of the timeframes provides the ability to tailor the automatically generated draft report.

The event item selection means may be arranged to generate a graphical user interface for user input and to present the selected event items to the GUI. Also the event item selection means may be arranged to enable the user via the GUI to change the automatically selected event items. Here this facilitates user interaction with the items to be included in the report before it is generated such that the automatically generated list of types of events to be included in the report can be adjusted by the user to customise the report. This is a significant step away from the prior art where it is very complicated to even attempt to generate such a report. The user can thus tailor the report to include or exclude certain events.

The database may be arranged to store events which are either an activity event or a milestone event, and the event item selection means is arranged is arranged to select automatically activity events which fall within the first timeframe and milestone events which fall within either of the first and second timeframes. Advantageously, the use of two timeframes, as described above, allows two sequential periods to be reported that which is in the past, but the status of which has not yet been reported (i.e. before the report generation date), and that which is in the future, but needs to be presented for review and subsequent actioning.

In one embodiment, the reporting module is arranged to generate the status report in a tabular form for presentation on a GUI. This represents the most compact yet clear way of providing this information. The reporting module may be arranged to generate the status report with user-editable areas for user annotation of the report. Again this is helpful in enabling the user to customise the automatically generated report.

The status report may provide information on the start date associated with both the start and end dates associated with each listed event. For assessing the status of each event, it is useful to understand where that event resides in relation to its scheduled start end dates. This immediately enables the user to understand the timing status of the event itself which is particularly helpful for management purposes.

The report generator may be arranged to generate the report using a GUI as described previously. Here all of the benefits of the dynamic formatting of the report onto a single page In one embodiment can be obtained.

According to an alternative consideration of the eighth aspect of the present invention, there is provided a method of automatically generating a relevant status report regarding the management of a multiple event process occurring over time, the method comprising: storing a plurality of different event items in a database, each item having a date and/or date range associated therewith together with status information regarding the state of execution of the event; determining a first timeframe from the time of generation of a previous status report to a present time, and a second timeframe from a present time to a next scheduled reporting time; selecting a subset of events of the plurality of different event items stored in the database, which are required for the status report, the selecting step automatically selecting events from the relational database which have an end date within the first or second timeframes; extracting information related to the selected events from the database that fall within the first or second timeframes; and generating a status report on the selected event items.

According to a ninth aspect of the present invention there is provided a graphical user interface (GUI) arranged to receive user information and display graphical components corresponding to the received user information, the GUI comprising: a compilation module arranged to create output pages containing the graphical components thereon in a display configuration as a data file for processing external to the GUI; and a conversion module arranged to convert each coloured region of each graphical component into a corresponding monochrome patterned region; and storing means for storing the converted graphical components in the data file for output.

Advantageously, the conversion of colour into a monochrome pattern means that if the graphical component is printed using a monochrome printer or on a low-cost monochrome setting, information represented by the different colours of the graphical components would not be lost. Since each colour has a corresponding monochrome pattern, different coloured regions would be easily distinguishable from one another through the corresponding different monochrome patterns following conversion and printing on a monochrome printer. By providing an option which gives the user a “hashed” rather than a purely grey-scale output, users who wish to avoid the expense of having colour print-outs and colour copies, can be sure that their monochrome print outs will have legible distinctions between the different on-screen colours. This option also means the user will not have to re-colour or re-print their output when they find it doesn't work in monochrome, saving time and considerable hassle.

In one embodiment the GUI further comprises a look-up table having a set of unique monochrome patterned fill types, wherein each of the possible display colours can be uniquely mapped to a corresponding unique monochrome patterned fill type. Use of a look up table represents a fast convenient way of effecting the transformation between the colour fill value and the monochrome patterned fill value.

Alternatively some of the set of monochrome patterned fill types may include a solid fill type. It is possible in this case that a combination of patterned and solid fill types are present in the set of monochrome replacement fill types.

The ninth aspect of the present invention can alternatively be considered to be a method of creating a representation of user information received via a graphical user interface (GUI) and displayed as corresponding graphical components, the method comprising: creating output pages containing the graphical components thereon in a display configuration as a data file for processing external to the GUI; converting each coloured region of each graphical component into a corresponding monochrome patterned region; and storing the converted graphical components in the data file for output.

### BRIEF DESCRIPTION OF THE DRAWINGS

Embodiments of the present invention will now be described, by way of example only, with reference to the accompanying drawings in which:

FIG. 1 is an example of a typical GANTT chart of the prior art;

FIG. 2 is a schematic block diagram showing a computer system comprising a project management application according to one embodiment of the present invention;

FIG. 3 is a screenshot of a GUI generated by the project management application of FIG. 2, when a timeline module is activated;

FIG. 4 is an image of a timeline module page of the GUI of FIG. 3 illustrating a ‘What You See Is What You Get’ (WYSIWYG) output generated by the project management application;

FIG. 5 is an image of an action list module of the GUI of FIG. 3, illustrating a WYSIWYG output generated by the project management application of FIG. 2;

FIG. 6 is a schematic block diagram of a hierarchical arrangement of view modules of the project management application of FIG. 2;

FIG. 7 is a schematic block diagram showing the components of the project management application of FIG. 2 in greater detail;

FIG. 8 is a schematic block diagram illustrating the composition of a data model of the project management application of FIG. 2;

FIG. 9 is a collection of three images of a timeline module page of the GUI of FIG. 3, and resultant detailed timeline page views of specific activity group components generated on selection of that component;

FIG. 10 shows a more detailed version of one of the resultant detailed timeline page views shown in FIG. 9;

FIG. 11 is an image of an agenda view of a meeting module of the GUI of FIG. 3, illustrating a WYSIWYG output generated by the meeting module;

FIG. 12 is an image of a meeting minutes' view of a meeting module of the GUI of FIG. 3, illustrating a WYSIWYG output generated by the meeting module;

FIG. 13 is an image of an action list view of a meeting module of the GUI of FIG. 3, illustrating a WYSIWYG output generated by the meeting module;

FIG. 14a is a flow diagram showing a method of implementing a dynamic formatting process, which creates the dynamically resizing GUI shown in FIGS. 17a to 17e;

FIG. 14b is a flow diagram showing a dynamic formatting algorithm of the dynamic formatting process shown in FIG. 14a;

FIGS. 15a, 15b, 15c, 16a, 16b, 16c and 16d are images of a timeline view page showing how user interaction with the GUI generates various display configurations when implementing the dynamic formatting process of FIG. 14a;

FIGS. 17a, 17b, 17c, 17d and 17e are images of a timeline view page showing how user interaction with the GUI generates various display configurations in an interlaced mode;

FIGS. 18, 19a and 19b are images of a timeline view page showing an action list over time module of the project management application of FIG. 2;

FIGS. 20a, 20b and 20c are images of a status report view page showing how a user can tailor a specific automatically generated report using an interface module;

FIG. 21 is an image of a status report page generated by the report module of FIG. 6;

FIG. 22 is an image of a timeline view showing WYSIWYG views of the timeline module of FIG. 3 with coloured activity groups;

FIG. 23 is an image of a timeline view showing the result of outputting the data file representing the timeline view of FIG. 22 on a monochrome output device; and

FIG. 24 is an image of a timeline page showing a WYSIWYG view of the timeline module of FIGS. 22 and 23 when a conversion module of the project management application of FIG. 2 has been activated.

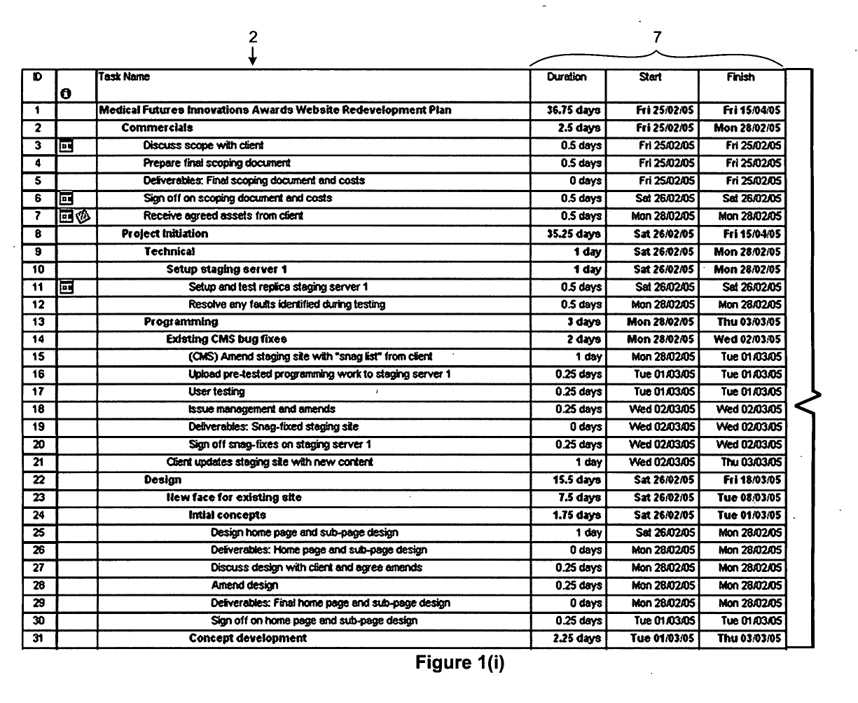

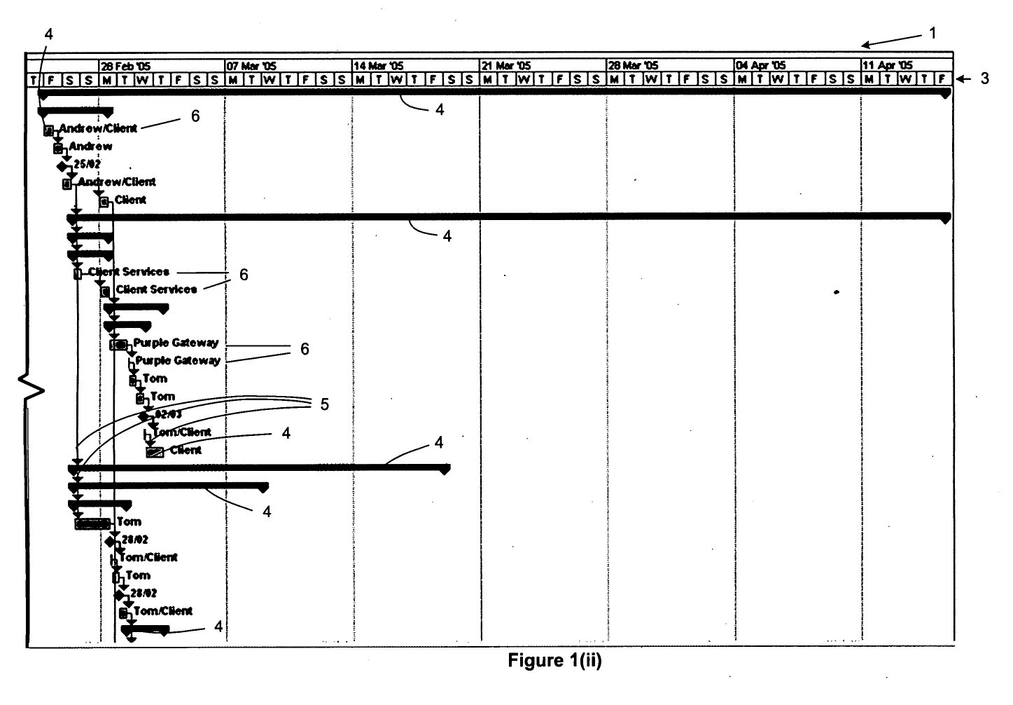

### DETAILED DESCRIPTION

An overview of a computer system running a project management application of the present embodiment is described below initially to provide the context of the embodiments of the present invention before explaining the embodiments of the present invention in detail. Whilst the present embodiment is described in the context of a project management application is to be appreciated that some aspects of the present invention can be used in other applications and are not to be considered to be limited to project management related uses.

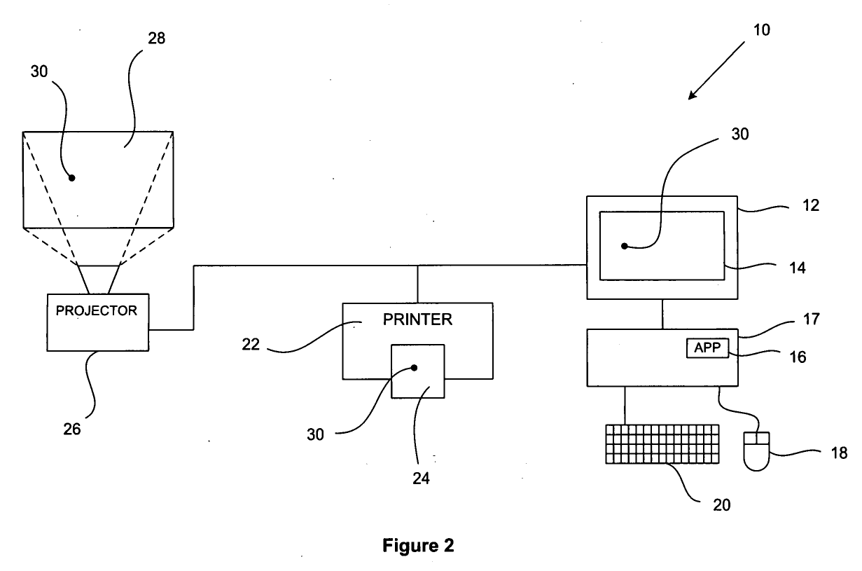

FIG. 2 shows a computer system 10 comprising a colour electronic display 12 on which a graphical user interface (GUI) 14 of a project management application 16 is displayed. The computer system 10 comprises a computer 17 for running an application 16, user input devices in the form of a mouse 18 and a keyboard 20 which are used by the user to provide inputs via the GUI 14 to the project management application 16. The computer system 10 also comprises a printer 22 which prints out onto A4 sized paper 24 (A4 size being of dimensions 162 mm by 297 mm), and also comprises a projector 26 which is arranged to project an electronic slideshow for viewing on a presentation area 28 by an audience of users.

In use, the user manipulates the mouse 18 and the keyboard 20 in order to input time-related information—for example, information about events and activities taking place during a project being managed by the user. The project management application 16 receives the information from the user, and then generates graphical components 30 (only one shown in FIG. 2) representative of the inputted information, formatted to be suitable for printing on the A4 (or other) sized paper 24 via the printer 22, or exported as a slideshow for viewing through the use of the projector 26. The GUI 14 comprises an output module (not shown) arranged to transmit a data file (not shown) for the purposes of exporting or printing to the projector 26 or printer 22.

It is to be understood that, in alternatives, the computer system 10 may comprise a network over which various components can communicate. For example, the project management application 16 may be run on a server, and accessed by a user through a client. Access may be over an intranet, via the Internet, and/or through another suitable communication system. In the case where the project management application 16 is run on a server, the GUI 14 may be presented to the user through a standard web-browser. The client computer may act as a dumb terminal. The printer 22 and the projector 26 may also be accessible via the network and do not necessarily have to be directly connected to the user's computer 17.

Whilst the present embodiment is described using A4 sized paper 24 in the printer 22, it is to be appreciated that different sizes of paper could be used (e.g. A3, A5, letter) with the knowledge that the GUI 14 will print out in the exact proportions seen on the screen whatever the size of paper being used. The design of the application 16 and the GUI 14 to be able to maintain the proportionality between the displayed image on the display 12 and in the output content, means that each displayed page of the GUI 14 is directly representative of a corresponding output page 22, 28. This is one notable feature of the present embodiment, which obviates the need for using additional software programs to generate an acceptable presentation output.

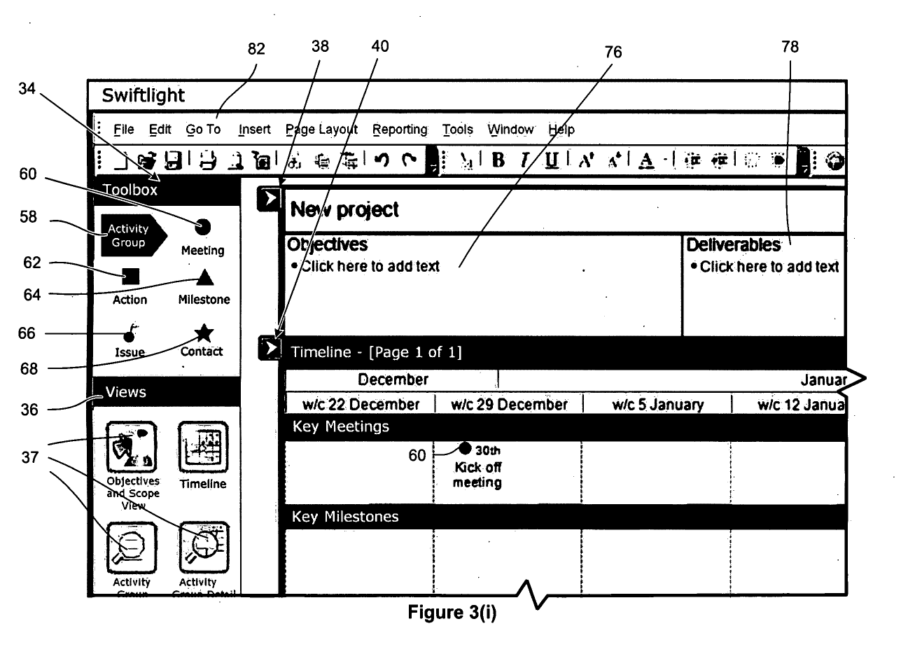

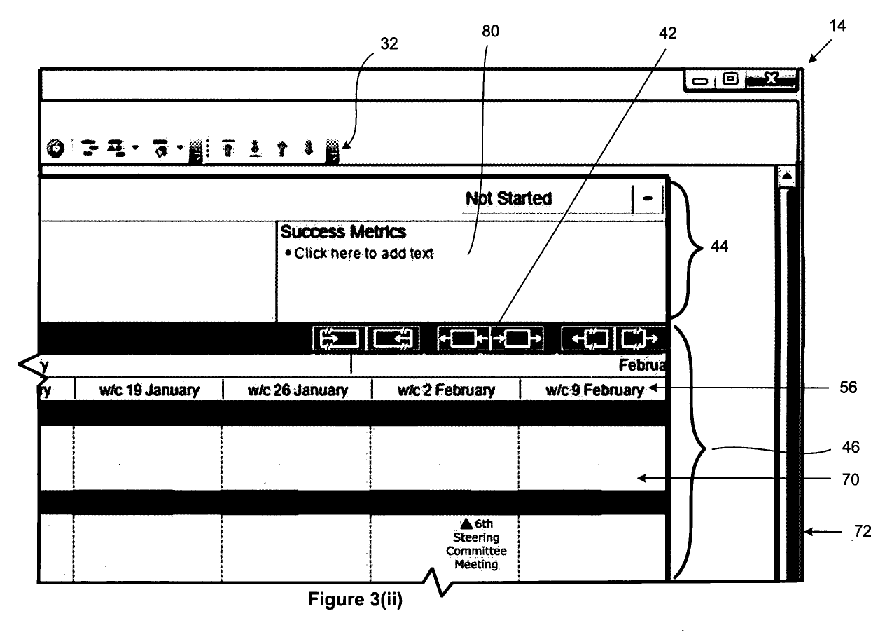

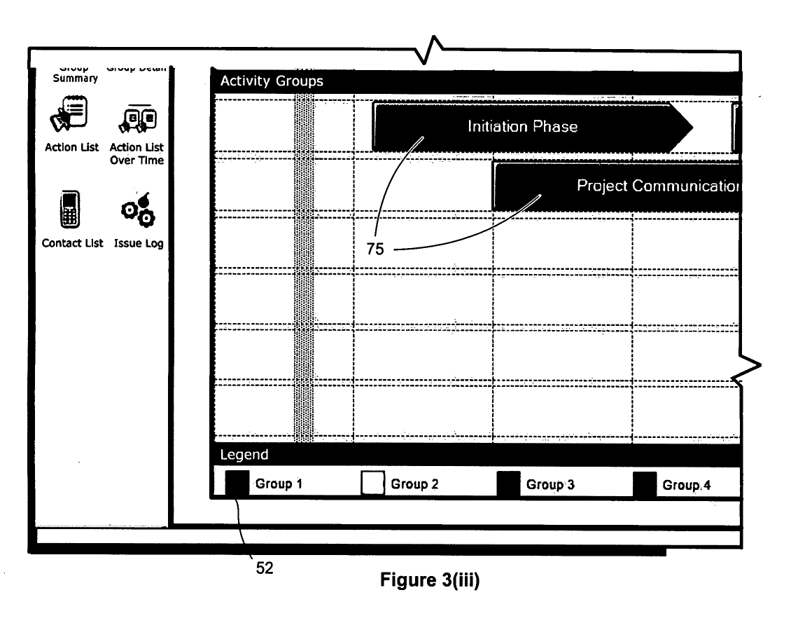

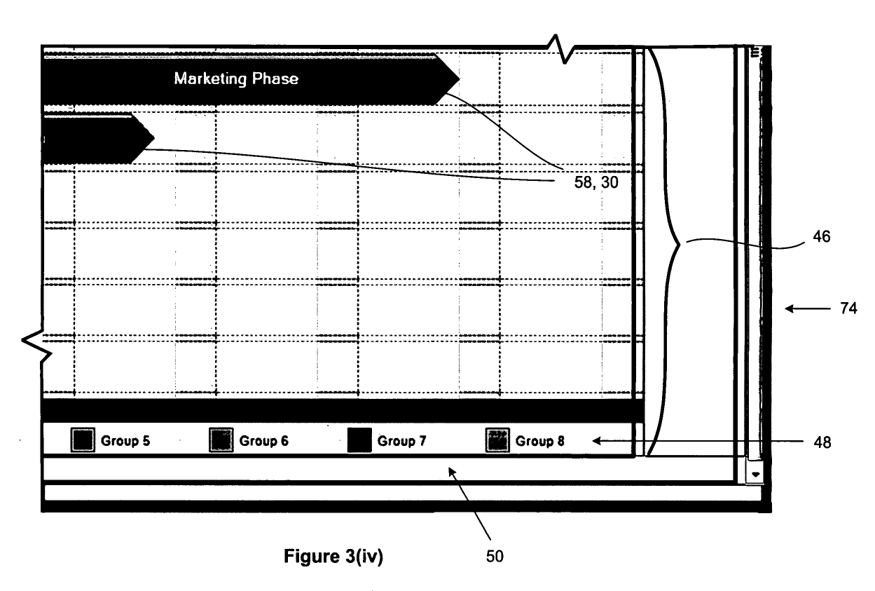

An explanation of how a user inputs project-related information is now described with reference to FIG. 3 where a screenshot of the GUI 14 generated by the project management application 16 is shown.

Referring to FIG. 3, the project management application 16 generates the GUI 14 which comprises a toolbar 32, a toolbox 34 which contains graphical representations of different elements to be used in the GUI 14, a view selector 36 presenting different view icons 37 for enabling user selection of one of several different GUI views, a header format controller button 38, a body format controller button 40, shortcut buttons 42, a page header 44, a page body 46, a legend 48 and a page delimiter 50.

The toolbar 32 can be selected by the user via the mouse 18 and/or keyboard 20 to carry out a number of functions such as opening, saving and closing files as is known in the art.

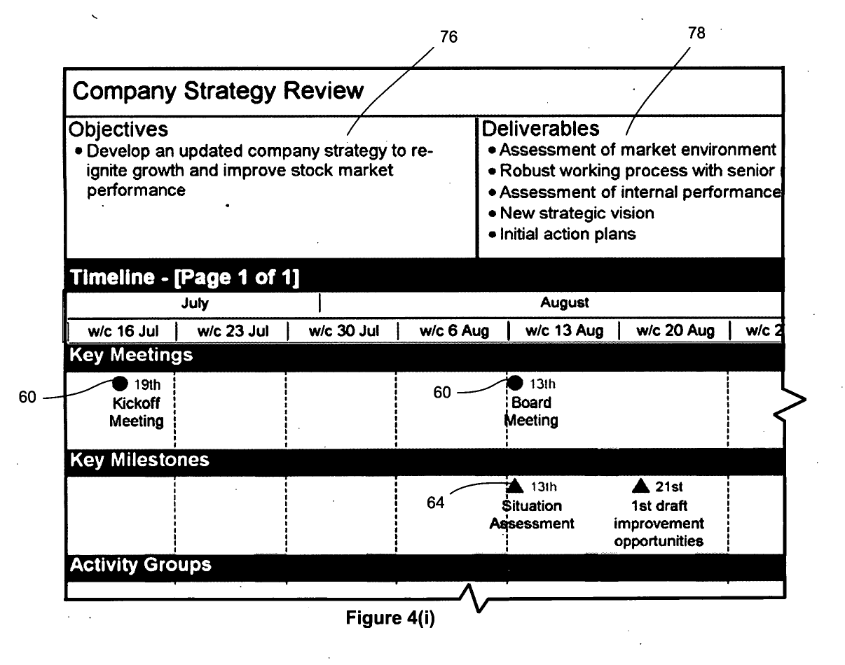

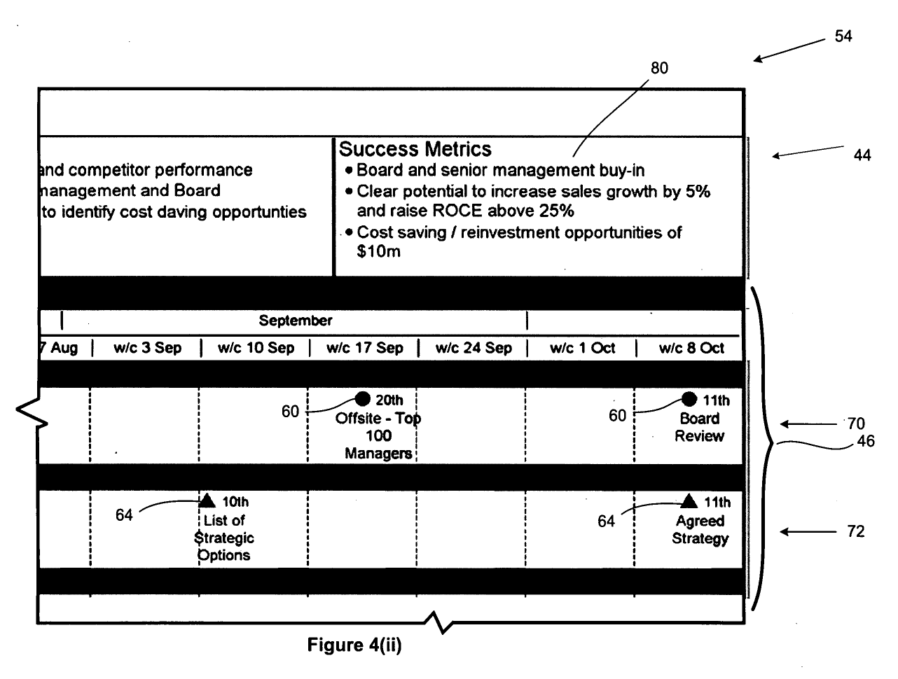

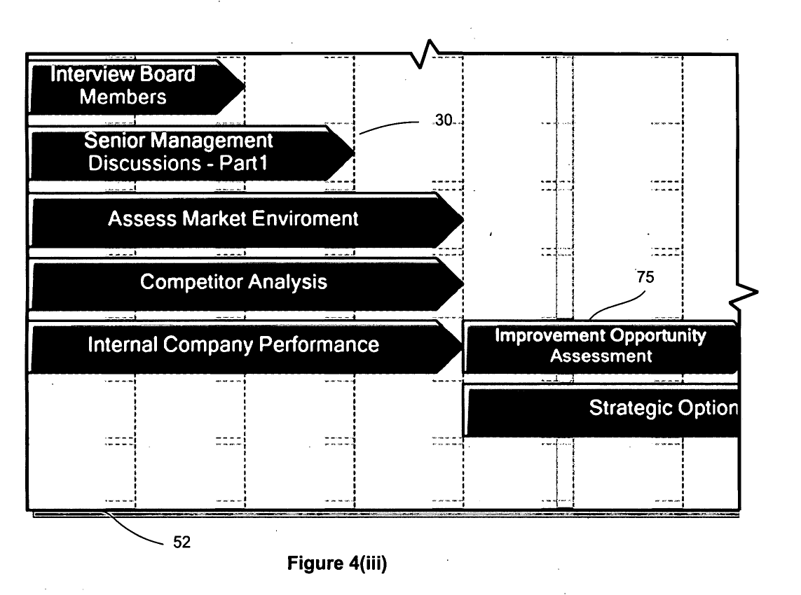

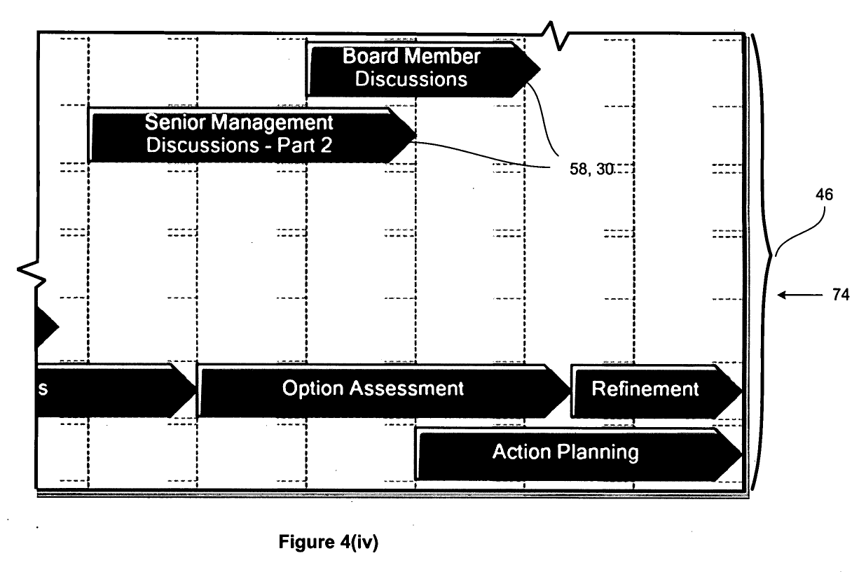

The toolbar 32, toolbox 34, view selector 36 and page delimiter 50 surround a rectangular area (referred to as a page) 52 which has the dimensions of a physical page to be outputted, for example to the printer 22. Thus, the user is presented on screen with a direct non-distorted representation of a final output page, which will be generated by the printer 22 or projector 26. Whilst the actual size of the displayed image on the projector 26 can vary, the relative proportions of the graphical elements, which make up that page 52 as determined by the GUI 14 on the display 12, are maintained in the projected image. For the printer 22, the displayed page 52 matches the actual proportions and look of the image to be printed on A4 paper 24. The page delimiter 50 is greyed out to enhance the appearance of an actual page 52 within the GUI 14. This arrangement is known as a ‘WYSIWYG’ arrangement, namely as a ‘What You See Is What You Get’ arrangement. It is to be noted that the legend 48 shown in the page 52 shown in FIG. 3 is a user selected option. In the FIG. 4 image, the legend 48 has be been deselected for display.

The actual output 54 to the printer 22 for example, is shown in FIG. 4, where the output 54 comprising the page header 44 and the page body 46 is shown. The print output 54 has complete proportional correspondence with the page header 44 and page body 46 shown in the GUI 14. In addition, it can be seen that a copyright notice has been added to the actual output page. Nevertheless, the proportionality of the bounded page image is maintained in the output printed image.

Returning to the GUI shown in FIG. 3, the page body 46 comprises a timeline 56 relative to which graphical components 30 can be positioned by the user to indicate events scheduled as part of a project. Different types of events can be represented, and accordingly there are different graphical component types for each of the different event types, so as to aid a user in easily distinguishing between different types of events.

The toolbox 34 comprises a number of selectable icons or symbols, each corresponding to an individual graphical component type, and so to a different type of event. The different events represented by the graphical components types are: an Activity Group 58 as a block arrow, a Meeting 60 as a circle, an Action 62 as a square, a Milestone 64 as a triangle, an Issue 66 as a bomb symbol, and a Contact 68 as a star symbol.

Typically, when inputting information about a particular event, a user uses the mouse 18 to select one of the icons 58, 60, 62, 64, 66, 68, and then positions the cursor under the timeline 56 to place the respective graphical component 30, corresponding to the type of selected icon, along the timeline 56. Events relating to Activity Groups 58 generally take place over a time period, and so the graphical component 30 (arrow) representing Activity Groups 58 can be dragged to occupy a width along the timeline 56, and so is representative of an event duration, rather than a single point in time. By using icon selection, dragging and dropping, the project management application 16 provides a simple, intuitive and rapid way for a user to populate a project plan, for example.

The page body 46 comprises individual display regions for each graphical component type (and so for each event type). A first display region 70 contains only events associated with Key Meetings 60, a second display region 72 contains only events associated with Key Milestones 64 and a third display region 74 contains only events relating to Activity Groups 58.

Once each graphical component has been arranged on the page 52, a user can input a caption 75 associated with that graphical component, so as to label the specific event that the graphical component represents. For example, as can be seen clearly in FIG. 3, one of the graphical components relates to an Activity Group 58 entitled “Initiation Phase”.

As well as receiving and displaying information about events, the project management application 16 is also arranged to receive and display, via the GUI 14, information relating to other aspects of a project. For example, the page header 44 is arranged to receive top-level information about a project such as a projects objectives 76, project deliverables 78 and success metrics 80.

The layout of the page 52 is designed to present a user with a ‘big picture view’ (an overview) and represent the information about the project in a hierarchical manner starting from the project objectives 76, deliverables 78 and success metrics 80, and working down to an overview of certain top-level events such as Key Meetings 60, Milestones 64 and Activity Groups. The information provided in the page header 44 can be considered to be at a higher level of importance than the information set out in the page body 46 such as in the specific timelines provided in the first second and third display regions 70, 72, 74, and as such can be maintained within the GUI 14 even with the generation of different views using the view selector 36. This persistence of display of the most important information advantageously enables the user to always be reminded of these overriding goals throughout interaction with the specific views of the GUI 14 in the page body 46. In this way, the combination of the page header 44 and the page body 46 advantageously provide a GUI 14 having a hierarchical display of user-determined information.

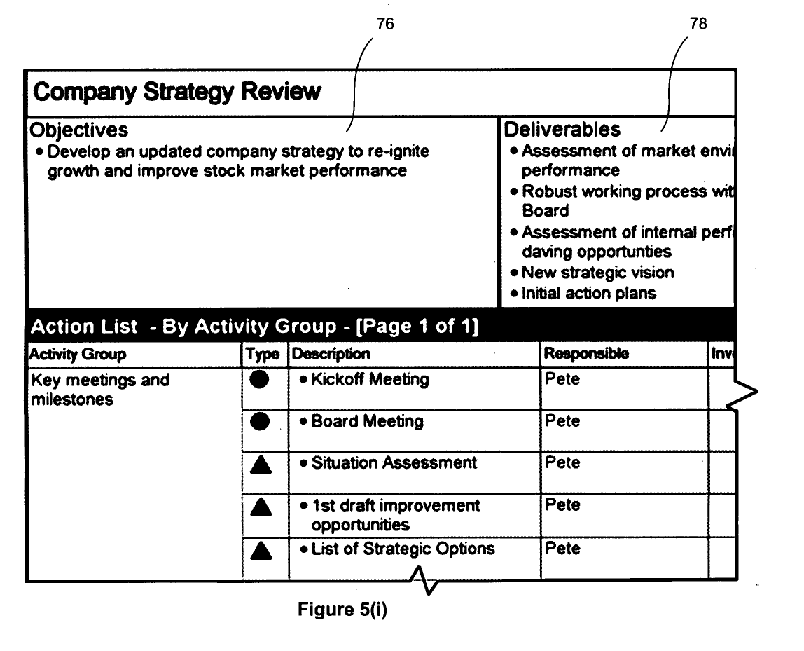

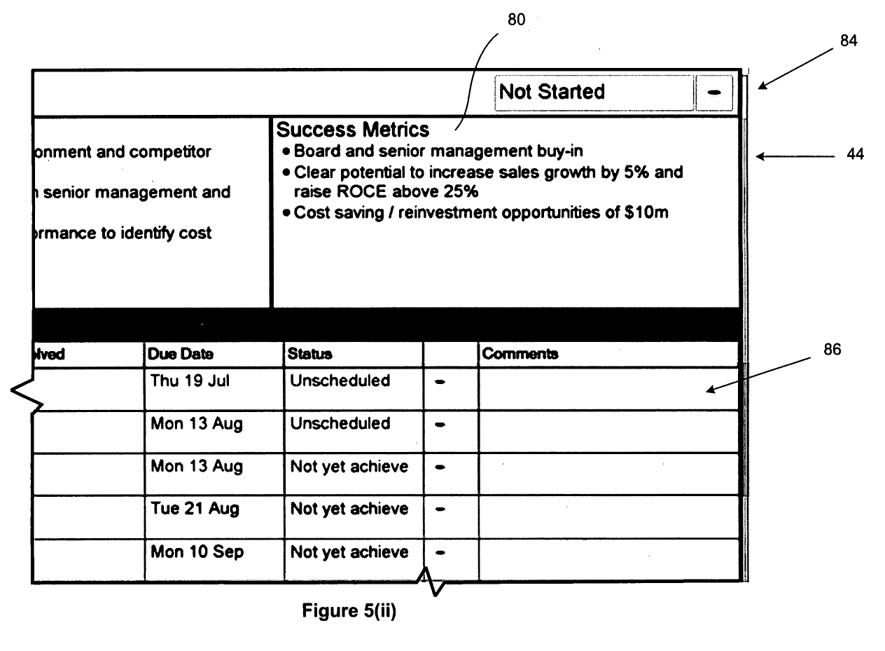

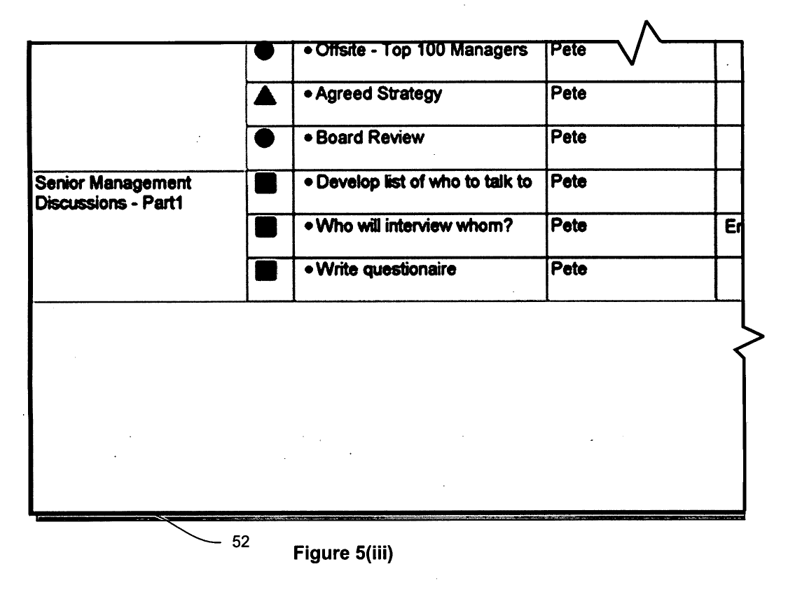

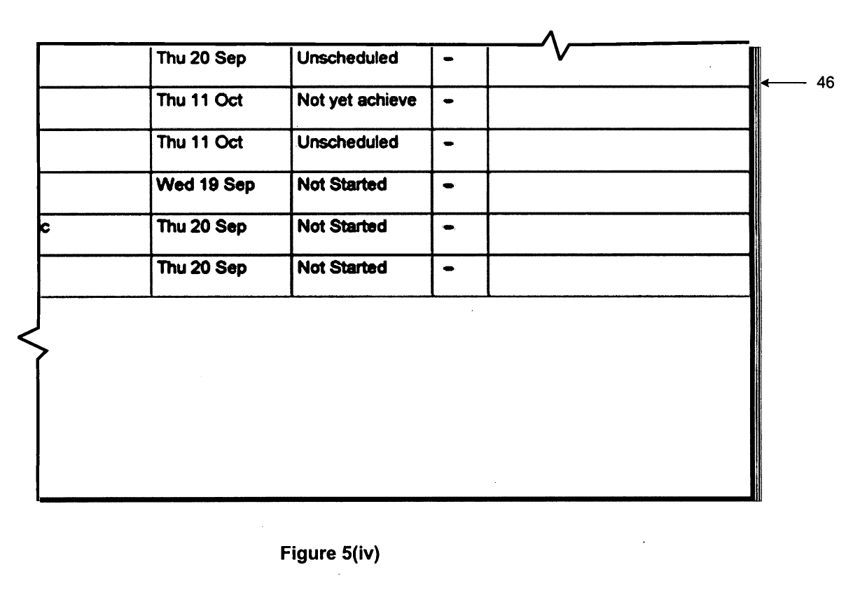

Another example of this hierarchical view for another module is shown in FIG. 5. This view can be obtained by the user using the mouse 18 to select the Action List icon 62 in the toolbox 34 (see FIG. 3), or through using the “Go To” menu option 82 in the toolbar 32 (FIG. 3).

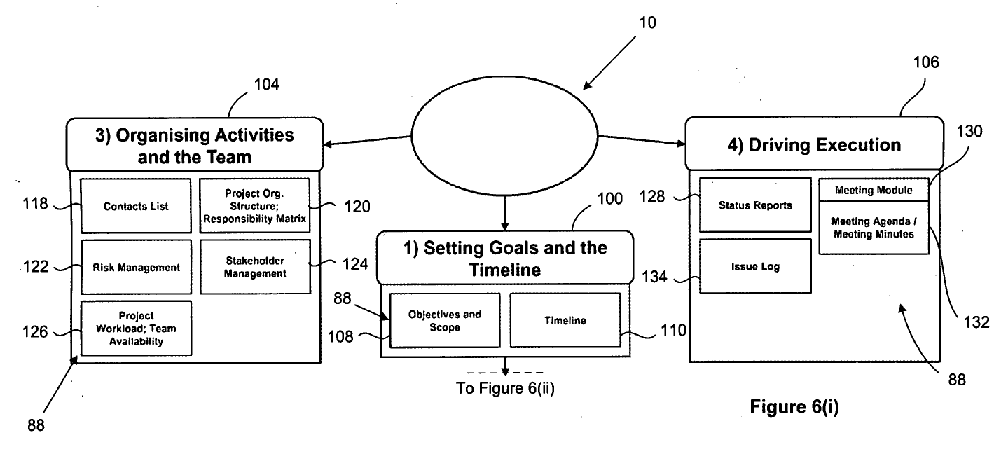

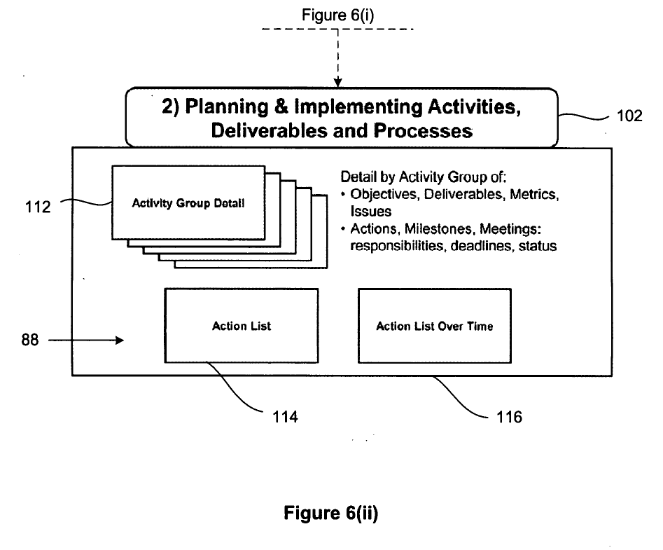

As shown in FIG. 5, an action list view 84 is created in the page 52 by an “Action List” module 120 (described later in FIG. 6). The page header 44 contains the user-editable text boxes for, in this example, the project's objectives 76, deliverables 78 and success metrics 80. The body section 46 of the page 52 contains a list 86 of all the meetings 60, milestones 64 and actions, which have been set up for the project, grouped by activity.

In other modules/other views, the information on the page header 44 continues to provide context about the project direction, whilst the rest of the page 52 displays other selected detail about the project so that the user can advantageously have the project objectives 76, deliverables 78 and success metrics 80 in mind whilst they are looking at other data.

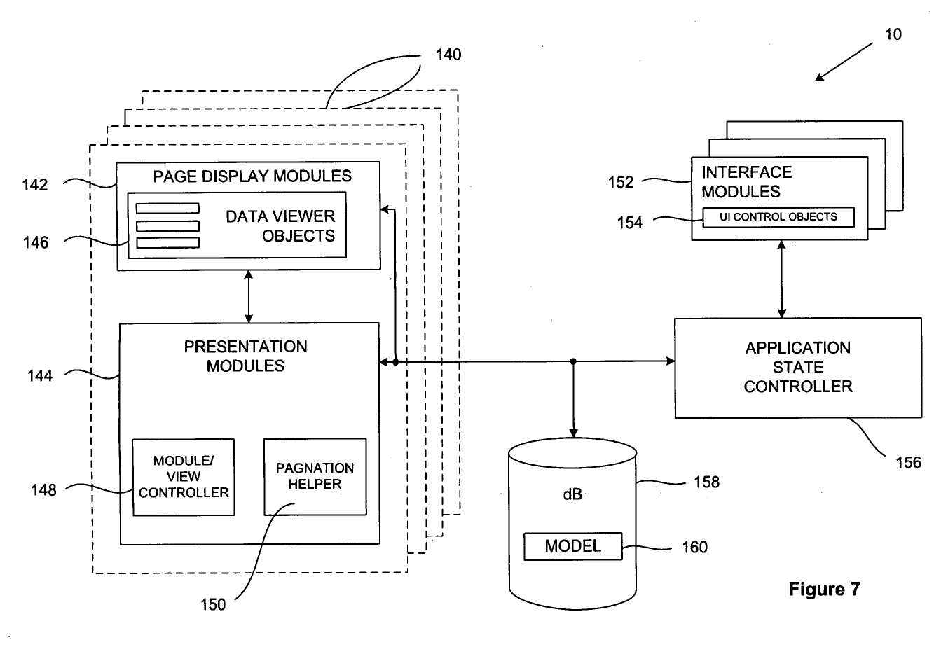

In addition to the hierarchical manner in which the information is displayed on a single page, the project management application 16 via the GUI 14 also presents and receives the information inputted by a user using a hierarchy of different views. Each view is selected information arranged and displayed by a different view module 88 (described in greater detail later with reference to FIGS. 6 and 7). When a view module 88 is activated, the view module 88 displays and formats the relevant information. For example, FIG. 3 shows the view presented by a timeline module 110 (see FIG. 6). The view selector 36 comprises a number of selectable icons 37, eight in this embodiment, each of which is associated with a different view module 88, and so when a user selects the appropriate icon 37, the respective view module 88 is activated and the respective view is displayed.

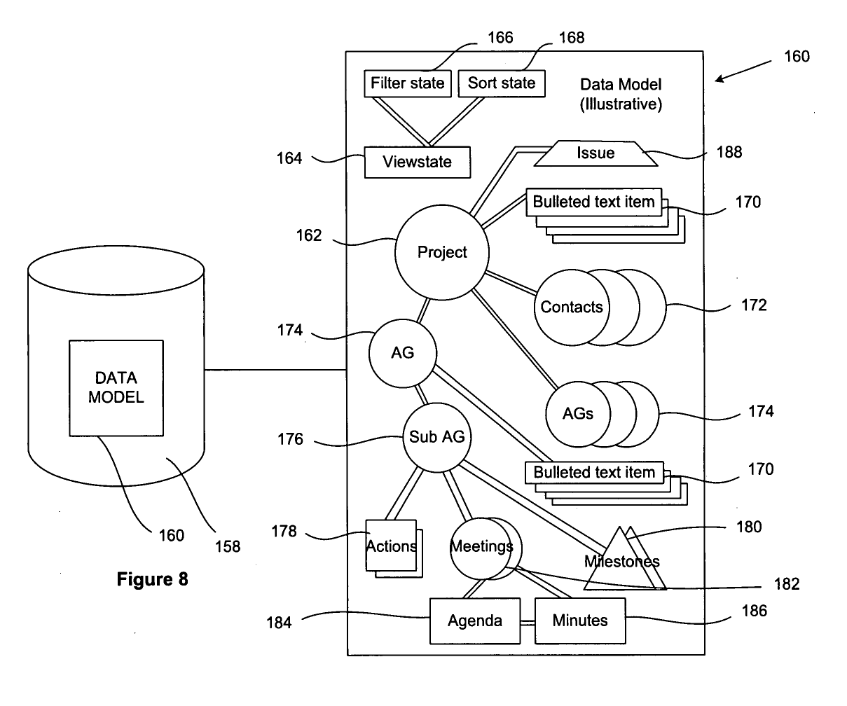

FIG. 6 shows a schematic diagram of the hierarchical arrangement of the view modules 88 of the project management application 16 which are categorised into one of four categories. A first category 100 entitled “Setting Goals and the Timeline” relates to top-level information about a project. A second category 102 entitled “Planning and Implementing Activities, Deliverables and Processes” relates to more specific, lower-level information about a project. The first and second categories 100, 102 of view modules 88 are therefore arranged in a hierarchical fashion. A third category 104 entitled “Organising Activities and the Team”, and a fourth category 106 entitled “Driving Execution” also relate to information about a project. Whilst FIG. 6 does not show these categories arranged in a hierarchical manner, they do in fact have components which are hierarchically arranged with other components. For example, the second category 102 comprises an activity group detail module 112 which will in turn comprises meeting information. The actual hierarchical arrangement of the data associated with the view modules 88, is reflected in the data model shown in FIG. 8 and is described in detail later.

The first category 100 comprises two view modules 88: an Objective and Scope module 108 and the Timeline module 110. The second category 102 comprises three view modules 88: an Activity Group Detail module 112, an Action List module 114 and an Action List Over Time module 116. The third information category 104 comprises five view modules: a Contact List module 118, a Project Organisation Structure/Responsibility Matrix module 120, a Risk Management module 122, a Stakeholder Management 124 and a Project Workload; Team Availability module 126. The fourth category 106 comprises four view modules 88: a Status Reports module 128, a Meeting module 130, a Meeting Agenda/Meeting Minutes module 132 and an Issue Log module 134.

These different modules 88 serve different purposes in the context of planning and implementing a project although the Meeting module 130 and the Meeting Agenda/Meeting minutes module 132 are very similar in focus and are closely related. The Objectives and Scope module 108 comprises a series of pages for displaying information about the project's scope (e.g. objectives, key questions, deliverables, success measures etc). The Timeline module 110 is an intuitive and highly configurable view that provides a “big picture” view of the plan highlighting information about the project's scope, key meetings and milestones, and main activities all in a one page wide timeline. The Activity Group Detail module 112 provides detail on what is happening, or needs to happen (e.g. the to-do list) within a particular Activity Group. The Action List module 114 comprises the “to do list” for the whole project, with all the Meetings, Milestones and Actions, responsibilities, due dates etc across all of the Activity Groups. The Action List over Time module 116 comprises a time-based view of Activity Groups and their Meetings, Milestones and Actions (the to-do list) either by week (4 weeks to a page), or by day (5 or 7 days per page). The Contact List Module 118 displays contact information for people or groups/entities involved in the project (e.g. email, phone etc). The Project Organisation Structure part of the Project Organisation Structure/Responsibility Matrix module 120 displays information about the project steering committee (if any) and project team structure. The Responsibility Matrix part of the Project Organisation Structure/Responsibility Matrix module 120 displays a matrix highlighting who is responsible for each Activity Group in the project, and who else is involved in each Activity Group. The Risk Management module 122 comprises a list in which to capture information about risks that might affect the project and the actions/contingency plans the project team have for dealing with them. The Stakeholder Management module 124 comprises a list in which to highlight the key stakeholders and their concerns and perspectives on the project. The Project Workload and Team Availability module 126 provides a means to allocate available resources (e.g. people and man-days) to Activity Groups, allocate workload (e.g. man-days) to Activity Groups and assess whether resources match the workload. The Status Reporting module 128 provides an easy way to generate status reports reflecting the project's position and performance at different points in time. The Meeting module 130 and its related Meeting Agenda/Meeting Minutes module 132 allow the user to create agendas and minutes for project meetings and capture them, and any resulting actions within the project file thereby helping keep the project plan up-to-date. The Issue Log module 134 provides a place for listing, managing and reporting on issues that may arise on the project, for example allowing the user to describe the issue, its potential impact and any actions planned to resolve the issue.

As mentioned, each of the view modules 88 can be activated in turn, and when activated, are arranged to receive and display selected information via the GUI 14 in a specific way. For example, the Action List module 114 is arranged to receive and display information, as shown in FIG. 5, about actions to be taken and is arranged to set out that information in the form of a list 86.

Referring back to FIG. 3, it is to be noted that in the toolbox 34, three icons relating to actions 62, issues 66 and contacts 68 are displayed as greyed out symbols. This is because the Timeline module 110 is activated and so adding information about actions, issues or contacts is inappropriate for this view. Further, the Timeline module 110 relates to high-level project information and the events associated with these greyed out icons relate to low-level information. If the Contact List module 118 were activated (via the contacts list icon in the view selector 36), then the icon in the toolbox 34 relating to contacts 68 would then become available for user selection and would no longer be shown as greyed out.

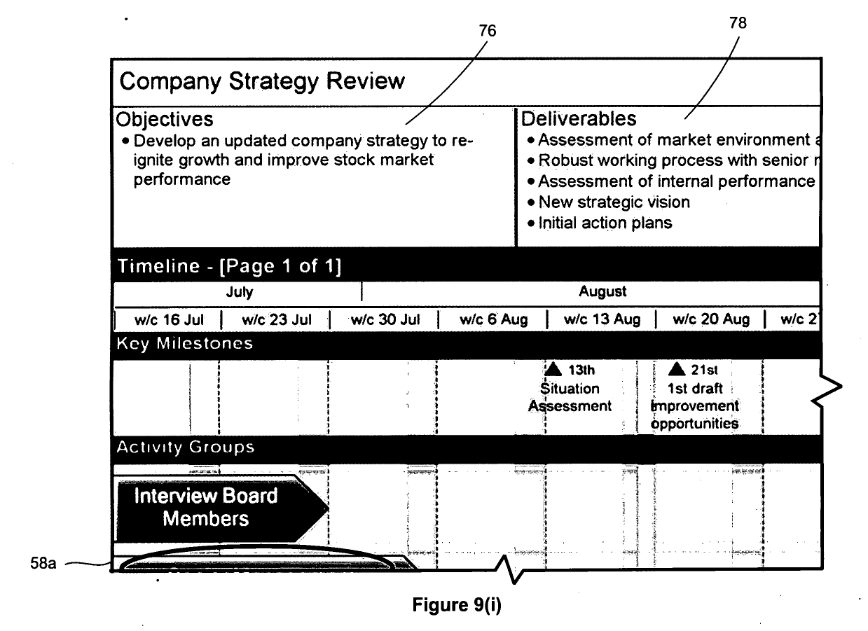

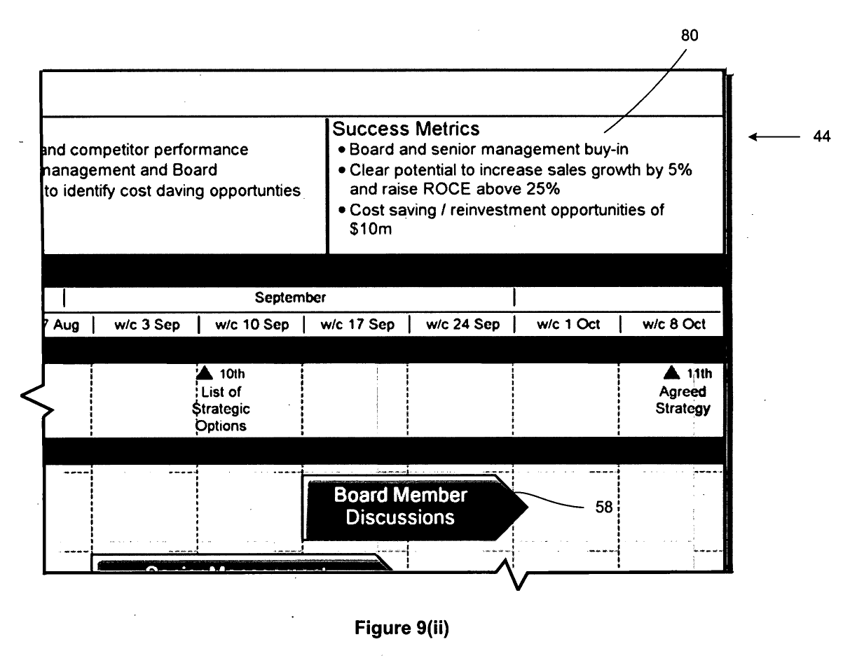

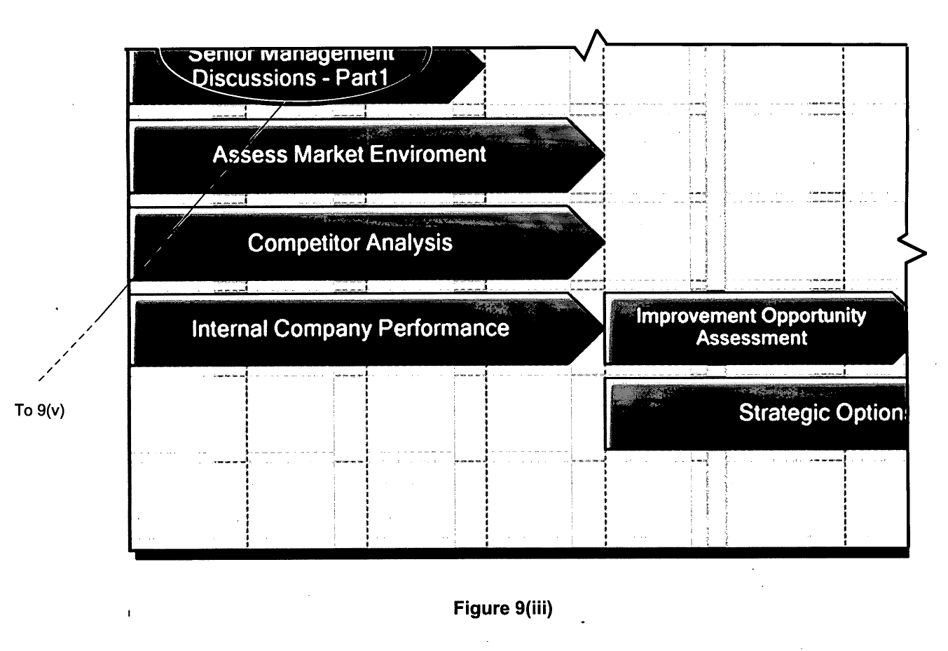

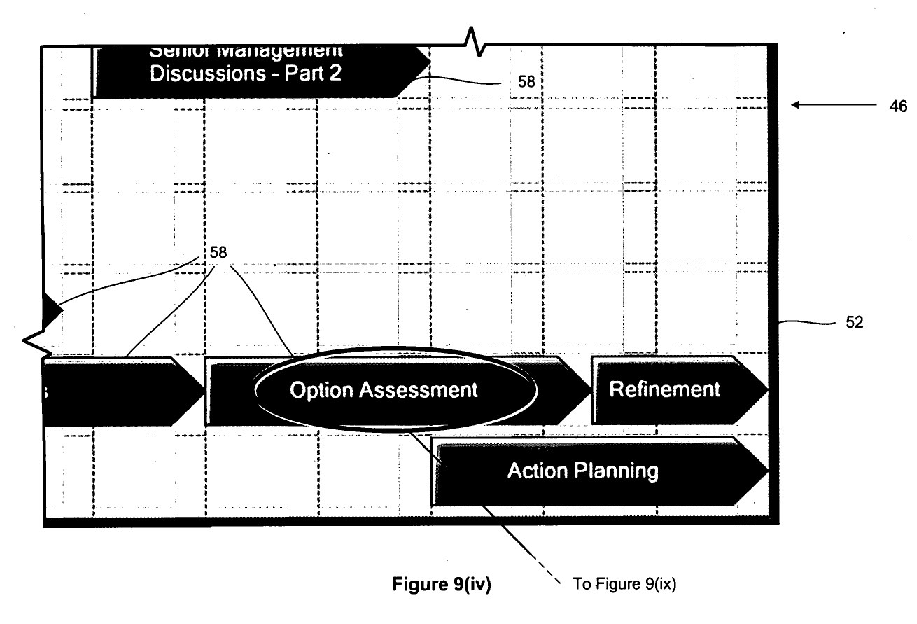

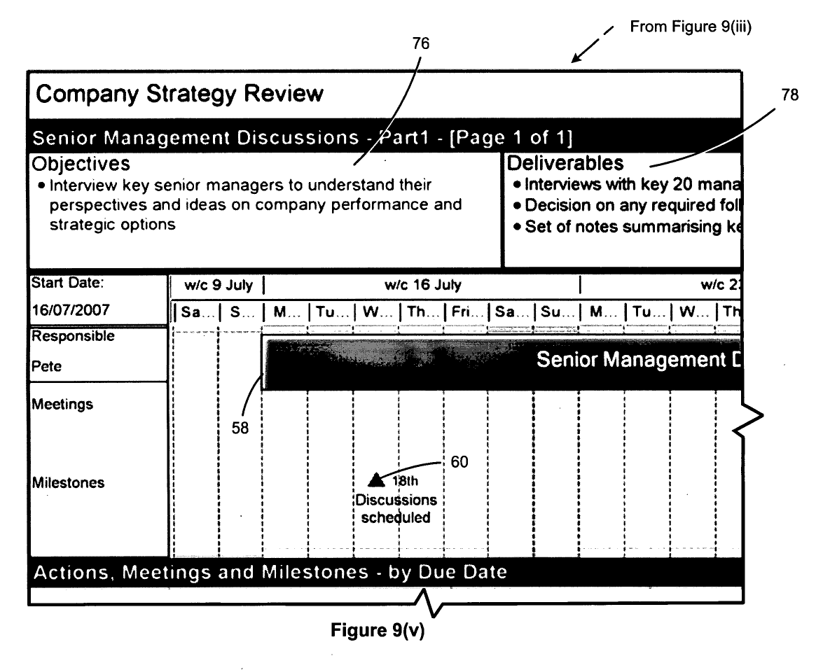

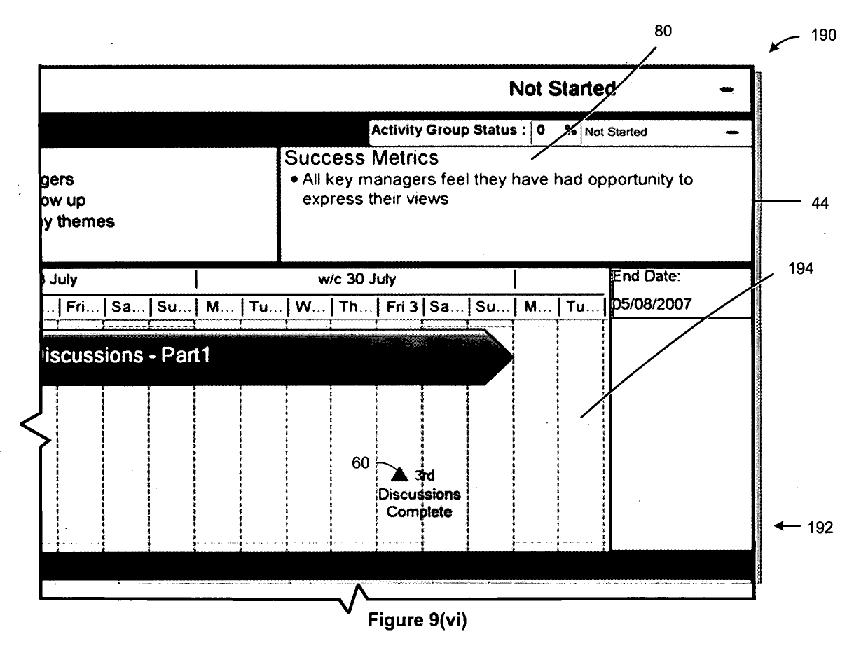

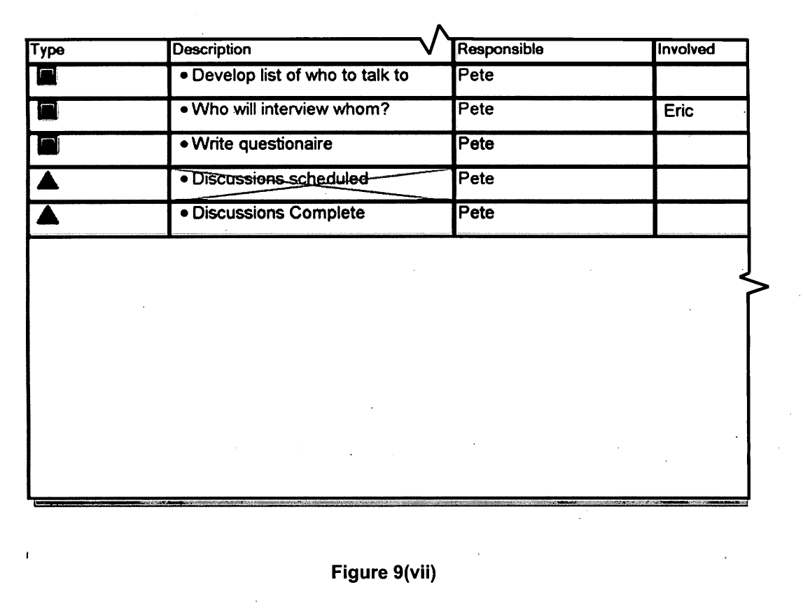

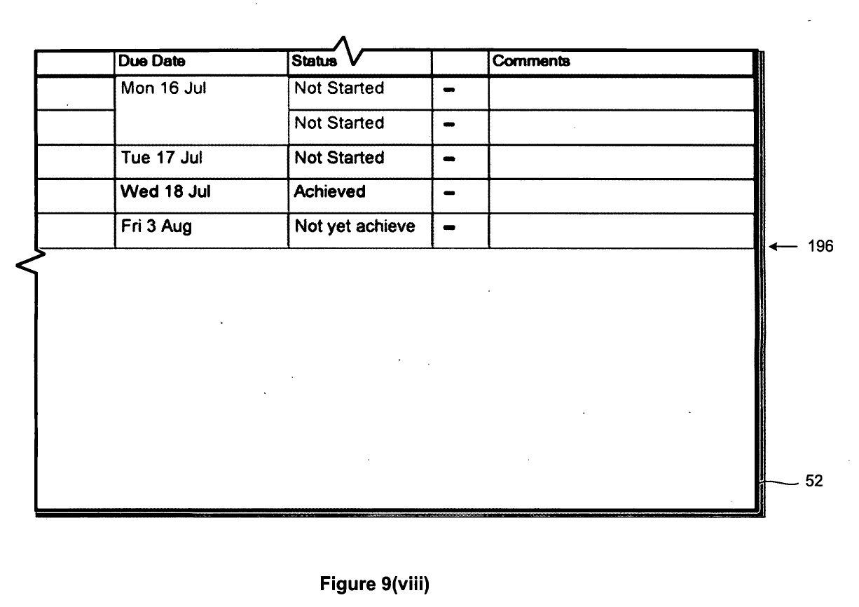

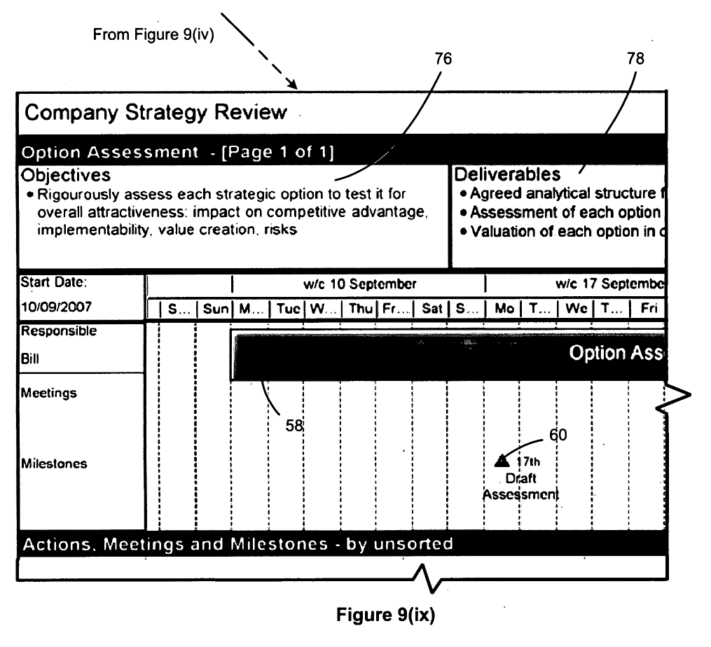

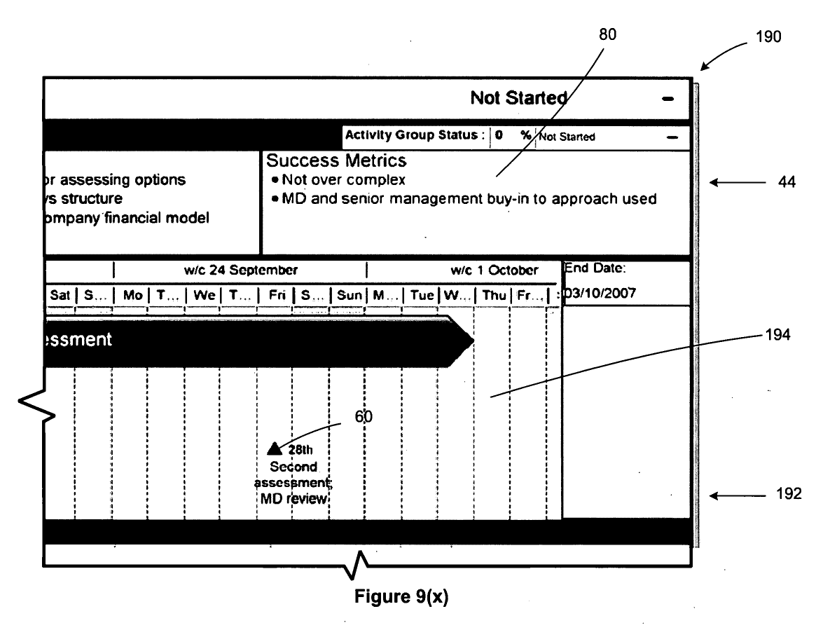

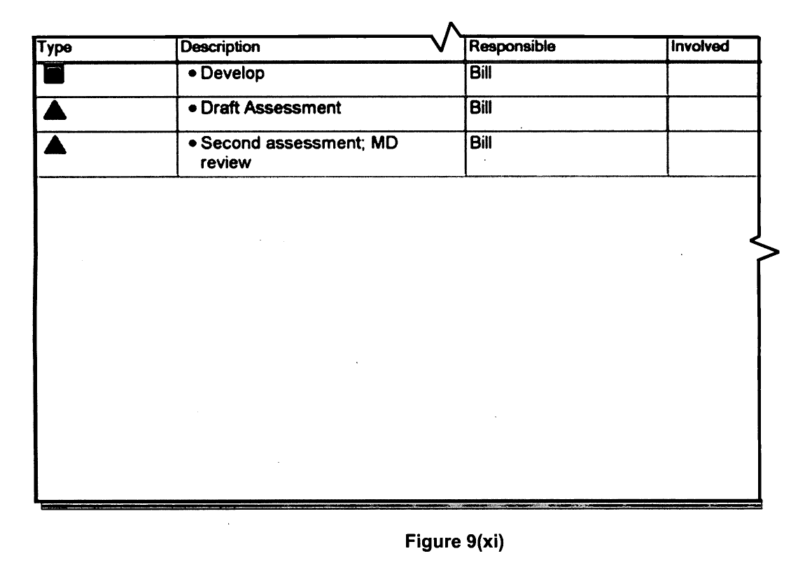

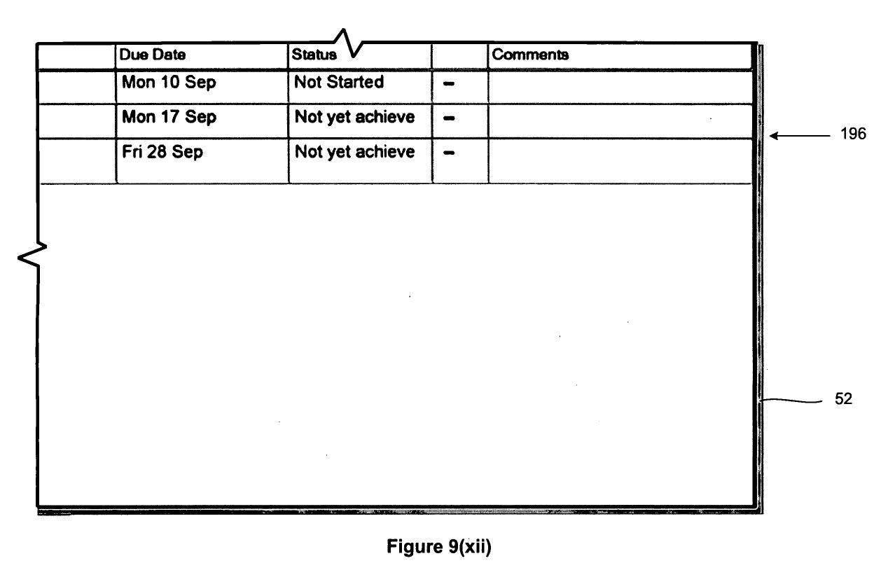

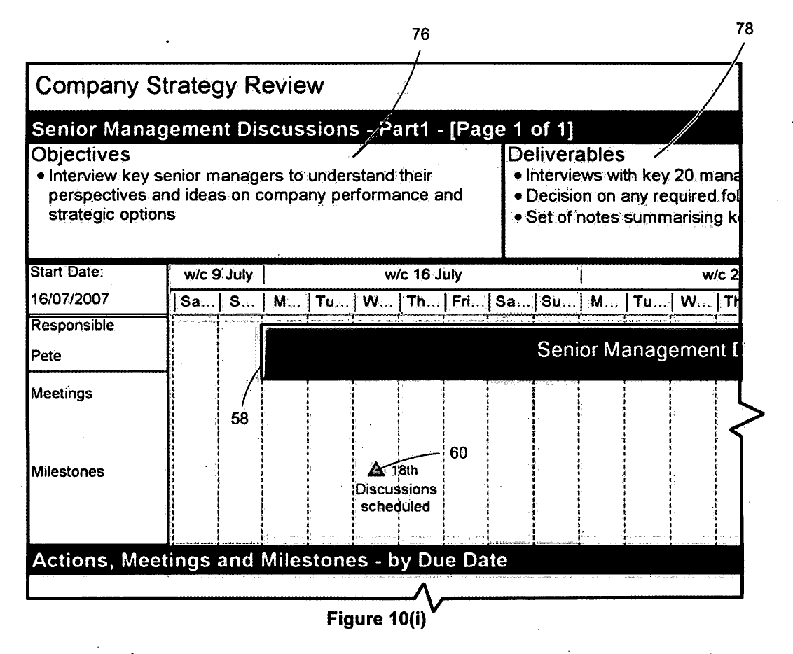

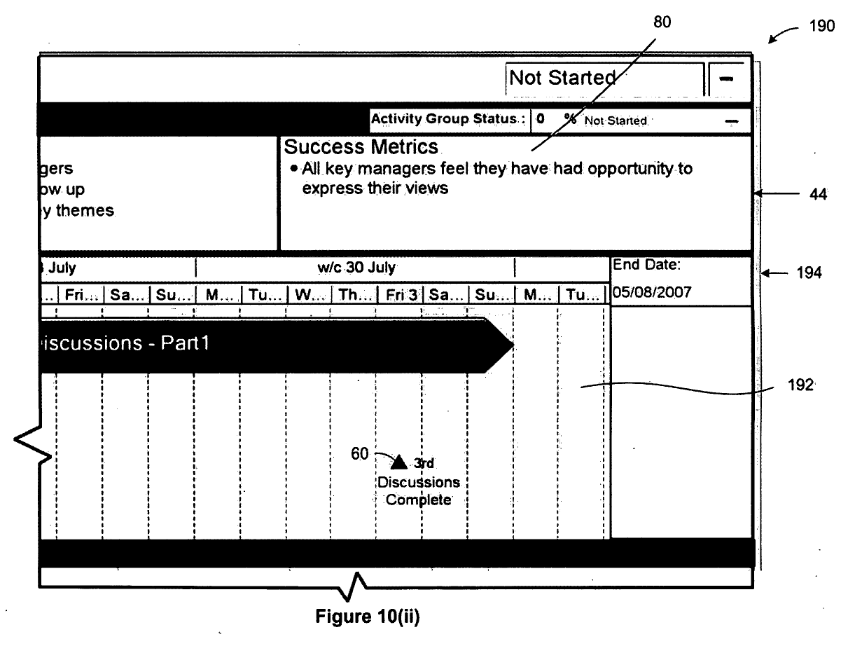

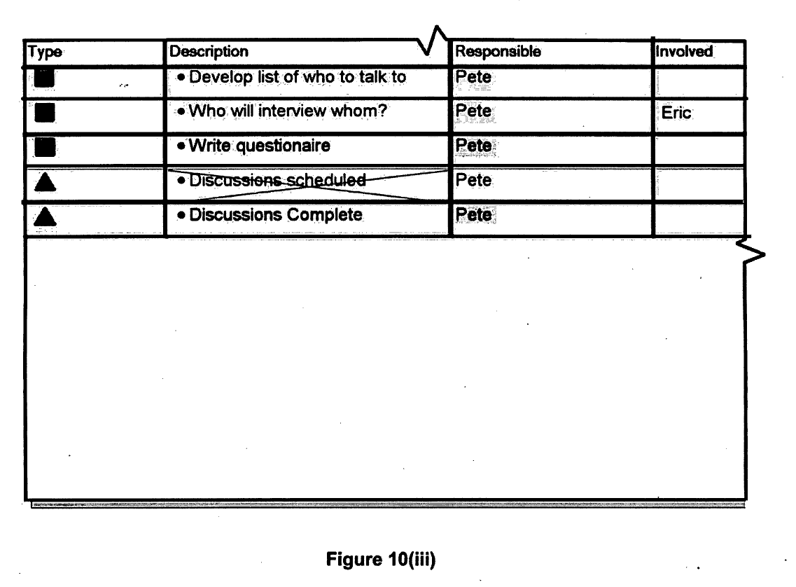

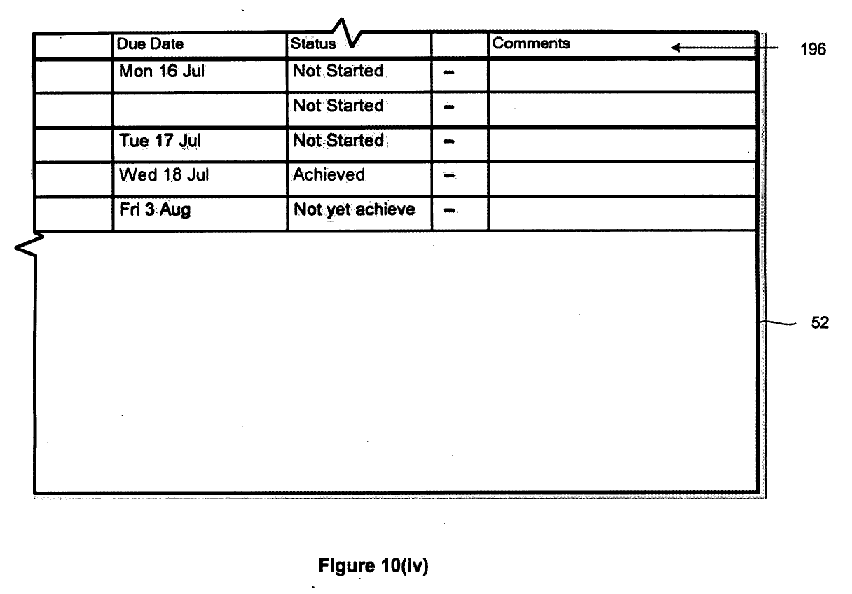

Referring to FIG. 7, a schematic representation of the project management application 16 is shown. The project management application 16 comprises a plurality of sets 140 of page display modules 142, and presentation modules 144. Each set 140 comprises one page display module 142 and one presentation module 144, which collectively are associated with a respective view module 88. The function of the page display module 142 is to render the page to the screen of the GUI 14. It comprises several data viewer objects 146 which each represent different parts of the GUI 14. For example, for an Activity Group detail module 112, the page display module 142 would comprise data view objects 146 for each of the project header 44, the expanded timeline section 192 and for an event list section 196 (described later with reference to FIGS. 9 and 10).

The presentation module 144 determines the content to be displayed for a given view module 88. The presentation module 144 comprises a module view controller 148 which identifies when changes have been made in the GUI 14 which may affect the associated view module 88 and a pagination helper module 150 which determines what content gets displayed on different pages in the view module 88.

Each set 140 of the page display and presentation modules 144, 146 has an associated interface module 152, whose function is to control the interactive components of the GUI 14 for a given associated view module 88. Each interface module 152 comprises a plurality of user interface (UI) control objects 154 which control the operation of specific components of the GUI 14 being generated. For example, UI control objects 154 are provided for controlling the menu, tool bar 32 and tool box 34 generated for use with a particular view module 88.

The project management application 16 also comprises an application state controller 156 and a database 158. The database 158 stores relevant information used by the application 16 such as and a printing conversion table (described later, but not shown). The database 158 also comprises a data model 160 which stores information relating to a project, using a hierarchical structure as is described in detail later.

Each set 140 of page display module 142, presentation module 144 together with the corresponding interface module 152, operate together in a similar manner and so, for the interests of clarity and brevity, the operation of a single set 140 with an associated interface module 152 is only described herein.

At a general level, the interface module 152 is arranged to receive user-inputted information and GUI control commands from the GUI 14. The corresponding presentation module 144 calculates the sizing and positioning of the graphical components 30 to be displayed within the GUI 14 on the electronic display 12. The page display module 142 renders the graphical components 30 to the electronic display 12 such that the graphical components 30 are arranged on an area on the GUI in the form of a page 52 (comprising the page header 44 and the page body 46—see FIG. 3) that has a predetermined height and width, and which will be represented in proportion on a corresponding output page, for example, when printed on hardcopy A4 sized page of paper 24 outputted by the printer 22. The presentation module 144 is responsible for the detailed sizing and arrangement of the graphical components 30 so that they fit onto the page 52.

The term ‘graphical components’ as used throughout the specification and claims, is intended to have a relatively broad meaning, being components of the GUI within the page 52 which are generated for display. Most of these components are resizable. However, some graphical components are not resizable in themselves but are taken into consideration by the presentation module 144 for resizing of other resizable components. Examples of graphical components in the present embodiment are set out below.

The list of graphical components includes objects; timeline components: and rows for Activities, (Key) Meetings, (Key) Milestones, Text boxes (in interlaced timeline mode—described later). This latter category can be considered to be rows or areas to contain objects. Other graphical components include static timeline components such as timeline date rows; section dividers/headers (e.g. for key meetings, key milestones); and the legend 48. The size (height) of these static timeline components are taken into account by the DFA—though they may not be resized. In the case where a list (e.g. action list) is being resized, graphical components include rows or areas to contain objects or data.

The application state controller 156 regulates the operation of the page display module 142, and the presentation module 144 and also the interface module 152. Further, the application state controller 156 controls the flow of the information passed between the page display module 142, the interface module 152, the presentation module 144 and the database 158.

As information is being received and updated from the interface module 152, it is passed through the application state controller 156 and stored in the database 158. However, it is also possible for data to be passed directly to and from the database 158 to the page display module 142 and the presentation module 144. As mentioned, the database 158 stores information in accordance with a data model 160, which is described in greater detail below.

A schematic view of the data model 160 is shown in FIG. 8. The data model 160 is adapted to receive time-related information—particularly about events, and other data associated with events—and store this information in a hierarchical way. The data model 160 comprises a project component 162, which is a top-level data type. Sub-components of the project component 162 include information about a Viewstate 164, which in turn has sub-components of a Filterstate 166 and a Sortstate 168, a series of Bulleted Text Items 170, a set of Contacts 172 and a set of Activity Groups 174.

The Viewstate 164 is data about which view module 88 is active, and how the graphical components 30 and other displayed items, such as text, associated with that view module 88 are arranged on the page 52. Filterstate 166 information relates to how the information relating to a particular view has been chosen by a user to be filtered. The user can select or deselect certain items to be displayed, and so the information relating to those items is still present, but could be hidden or shown depending on the user's selection. Sortstate 168 information relates to which order listed information is chosen by the user to be presented. For example, if the information relates to a list of contacts, the contacts can be listed alphabetically or reverse-alphabetically by first name or surname or in a user determined order.

Information about the Viewstate 164, the Filterstate 166 and the Sortstate 168, are used by the application state controller 156 to control which view module 88 is active, and what is displayed to the user in real-time. The data model 160 may also store other information relevant to the real-time operation of the project management application 16 such as selected control/item information and clipboard status.

If the application 16 is shut down and restarted, or if the user switches between multiple views, the application state controller 156 can use the state information to determine how the graphical components 30 and other data arranged on the page 52 is to be maintained, and so the last set of graphical components, arranged for a particular view, persist.

Information about a Bulleted Text Item 170 relates to an item which is part of a bulleted list appearing in the page header 44; for example, as objectives for the project.

Information about Contacts 172 includes the name, address, telephone number and/or other details about a person or entity, which may be relevant to a project.

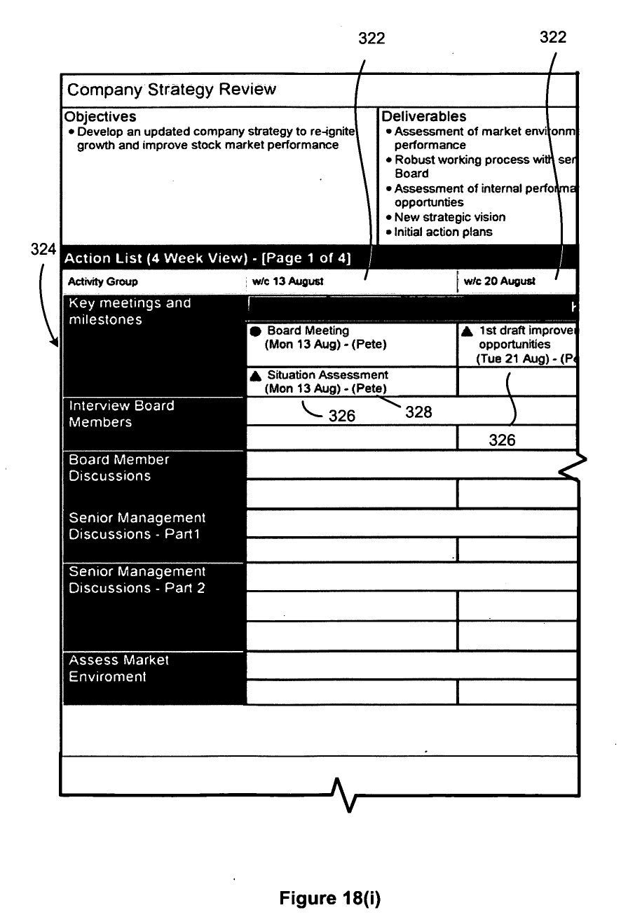

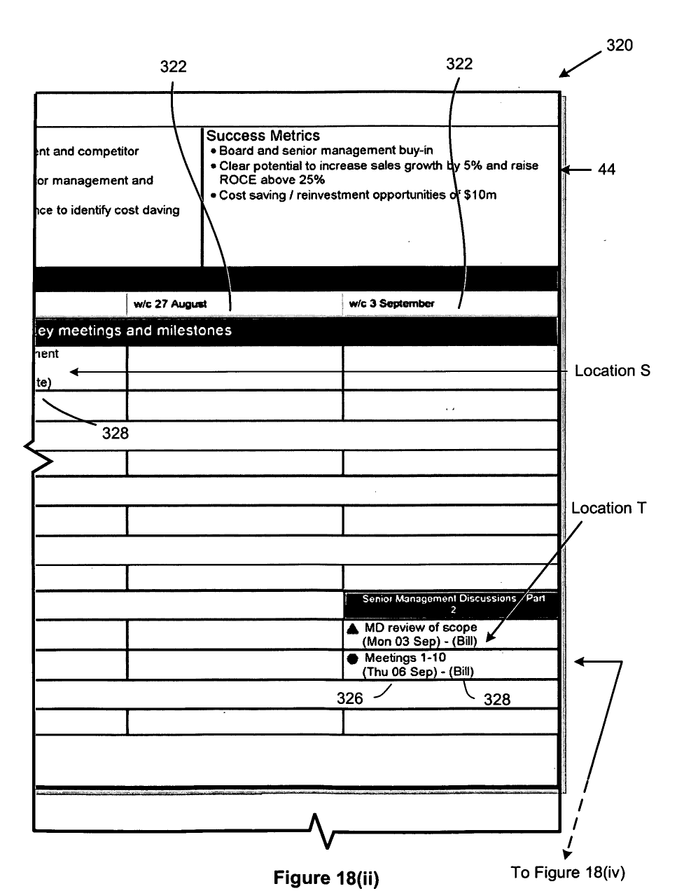

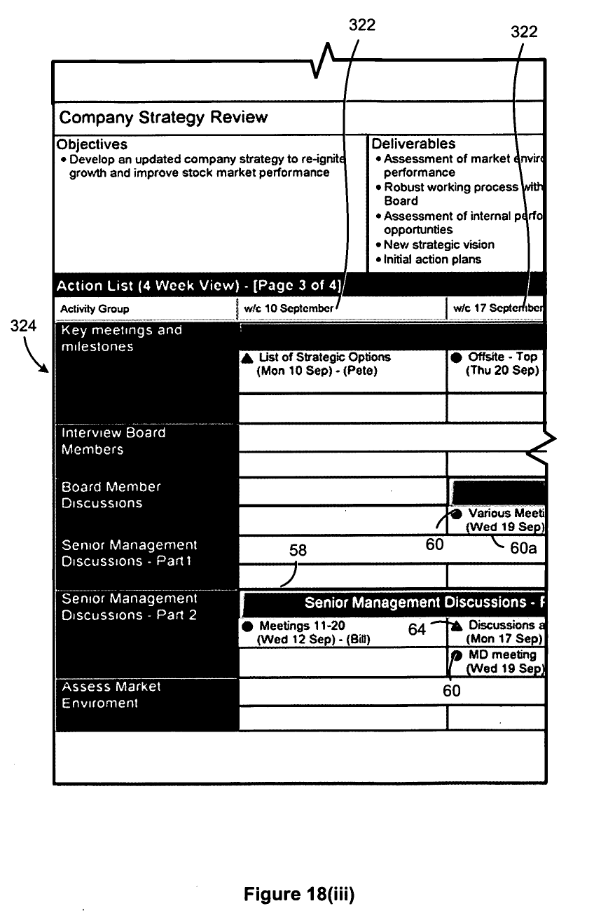

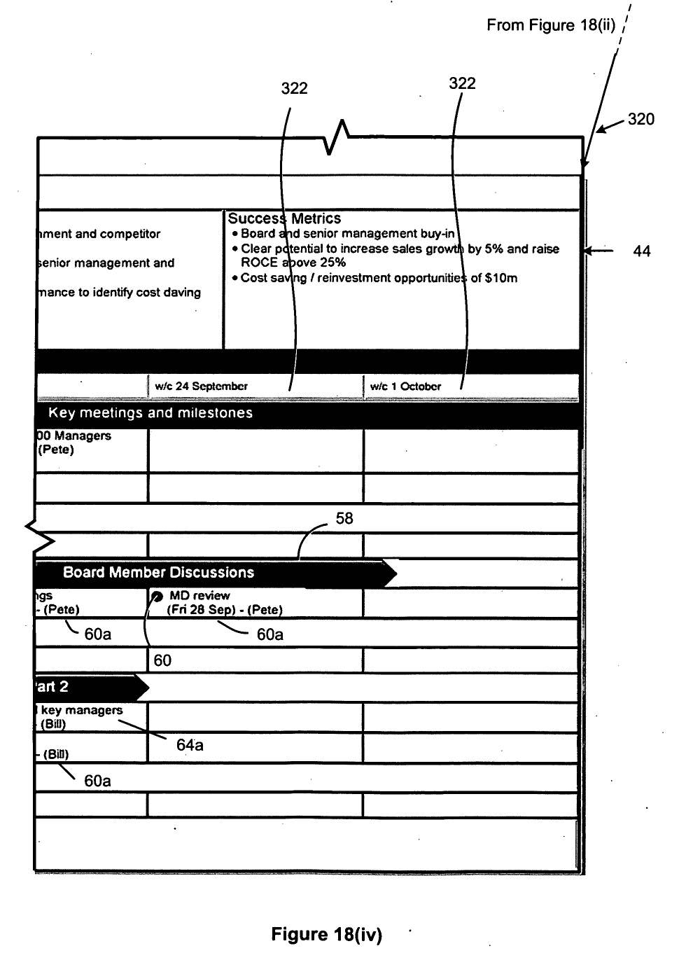

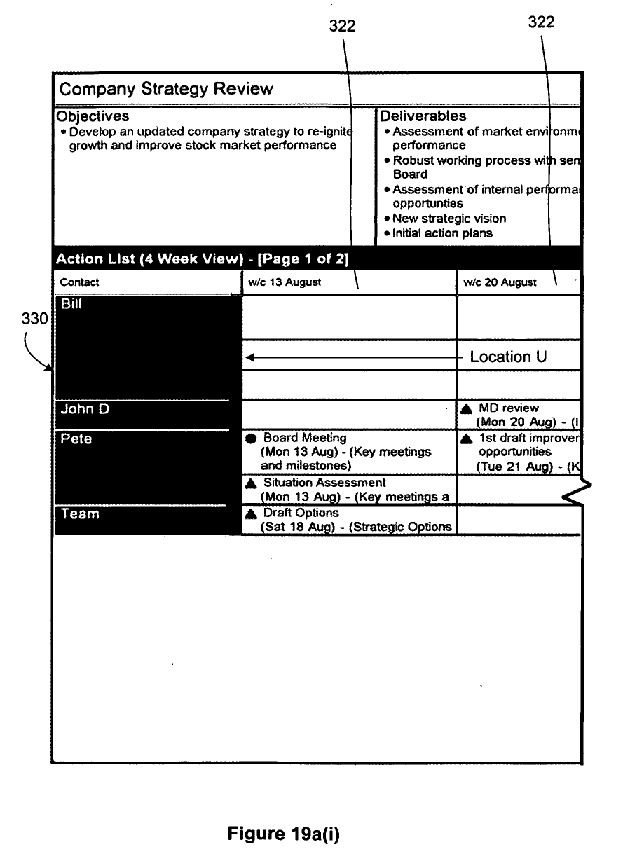

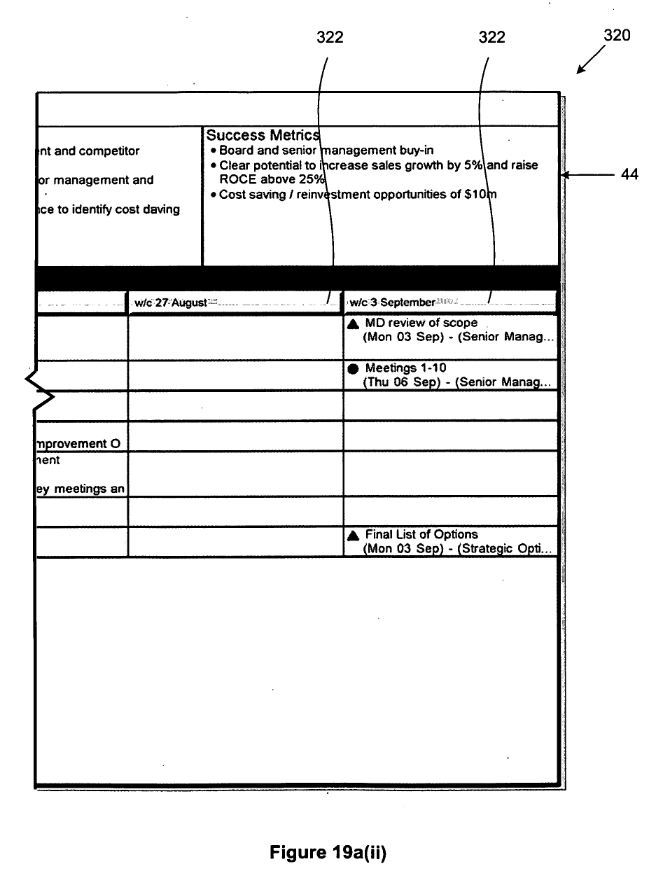

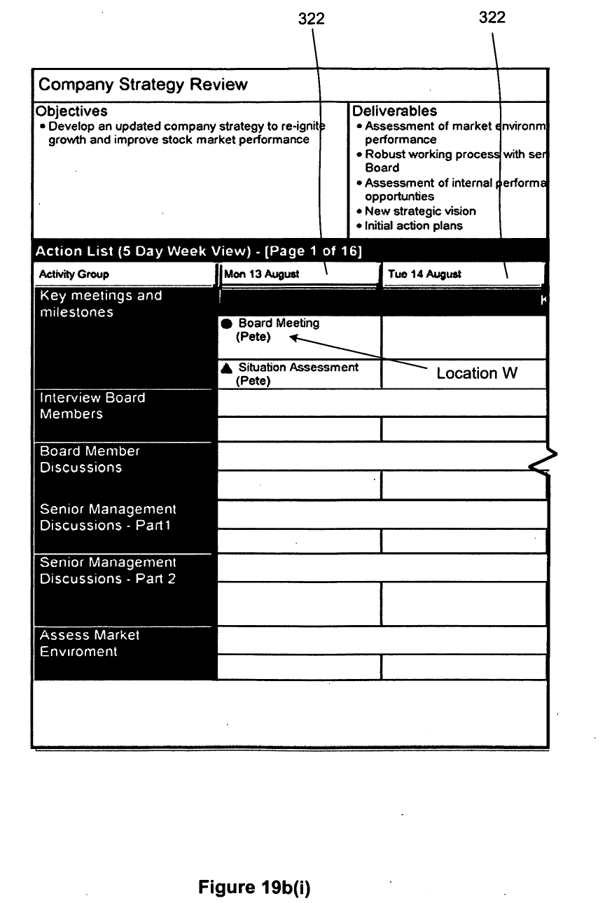

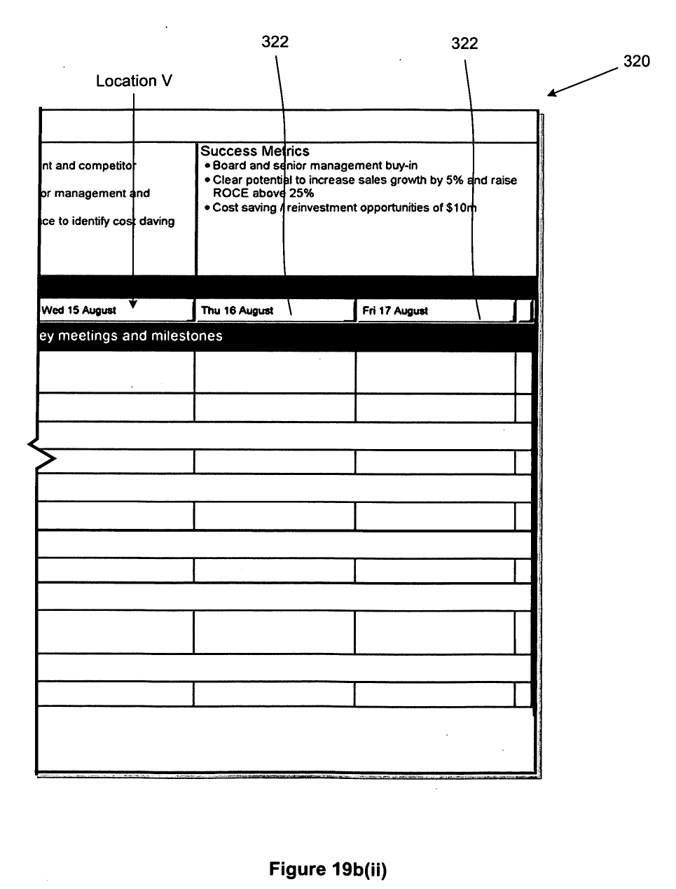

Because information about the project is stored as part of a data model 160, the same information can be presented in a number of different ways. For example, comparing the GUI screenshots shown in FIG. 4 with those shown in FIG. 18, FIGS. 19a and 19b, which are described in greater detail later, it can be seen that the same data items can be displayed in the form of a top-level timeline module 110, or as part of a lower-level action list over time module 116, each having timelines with different timescales.

Referring back to FIG. 8, data relating to projects 162 are split into a number of Activity Groups 174, each of which is group of activities that are planned to take place over a certain period of time in order for the project 162 to be completed. Each Activity Group 174 comprises Bulleted Text Items 170 (for example, to list the main considerations associated with a particular Activity Group 174), and also one or more Sub-Activity Groups 176. Each Sub-Activity Group 176 is associated with a member of the group of activities planned within an Activity Group 174. Each Sub-Activity Group 176 comprises the details of each of the activities planned, such as Actions 178, Milestones 180, Meetings 182 and Issues 188. Each Meeting 182 also has an agenda data element 184 and a minutes' data element 186.

At a general level, when a user inputs information via GUI interaction, the project management application 16 stores this information in the database 158, via the interaction of the page display module 142, the presentation module 144 and the associated interface module 152, with the application state controller 156.

In a more specific example, referring to FIG. 3, as a user is controlling the mouse 18 to select an icon 58 in the toolbox 34 relating to an Activity Group graphical component, the interface module 152 passes information via the application state controller 156 and to the presentation and page display modules 144, 142 to record that this particular icon 58 has been selected. The relevant data is passed to the database 158 when the selected item is committed to the page by the user.

As the user uses the mouse 18 to move the cursor (not shown) to a position along the timeline 56 and selects a position, the interface module 152 generates a graphical component 30 corresponding to an Activity Group 58 located on the timeline 56 at the current cursor position. If the user then uses the mouse 18 to drag the Activity Group graphical component 58 along the timeline 56, the presentation module 144 and page display module 142 reformats the graphical component 58 so that it extends a length along the timeline 56 matching how far the graphical component 58 has been dragged. The presentation module 144 calculates where, in relation to the timeline 56, the user has placed the Activity Group graphical component 58, and how far the along timeline the graphical component 58 has been dragged, and transmits this information to the database 158. The information transmitted includes the data-type, i.e. that the graphical component 58 represents an event item relating to an Activity Group, and also contains information relating to the date range associated with that data-type (indicated by the user dragging the Activity Group along the timeline). Furthermore, the user can also position the Activity Group graphical component 58 on a chosen row of the timeline 56 and this information is also provided to the database 158. If the user uses the mouse to click on the resulting graphical component 58 to label it with text 75, this information is also stored in the database 158.

Notably, the date and/or date range associated with positioning of graphical components 30 relative to the timeline 56 is stored numerically. This has the advantage of allowing the project management application 16 to perform scheduling calculations with that data, which would not be possible with a purely presentational application such as Microsoft PowerPoint®, for example.

If the user wants to add or take away time from the beginning or end of the timeline, or to scroll left or right, then the user can do so by selecting the appropriate one of the shortcut buttons 42. The interface module 152 monitors user selection of these buttons 42 and interacts via the application state controller 156 with the page display module 142 and presentation module 144 to reformat the page 52, and the graphical components 30 displayed thereon accordingly.

If the user wants to change the content and format of the header 44 or the body 46 of the page 52 (for example, minimum/maximum font size of the labels of the graphical components 30) the user can do so by selecting a respective header format controller button 38 or a body format controller button 40. Once again, the interface module 152 monitors the user's selection and interacts via the application state controller 156 with the page display module 142 and the presentation module 144 accordingly, to change the appearance of the page 52.

Any changes made through the selection of the shortcut buttons 42, the header format controller button 38 or the body format controller button 40, are stored in the database 158 as Viewstate information 164 which can be recalled when the project management application 16 is shut down and restarted, so that the user's preferences are recorded.

As mentioned previously, there are several view modules 88 which can be activated at any one time through the user selecting the appropriate icon 37 of the view selector 36. It also possible to access other views by selection of an appropriate user-selected graphical component 30. For example, double-clicking on an Activity Group graphical component 58 when the Timeline view module 110 is active, changes the active view module 88 to the appropriate Activity Group Detail module 112 associated with that graphical component. This enables a user to access intuitively a set of low-level information by interacting with the high-level graphical information associated with that low-level information. In general, most graphical components can be used as portals to other views, and this facilitates simple intuitive user interaction with the project management application 16.

Referring to FIGS. 9 and 10, an example of activation of different view modules 88 is now described. A user double-clicking on (selecting via the GUI 14) an Activity Group graphical component 58 in the timeline view 56 in the GUI 14 causes a view module associated with that specific graphical component to be activated. For instance, double-clicking on the Activity Group graphical component 58a labelled “Senior Management Discussions—Part 1” activates a respective Activity Group detail view 190 (shown in thumbnail version in FIG. 9 and illustrated in detail in FIG. 10). Each of the twelve Activity Groups 58 displayed in the body 46 of the page 52 has its own Activity Group detail view module 88, laying out the specific information about that particular Activity Group 58. In particular each detailed view 190 comprises the header section 44, an expended timeline section 192 where meetings 60 and milestones components 58, 60 are displayed along an expanded timeline 194 extending just over the timeframe of the activity (in this case three weeks), and a list section 196 where each meeting, milestone and action is presented in a list format. The list may be ordered by due date or may remain unsorted and shows additional information such as associated responsibilities, deadlines and status.

The benefit of this arrangement is that it allows the user to have a timeline which communicates an overview of the interaction of different Activity Groups separately from more detailed information about each group itself. Also by separating the lower level (the Activity Group Detail view 190) from the overview (timeline view 56), the user can input detailed information into the GUI 14 without cluttering the main overview of the project as displayed in the hierarchically higher-level timeline view module 110. However, by enabling each of the graphical components 30 to act as a portal to more detailed information, a convenient and intuitive way of user access to that detailed information is provided. Furthermore, since the highest-level information about a particular Activity Group has already been provided in the timeline view module 110 (for instance, the event duration), this information presents itself in the more detailed Activity Group detail view module. For instance, the presentation module 144 can automatically generate the total timeline length and scale 194 within a respective Activity Group detail view module 190. This approach simplifies the user interface at each level that contributes to ease of use and a low-training requirement.

As mentioned previously with reference to FIG. 6, the system is arranged to handle meetings and this is important to the management of a project. Generally speaking, when there is a meeting during the course of a project, points for discussion are raised before the meeting, and after the meeting, the points raised during the meeting are minuted. The project management application 16 includes specific view module 88 called the meeting module 130, which serves to capture such information and store it within the appropriate parts of the data model 160.

The meeting module 130 allows users to set up meeting agendas and minutes both for meetings that are already scheduled in the application database 158 (for example, meetings in the main timeline view module 110 or in specific Activity Groups) or for ad hoc meetings that are not scheduled and thus not shown in the timeline (e.g. project team meetings).

The user can activate the meeting module 130 to open up a blank agenda (or get to existing agendas) by selecting a meeting in any view and using the right click menu or via the “Meetings” menu option in the toolbar 32 at the top of the GUI 14. Sub-options on the meeting menu allow meeting agendas or minutes to be created for ad-hoc meetings that are not scheduled in the timeline.

Meeting minutes can be created for existing or ad-hoc meetings in the same way.

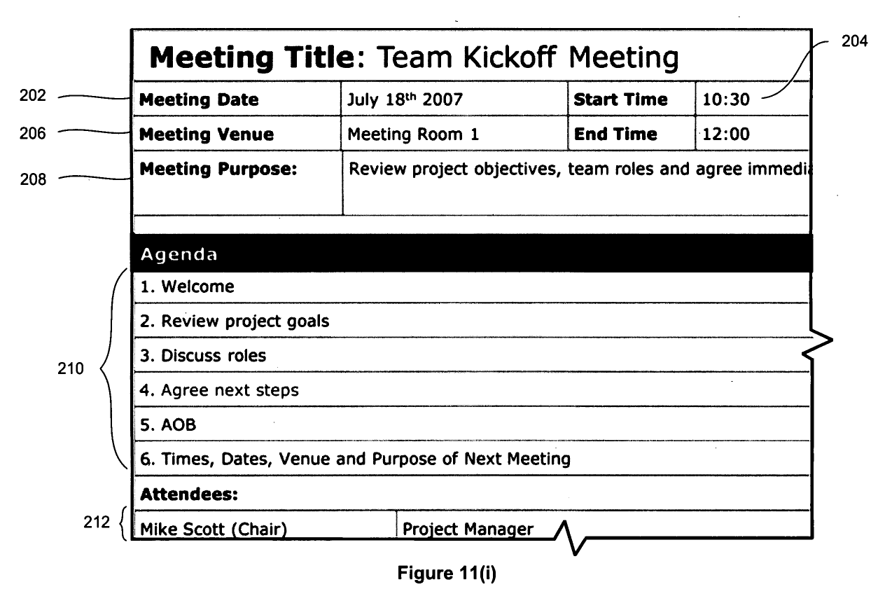

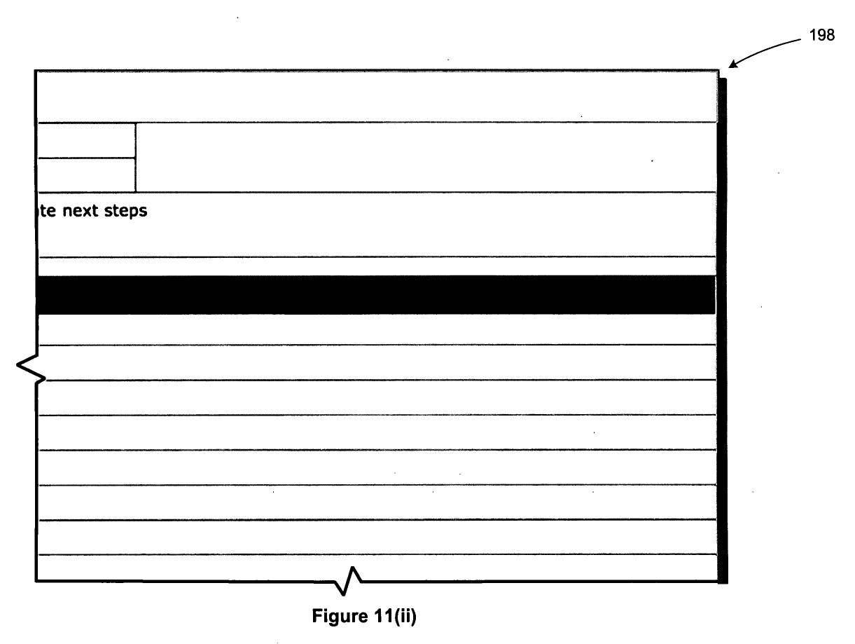

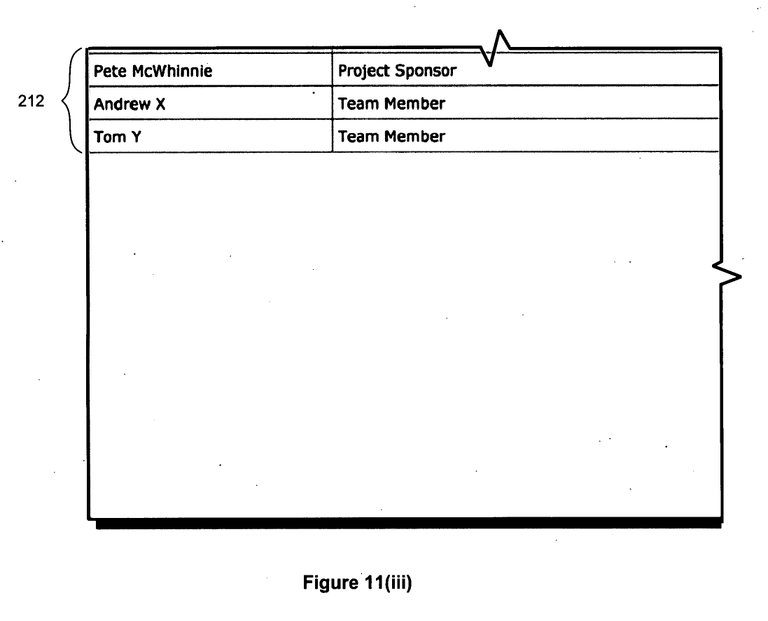

More specifically, referring to FIG. 11, opening up a blank meeting agenda 198 pulls up a standard template 200 for an agenda. The user can then populate this with the meeting date (if not already set) 202, the meeting time 204, the meeting venue 206, the purpose of the meeting 208 and list agenda items 162 and attendees 166 as shown in FIG. 11.

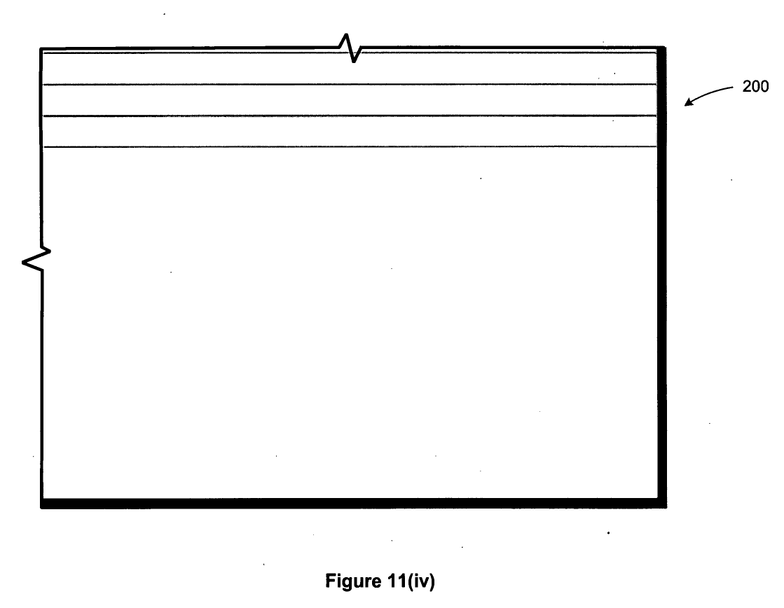

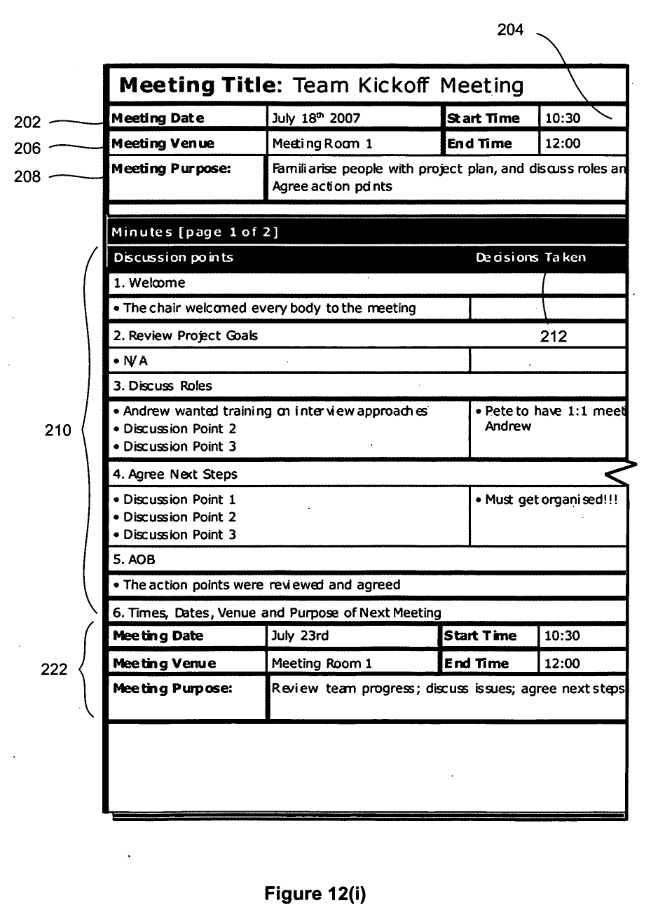

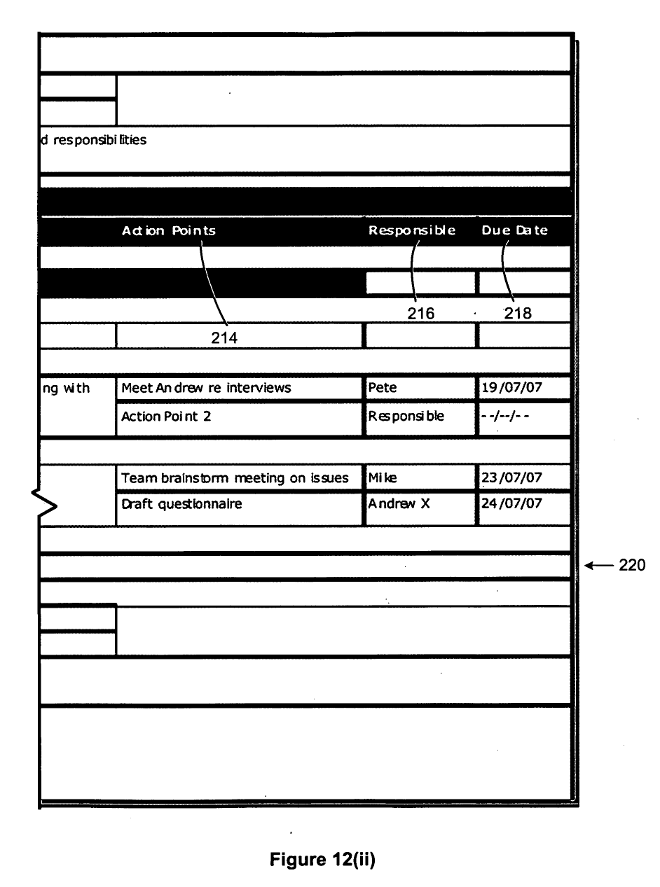

Referring to FIG. 12, the meeting minutes component 132 of this module 88 allows the user to record on a standard minute template 220 two key features. Firstly, decisions taken 212 verses agenda points 162 can be recorded. Secondly, new actions 214, meetings 222, or milestones (not shown) that arise from the meeting, can also be recorded as shown in FIG. 12.

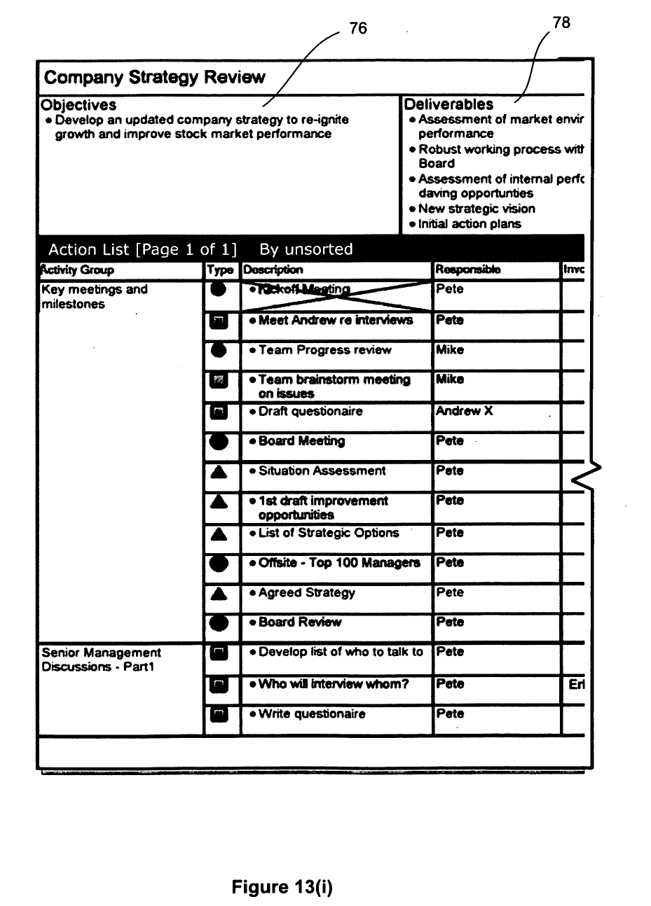

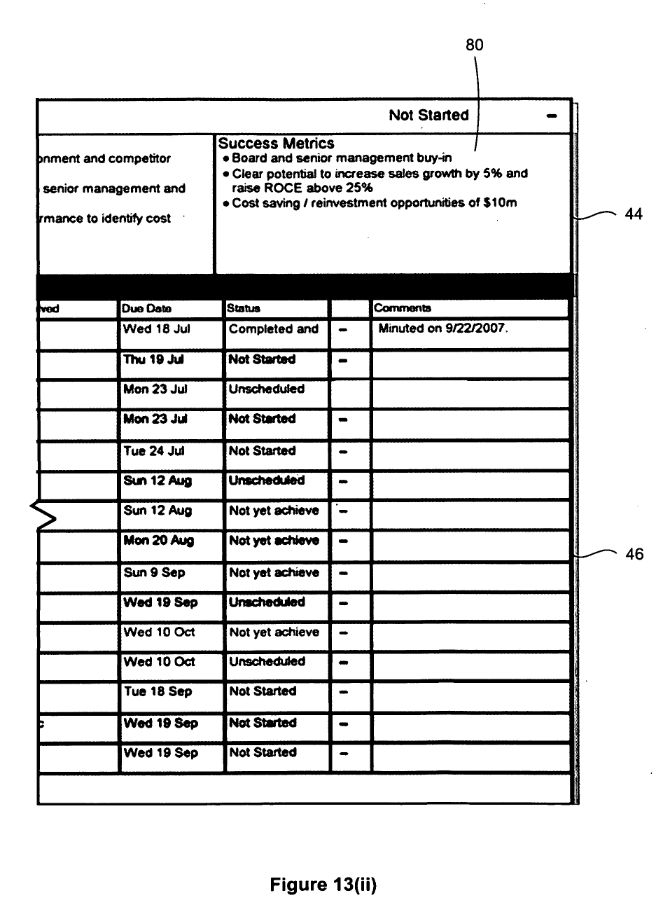

The template 220 also enables the person responsible for the action 216 and the relevant date 218 to be recorded. When the minutes 186 are saved, the actions 214 noted in the minute module 132 are stored in the database 158 according to the data model 160 and can be accessed by other view modules 88. In this way, the project plan can be kept up-to-date. This is possible because the template 220 has specific areas, which translate directly into actions, people and dates. FIG. 13 shows an Action List view 230, which has been updated with the actions points 214, and meetings 222 noted in the minutes template 220 shown in FIG. 12.

A strong link between meetings and the project plan can therefore be created which means that the project plan can automatically be kept up-to-date without rework from the project manager, which in turn makes it more likely that the project plan will be kept up-to-date at all. With all the meetings agendas 162 and minutes 220 in the project file, the relevant information is also all in one place and this makes it relatively easy for the project manager or others to find them. Furthermore, the meeting module 130 also provides a simple way for users to create agendas 162 and minutes 220, in a standard format, which helps users utilise these basic tools of meeting management more easily than creating them from scratch in a word processor or via email.

The meeting module 130, like all view modules 88, can be interfaced with an output module (not shown) within the application 16 for exporting to a data file (e.g. as text, PowerPoint® file, PDF file, GIF file) and/or printing.

As mentioned previously, the project management application 16 displays an area as a page 52 in the same proportions as it would appear on an output page of, for example, a hardcopy printout 24 from the printer 22, or a display area 28 from a projector 26. Referring to FIG. 3, the page delimiter 50 defines a greyed out area which sets the boundary of the page so as to give the user a ‘What You See Is What You Get’ (WYSIWYG) view of the page, an example of which is shown in FIG. 4. Here, only the page content is displayed without editing controls such as the toolbar 32, toolbox 34, view selector 36 and shortcut buttons 42, and this page 52 is outputted to the printer 22, or exported to a file (e.g. PowerPoint®, PDF or GIF files) suitable for presentation on the projector 26 or other display means.

This page 52 has a predetermined, fixed height and width, which corresponds to the proportions the output will have on a page—for example, to the A4 sized page of the printer 22- or on the screen of the projector 26.

The interface module 152, page display module 142 and presentation module 144 interact so that as graphical components 30 are generated and rendered to the page 52 they are sized and arranged so that the graphical components 30 fit to the page.

In one embodiment, the sizing and arrangement of the graphical components 30 is controlled dynamically by the presentation module 144 and does not require user intervention. As the user adds, removes or edits graphical components 30 representing events or other information relevant to a project, the presentation module 144 instantaneously reformats the page 52 to best display the information. This means that a user who is inputting information about a project can focus on the content, instead of being distracted by having to think about the format and presentation of that content. Therefore, this speeds up data entry and the interface between the user and the GUI 14 is enhanced.

The presentation module 144 is arranged to execute a dynamic formatting process for controlling the sizing and arrangement of the graphical components 30. A separate dynamic formatting process is provided for each module 88. Each dynamic formatting process works through approximately the same steps that are described below with reference to the timeline module as a non-limiting example. It is to be appreciated that there are several at least partly conflicting considerations, which the dynamic formatting process balances in order to derive the best fit of the graphical components 30 on the page 52 or multiple pages.

A first consideration is the preference that the graphical components 30 should fit to the minimum number of pages. This facilitates an optimum interpretation of the information represented by the graphical components 30 as the user interpreting the information is presented with it using the minimum number of pages, and can therefore more quickly assimilate that information than if the information is distributed over a greater number of pages.

A second consideration is that a minimum size for graphical components 30 needs to be set. If, for example, a graphical component 30 comprises text having a font size which is too small to be read easily through use of a projector screen (which in many cases has a lower resolution than an personal electronic display) then members of an audience may have difficulties interpreting the information represented by that graphical component 30.

A third consideration is that graphical components 30 should occupy the maximum amount of available space on a page 52 so as to maximise the visual impact of the information represented by the graphical components 30.

A fourth consideration is that graphical components 30 of the same type should be similar in relative appearance, except where the differences in appearance are representative of information. For example, graphical components 30 representing an Activity Group are shown as arrows (see FIG. 4). The horizontal length and position of the arrows along the timeline 56 represent the start and end date of the Activity Group event, and event duration. The relative vertical position between the arrows serves to distinguish between different events. However, the vertical height of each of the arrows is constant for each graphical component 30 representing an Activity Group. This is because the vertical height does not represent any additional information about the Activity Group, and so to represent different Activity Groups with different vertical heights would poorly present that data. Therefore, it is desirable to allocate the relative height of the graphical components 30 representing Activity Groups uniformly.

The above considerations are exemplary of a set of considerations, which are applied to the GUI for generating the dynamically optimised display. However, this is a non-exhaustive list. Other considerations, such as setting the minimum or maximum size for each component (in the vertical dimension), each acting as a constraint within the dynamic formatting algorithm, are possible which can be added to this set but which are not described herein further because the skilled addressee will understand generally how to implement these from the description of the above elements.

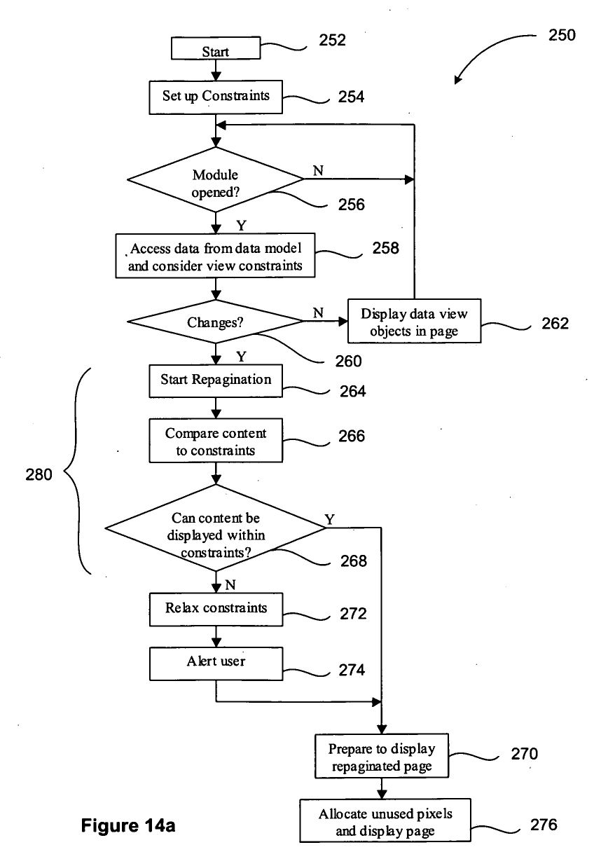

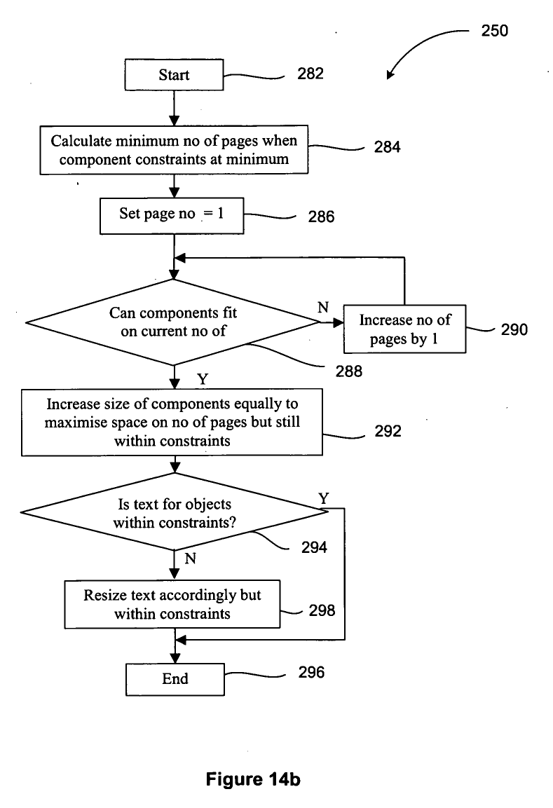

Referring now to FIG. 14a, the steps of the dynamic formatting process 240 (referred to as the method), which generally balance the above-described set of considerations, is described below. The method includes the Dynamic Formatting Algorithm (DFA), which is implemented on the pagination helper module 150.

The method 250 commences at Step 252 with the setting up of constraints at Step 254. The method has a set of default sizes and format settings for the page layout and for the different objects that can be displayed within the page 52. The user, through use of the formatting buttons 38, 40, may alter these sizes and settings, within certain minimum and maximum values, for example. The key settings for the DFA are those that relate to the height and width of different objects for display, and the selection of which elements should be displayed (e.g. how many rows for Activity Groups, key meetings 60 and milestones 64 etc).

For the avoidance of doubt, the graphical components 30 to be displayed on the page 52 when a particular view module 88 is active are stored, as such, in the database 158 as part of the data model 160. This includes the results of user-editable options to hide or reveal entire display regions such as those associated with Key Meetings 60, Key Milestones 64 and Activity Groups 58 as well as particular individual graphical components 30 within each of the display regions. Within each view module 88 it is possible to have several alternative configurations in which different sets of graphical components can be chosen to be displayed in a variety of configurations, as is described later.

The DFA continually checks, at Step 256, the database 158 to determine whether such information has changed, for example by user interaction with GUI 14 resulting in the opening of a module. If it has not, the method 250 simply keeps checking for this event. If however, the information has changed, then the module view controller 148, at Step 258, accesses data from the data model 160, looks at the view constraints, and determines at Step 260 whether there have been any changes since the module was last paginated, in order to determine whether a recalculation of the sizing and arrangement of the graphical components 30 is necessary. The view module controller 148 also reviews the Viewstate information 164 as part of its check at Step 260.

If there has been no change as determined at Step 260, then there is no need for the pagination helper module 150 of the presentation module 144 to do anything, and the page display module 142 displays at Step 262 the pages it already has. The method 250 in this case returns to the step of continually checking the database 158 at Step 256 to determine whether anything has changed.

However, if there has been a change, as determined at Step 260, in either the data to be displayed or the constraints limiting how that data is to be displayed, then the pagination helper module 150, implementing the DFA, commences a repagination process at Step 264. This involves comparing content to be displayed with the associated constraints at Step 266 and executing a recalculation of how the graphical components 30 may be sized and arranged on the page 52, to balance the above-mentioned considerations. This process is effected by the DFA which described, in detail, later with reference to FIG. 14b.

A check is carried out at Step 268 to determine whether the repaginated page can be displayed. In other words, at this stage, the presentation module 144 determines whether the changed repaginated page content meets the current constraints. If it does, then the data relating to the page is passed to the appropriate data viewer object 146 in the page display module 142, which takes the relevant data and converts it into a data set for the appropriate display module 88, e.g. the timeline display module 110. The corresponding data view object 146 then prepares to render the data to the screen 12 at Step 270 using the calculated height and widths of each component 30 as a percentage of the page 52 and applies scaling accordingly.

Alternatively, under certain circumstances, it may be impossible to effectively balance all the above considerations, especially if the user-defined constraints are too rigidly set. In such a situation, as determined at Step 268, the method 250 continues at Step 272 by relaxing some of the constraints and also generating, at Step 274, a user prompt warning the user that some of the constraints, or considerations have been relaxed. The subsequent constraint relaxed page or pages are then prepared for display at Step 270 by the page display module 142 as described above.

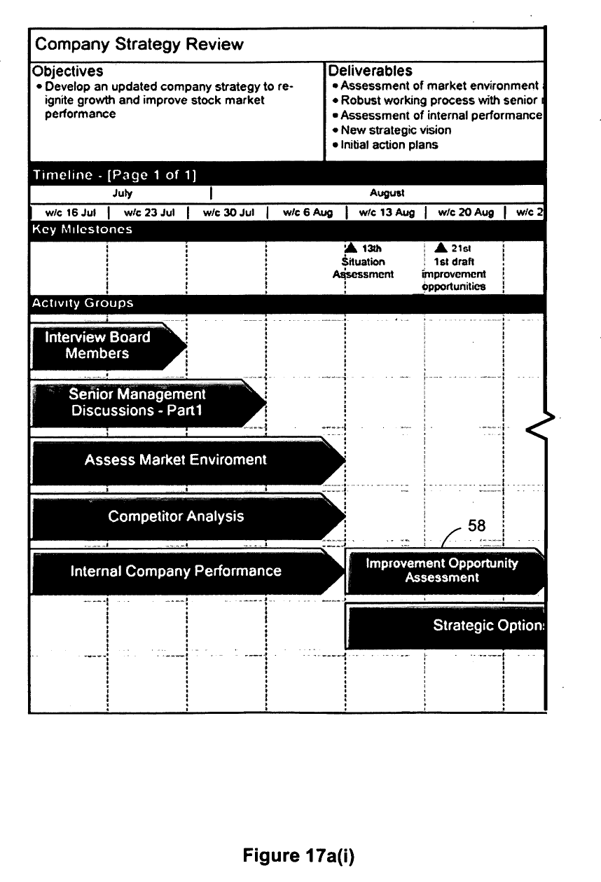

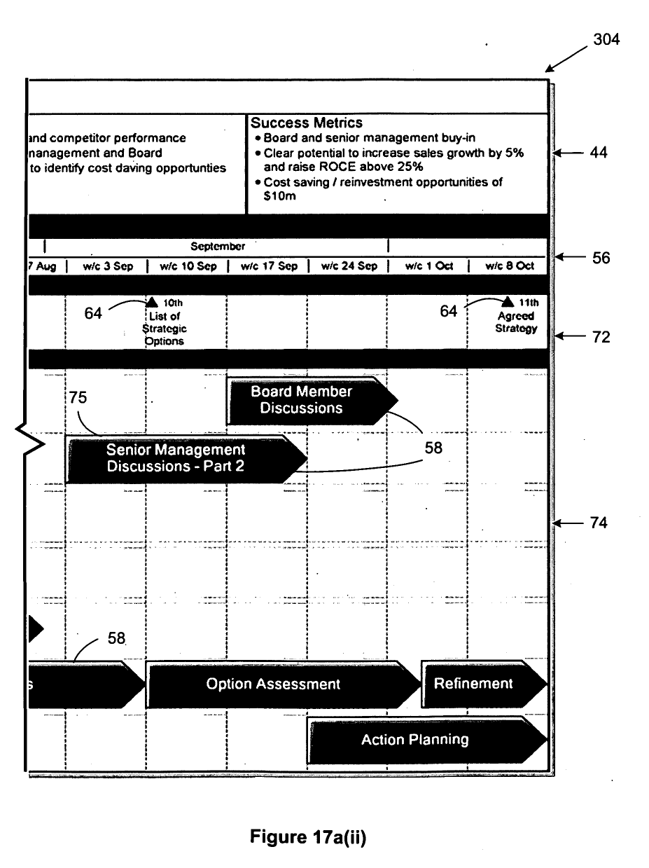

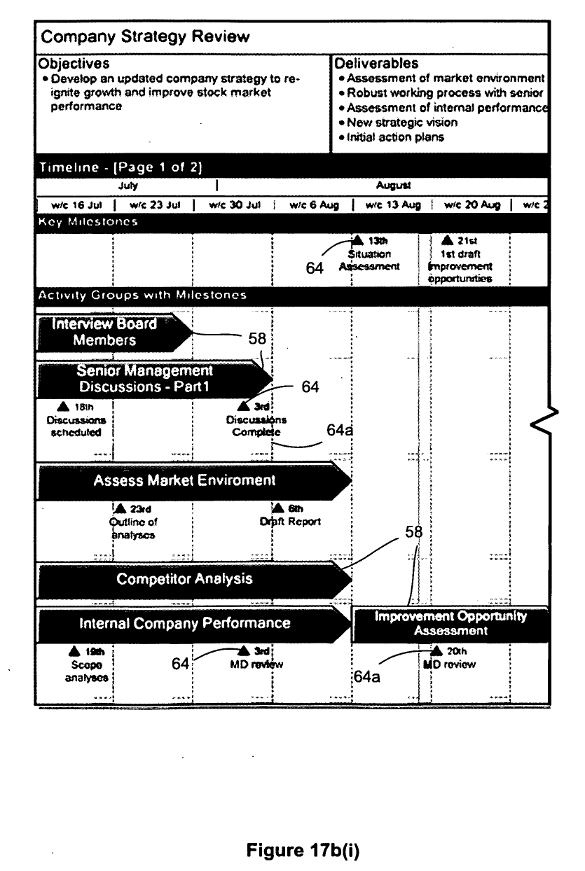

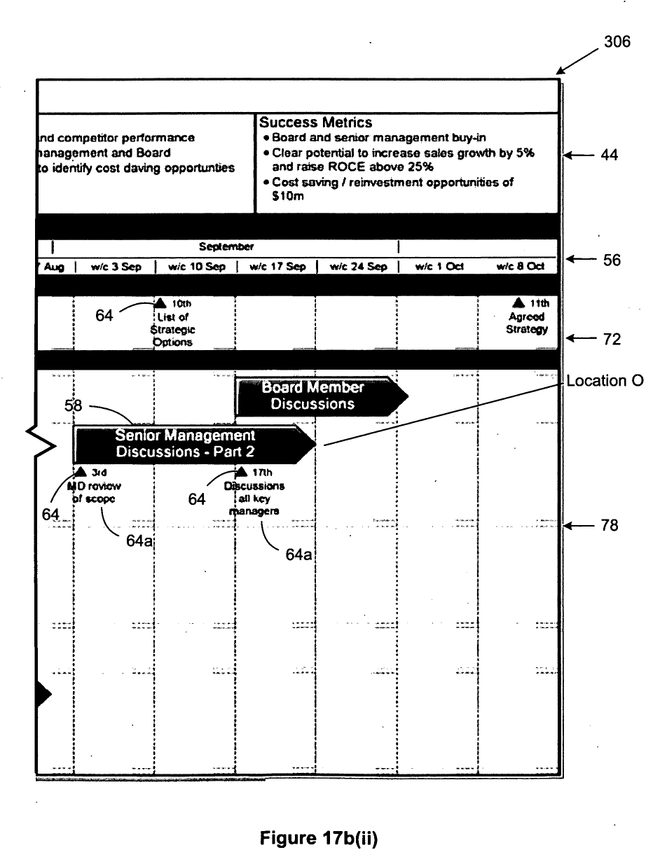

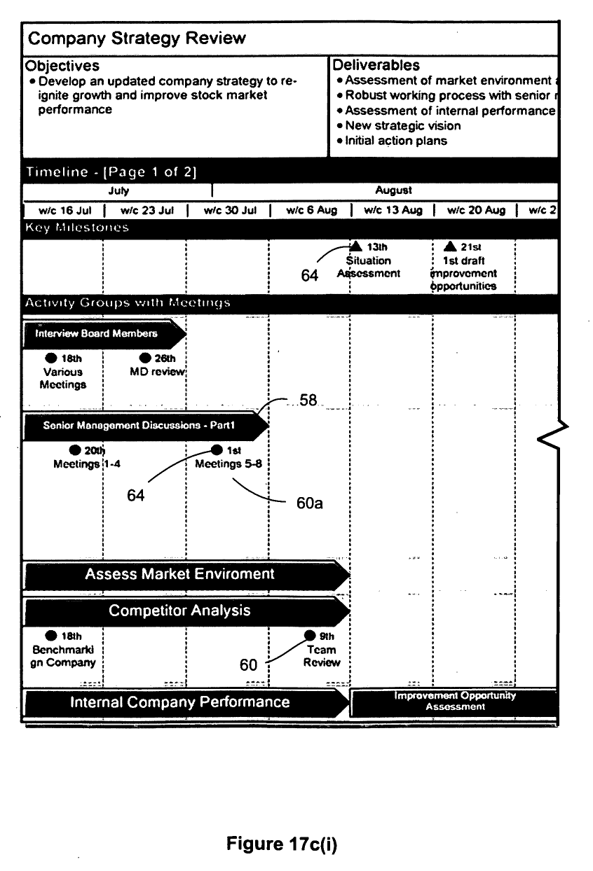

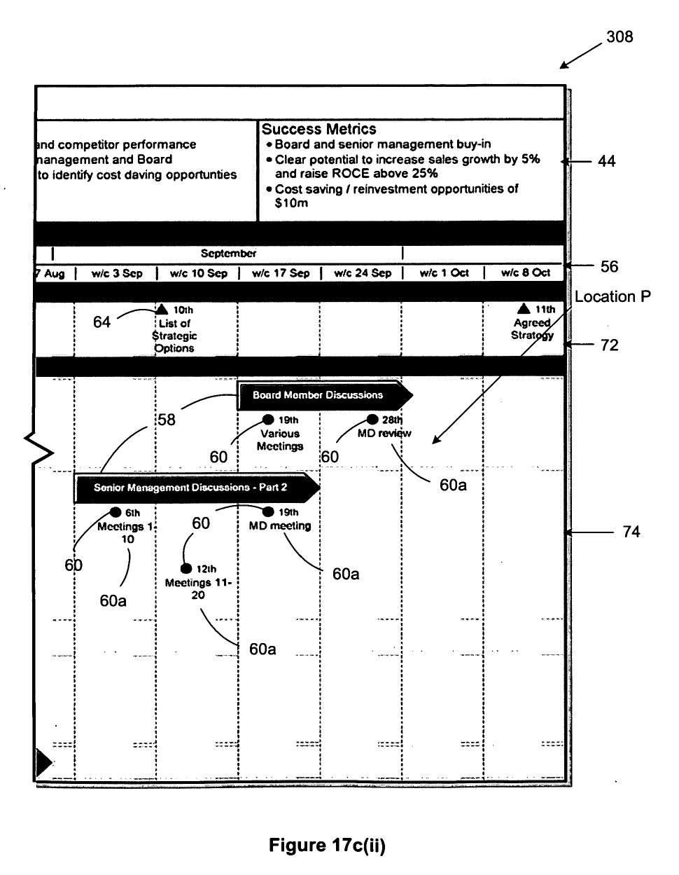

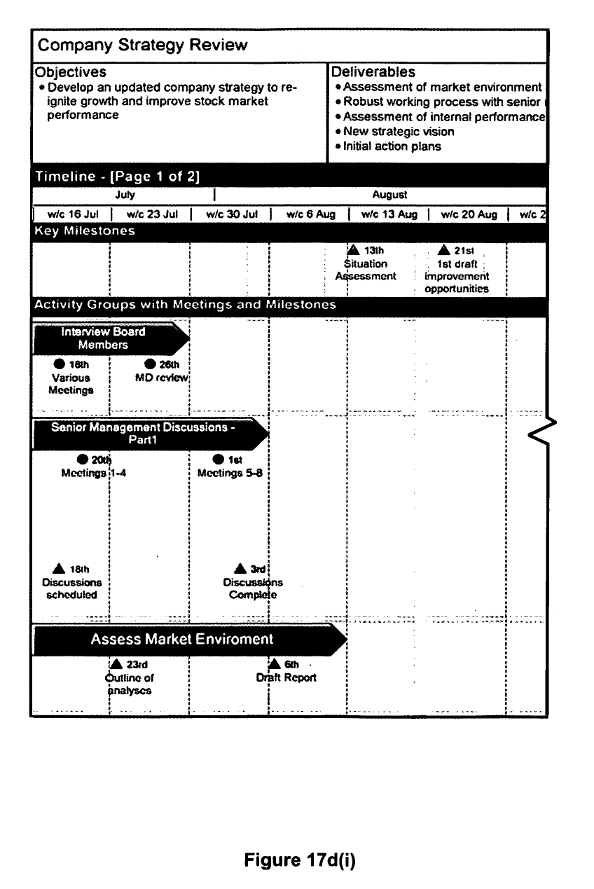

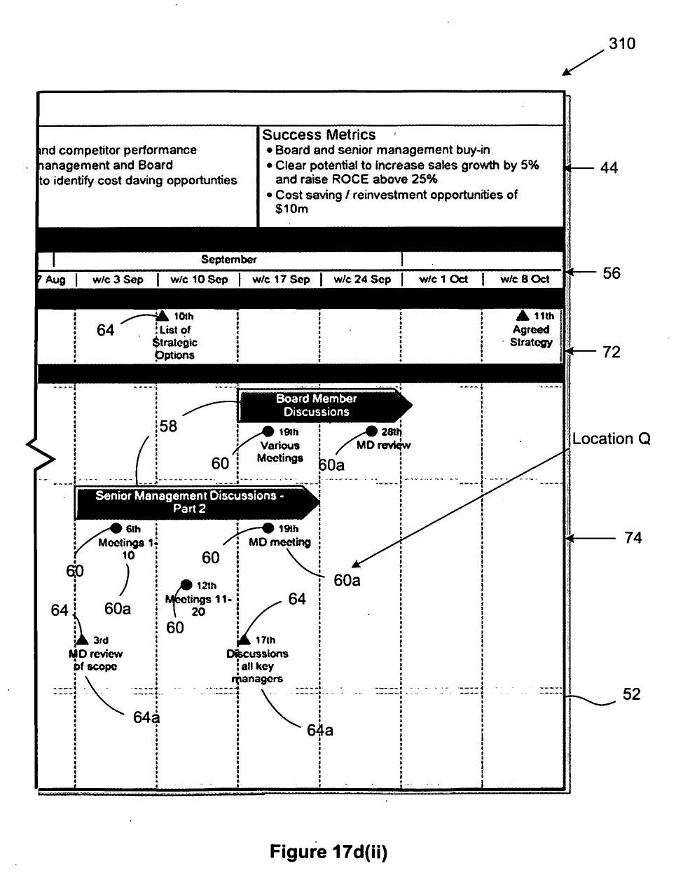

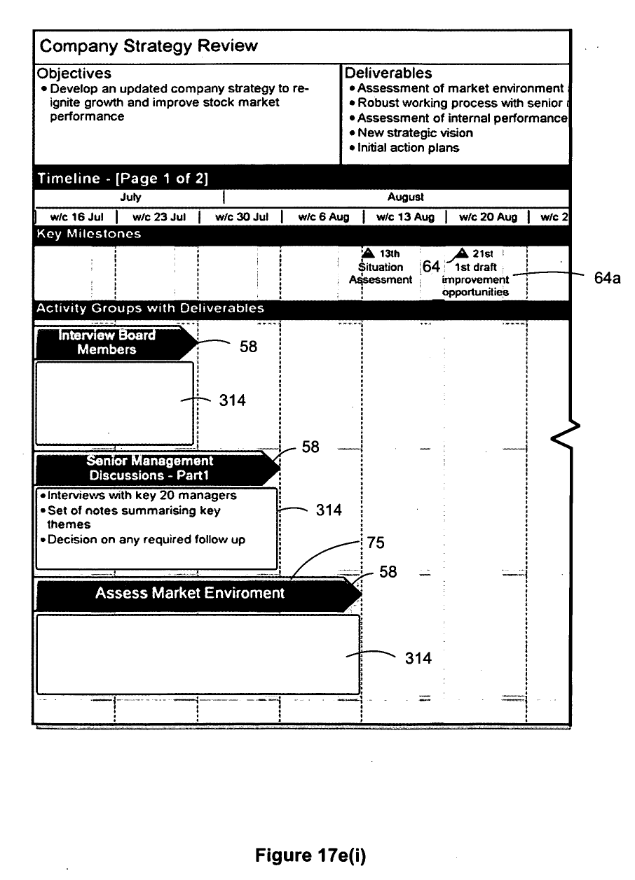

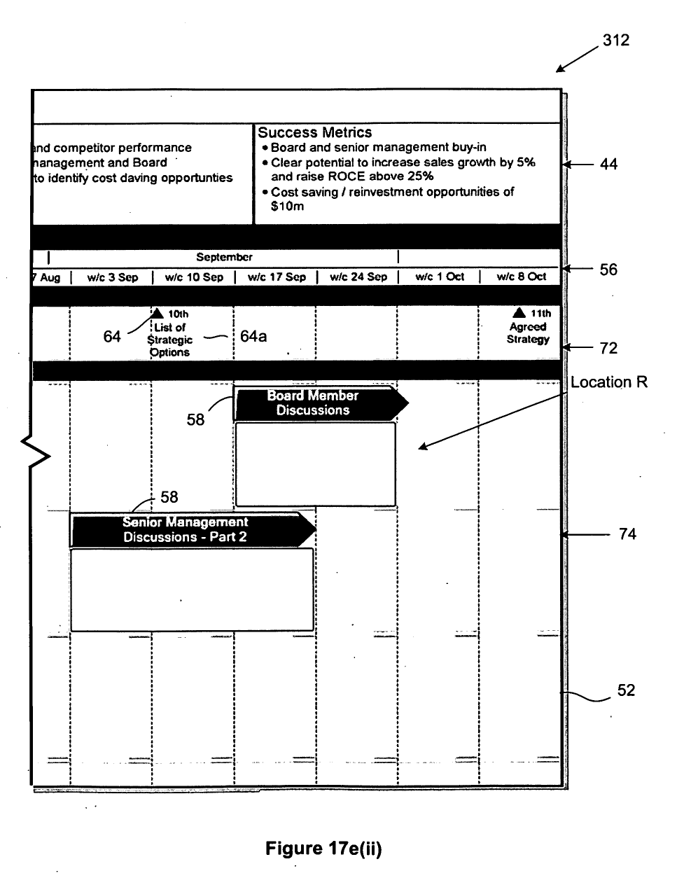

An example of this constraint relaxing aspect is now described. The user can opt to have key meetings 60 and milestones 64 displayed on page one and all subsequent pages of the timeline module. In certain circumstances, when the timeline is in “interlaced mode” (described later with reference to FIGS. 17a to 17e) displaying Activity Groups and their meetings 60 and milestones 64, it might not possible for the key meetings 60 and milestones to be displayed on page two, and this is prevented by the method relaxing this user constraint.

Finally, the last step in the method 250 is to calculate and allocate any extra pixels at Step 276. Here the data viewer object 146 checks to see if there is any unused “grey space” at the bottom of each page 52 and if so, determines the number of pixels in the grey space and allocates them to the other objects on the page 52, increasing the height of each of the objects until the grey space has gone and the page looks “full and complete” and the full page is then displayed. This is described in greater detail later.

The above method 250 takes place when a module is opened for the first time. However, the steps when a user is adding/editing content within the module are essentially the same. The module view controller 148 is watching to see when there are changes that might affect the page display and it initiates a re-pagination (using the DFA 280) when the need arises.

Returning now to the repagination process 280 implemented by the DFA, this is now described in greater detail below with reference to FIG. 14b.

The repagination process 280 commences at Step 282. The DFA starts to calculate at Step 284, a minimum number of pages 52 (each set at the same predetermined size) required to accommodate the graphical components 30 to be displayed, when each of the different graphical components 30 have their respective size attributes (constraints) set to a chosen minimum. Setting the size attributes to the minimum ensures that the number of pages required to display the relevant information is minimised, fulfilling the first consideration, whilst at the same time ensuring the graphical components are not too small.

Initially, a number of pages parameter is set at Step 286 to one page. A check is then made at Step 288, to determine whether the components can fit on the current number of pages. If this is not possible, the number of pages parameter is incremented at Step 290, and the check is carried out again at Step 288.

When the components 30 can fit onto the current number of pages 52, the DFA 280 increases at Step 292 the size of each of the changeable graphical components by an approximately equal amount, so that the size occupied by the graphical components are uniform and maximised on the minimum number of pages. However, the graphical components also have a maximum size constraint that provides an upper bound to the step of increasing their sizes, and the user may also impose constraints in terms of what should be displayed. This may result in a second page not being completely filled with graphical components as the maximum size may have been reached.

It is to be understood that the user, through, for example, the use of the header format controller button 38 or the body format controller button 40 (referred to collectively as formatting dialogues), can customise the minimum and maximum size constraints of each type of graphical component 30. Doing this affects the minimum and maximum size constraints of every graphical component 30 of the same type, and so the user does not need to alter the size constraints of each graphical component individually. Such individual manual altering would depart from maintaining the uniformity of similar graphical components, leading to poorly presented information and also requiring user input for each and every graphical component.

In other words, the dynamic formatting process 250 manipulates information about the size (height and width) of different graphical components 30, their position on the page 52, and the sizing constraints for each graphical component 30 (some of which can be chosen by the user) to automatically fit content to the size of the page 52 or, if constraints have been reached, to break into two (or more) pages 52 as required.

In certain view modules (e.g. the Timeline module 110 shown in FIG. 4) 88, the application 16 subsequently also checks at Step 294 whether the text 75 for objects 30 is still within its predetermined constraints. If it is, the DFA 280 ends at Step 296. Alternatively, the DFA adjusts, at Step 298, the font size of text 75 within graphical components 30 by making the text 75 as big as possible but still within the constraints. If the object is resized, the font size automatically adjusts within pre-set constraints. Following this the DFA 280 ends at Step 296.

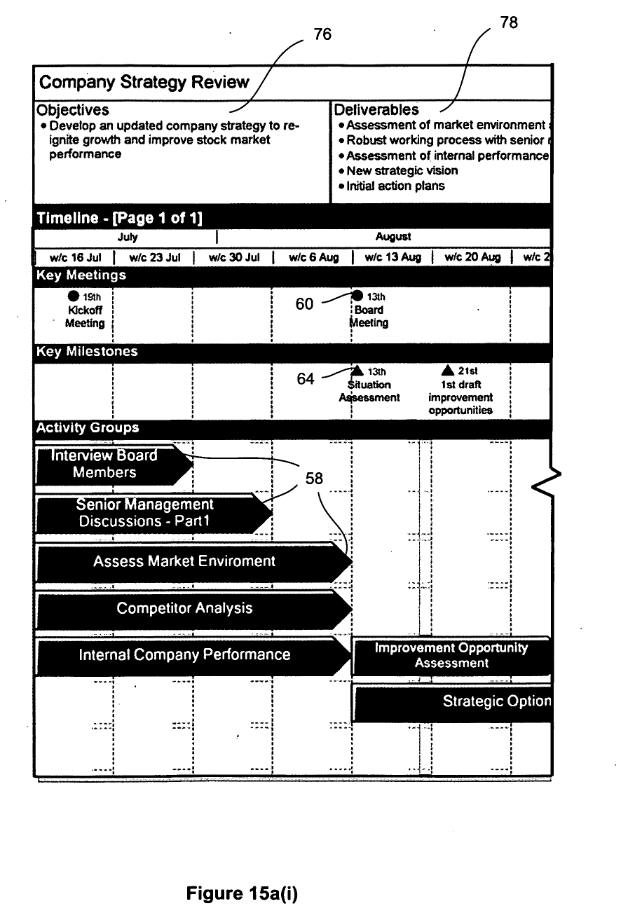

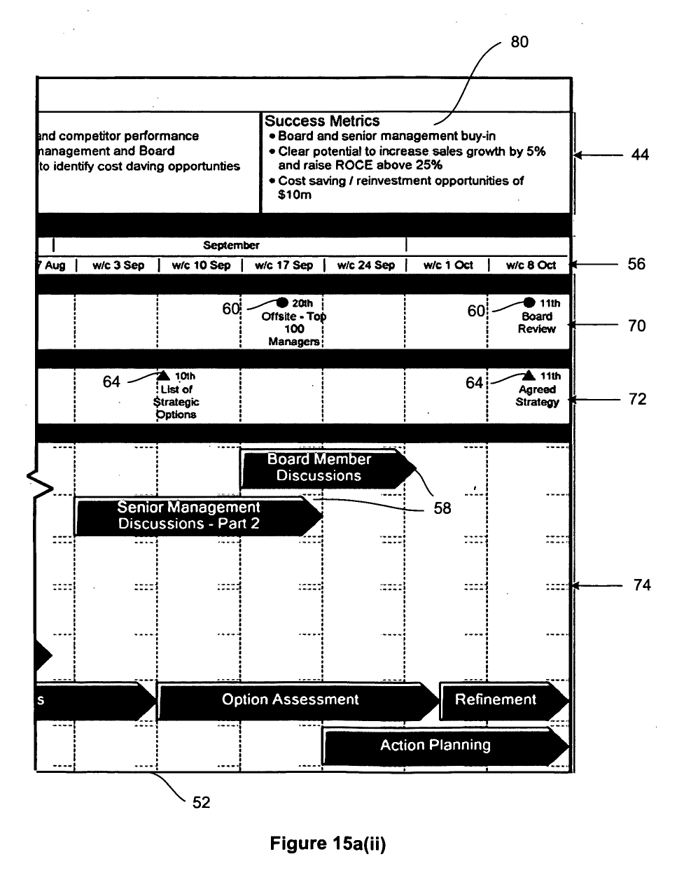

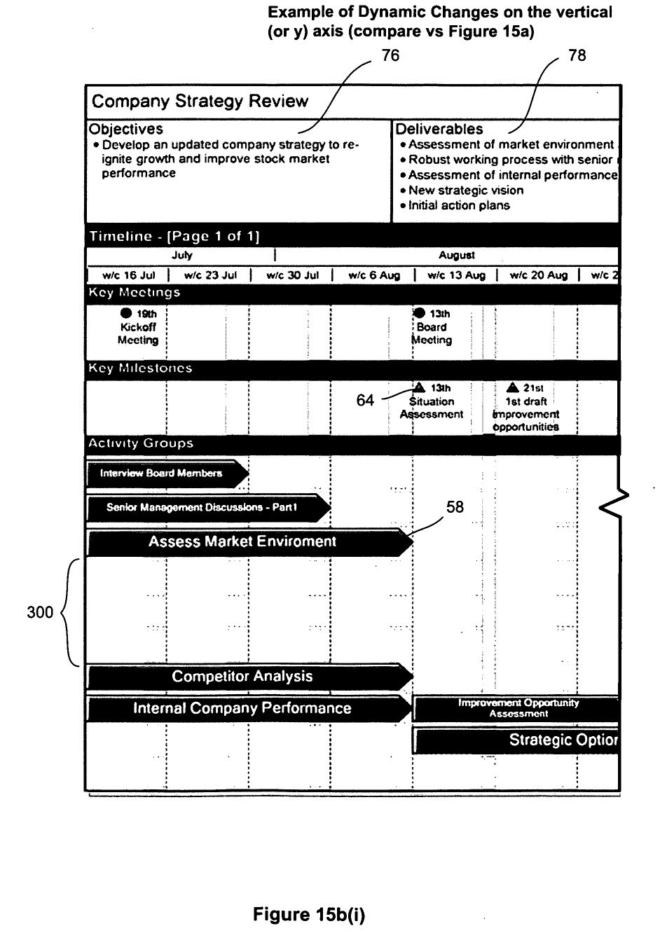

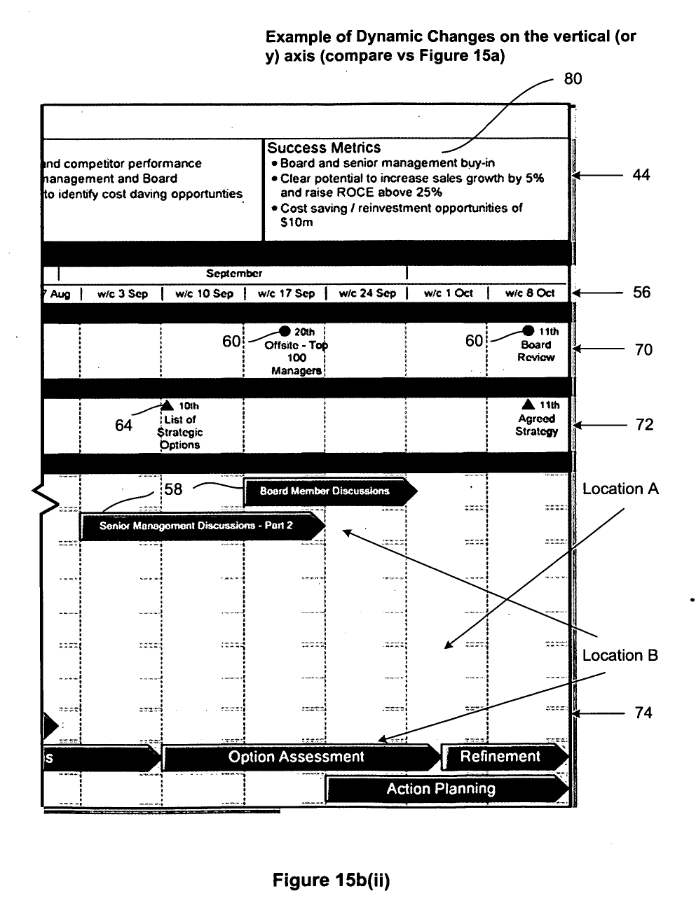

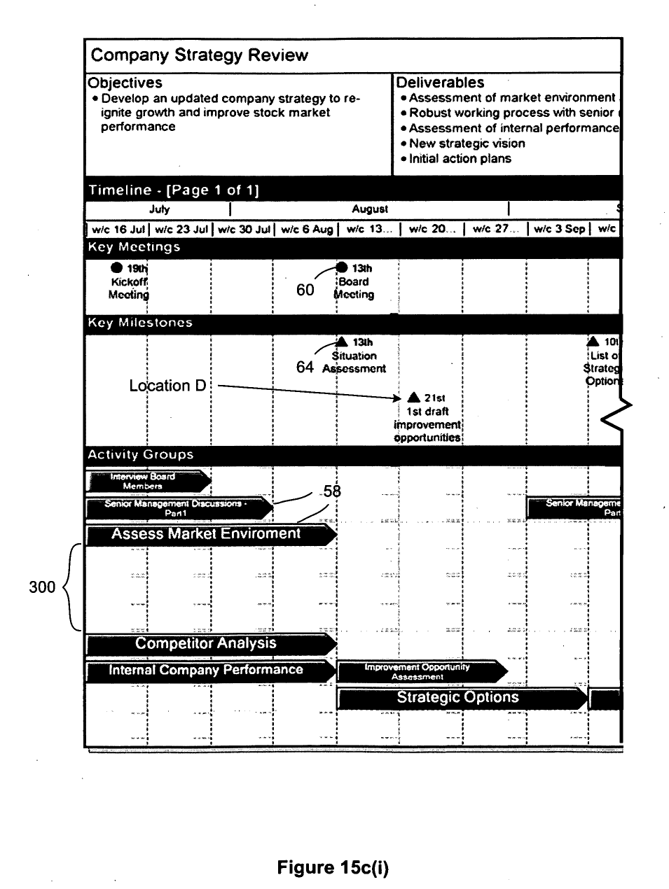

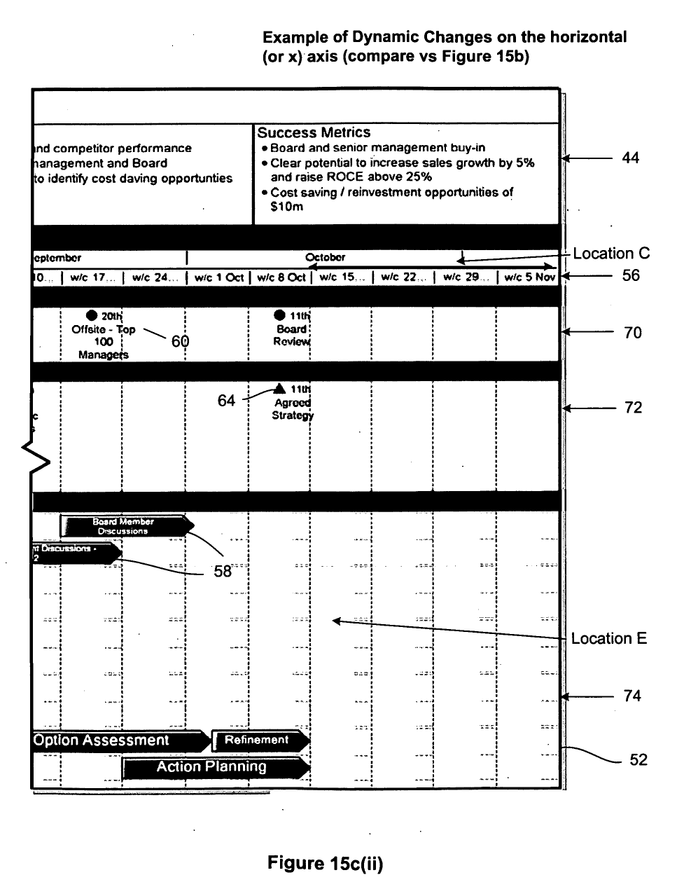

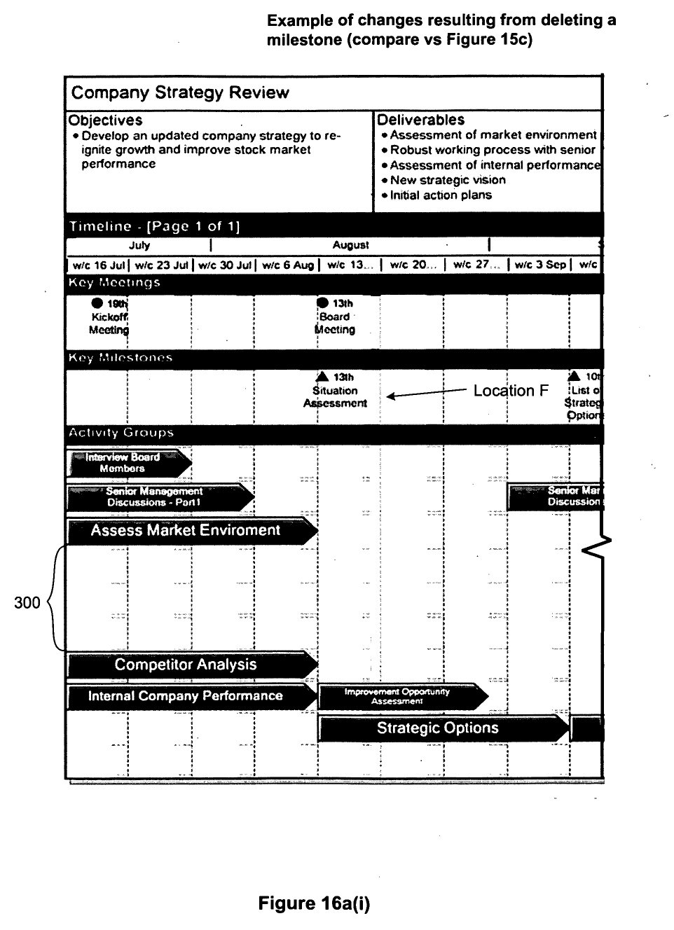

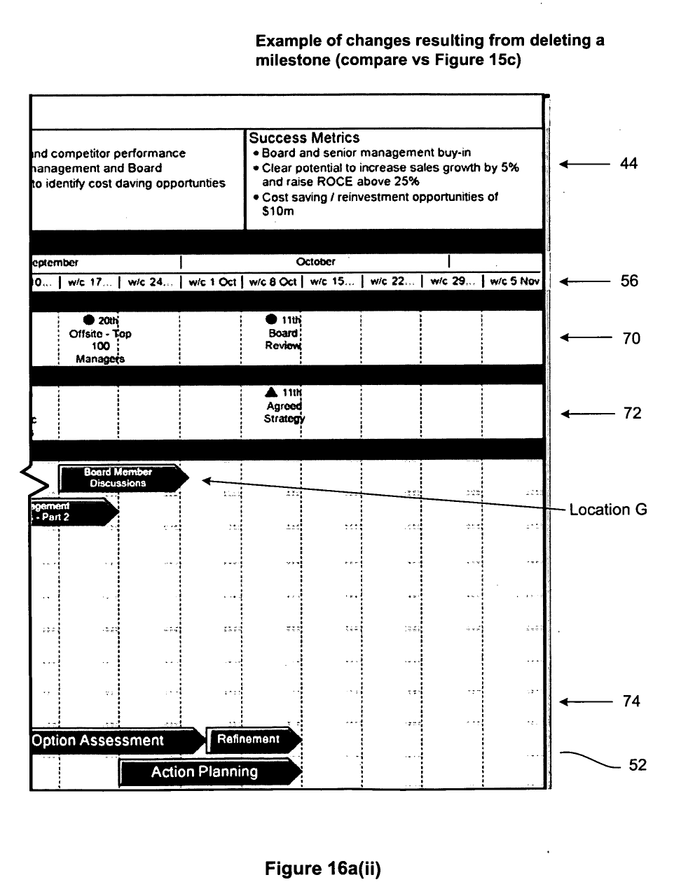

Generally, the DFA 280 chooses the size of the font so that the entirety of the inputted text 75 remains visible, and may also distribute the text evenly within the graphical component—for instance over multiple lines. By way of example, referring to FIG. 15c, the Activity Group graphical component 58 on the second row entitled “Senior Management Discussions—Part 1” has its text 75 distributed over two lines within the graphical component 30 and is smaller relative to the Activity Group graphical component 58 on the last row entitled “Action Planning”—even though these Activity Group graphical components 58 are of the same size. In the situation that the area available within a graphical component 25 is too small to accommodate the text 75 therein set at the minimum font size, truncation of that text occurs. Automatic formatting of the font, in this way, is another way in which the present project management application 16 relieves the burden of choosing the correct formatting from the user.

The size, position and constraint information for different graphical components 30 is taken either from hard-coded constants (e.g. height of the title row), or from a look-up table (not shown) which contains settings which are editable by the user (e.g. desired height of a meeting row as a percentage of the page), or from the data model 160 (e.g. the date position of a graphical component relating to a meeting).

As mentioned, previously, the DFA 280 acts to size graphical components 30 of the same type to be of uniform appearance (e.g. Activity Group graphical components 58 are generally of the same vertical height). However, this can lead to wastage of available space on a page 52. For example, if the vertical space available for Activity Group graphical component is 100 pixels, and there are six Activity Group graphical components 58 to be accommodated within that space, the vertical height (accounting for spacing) of each graphical component would need to be a maximum of 16 pixels. (If each graphical component were 17 pixels in height then this would occupy a total of 102 pixels, and so in excess of the available space).

However, since 16 pixels×6 components=96 pixels, four pixels are being unused, and therefore wasted. Therefore, the last part of the method 250 is the ‘allocate unused pixels’ stage, at Step 276, mentioned previously. Here surplus available space is determined, and then made use of, for example by distributing the surplus space over certain graphical components. In this specific case, a single pixel would be added to the vertical height of four of the six graphical components, thereby maximising the space occupied by the graphical components so that the page 52 is presented to be full and complete.

An example of how the presentation module 144 runs the DFA 280 when the timeline module 110 is activated is now described, but it is to be appreciated that similar operation and principles are applicable to the other view modules 88 of the project management application 16.

Referring to FIG. 15a, on activation of the timeline module 110, the presentation module 144 determines that the following components 30 need to be displayed, listed in order from top to bottom: a header section 44, a timeline section 56 having a section label, a key meetings display region 70 having a section label, a key milestones display region 72 having a section label, and an activities group display region 74 having a section label with, in this case, seven rows of Activity Groups 58.

Then (assuming the view module controller 148 has asked the DFA 280 to re-paginate at Step 264), the question is asked ‘Can the content be displayed?’ as has been mentioned previously, in certain circumstances, the size of the components that the user wants to display will be too much for the page and the DFA 280 takes action to prevent this and to inform the user. For example, if the user is trying to display the following: the full page header: maximum 25% of the page height; three rows each of key meetings 60 and milestones 64 (six rows in total) at a maximum 12% of the page height per row, which equals 72% of the page height; three section labels (Timeline, Key Meetings and Key Milestones) at a total of 8.7% of the page height, and the timescale (date) rows at 5.5% of the page height, the content for display in theory accounts for 111.2% of the page height. Further, if the user has selected to display the key meetings 60 and milestones 64 on all timeline pages 52, rather than just on the first page 52, this would lead to it being impossible to display the Activity Groups 58 at all. The DFA 280 handles these problems in two ways:
a. If the user is trying to display multiple rows of key meetings 60 and milestones 64 on all pages, the DFA 280 will warn the user this might pose a problem, and where it detects that a problem has occurred, it only displays the key meetings 60 and milestones 64 on the first page; and
b. In the case where there are many rows of key meetings 60 and milestones 64 and the total height of the content exceeds 100% (as above), the DFA 280 reduces the actual height of the key meetings and milestones rows to ensure that the header and key meeting and milestones content fits to page 1.

Note, in the FIG. 15a example, the user is not trying to display the header and key meetings 60 and milestones 64 on all pages and there is only one row each of key meetings 60 and milestones 64, so there would be no need for a warning or action on this from the DFA.

In this example, the following components have fixed or user-defined height constraints, calculated as a percentage of the total page height:

| | | |
|---|---|---|
| a. | Header section: | 22.8% |
| b. | Section labels for the timeline, key | 8.7% |
| | meetings, and key milestones @ 2.9% each | |
| | Total for section labels = 3 × 2.9% = | |
| c. | Timescale rows: | 5.5% |

In order to calculate the space the key meetings/milestone display regions will occupy, the DFA 280 determines how many rows are required to accommodate the graphical components 60, 64 associated with the key meetings/milestones. From querying the database 158 (reading a look-up table provided—not shown), the DFA determines that the user-defined width of a meeting/milestone graphical component 30 has been set as 7% of the page width, and that the timeline date range is ninety-one days (16^{th} July to 14^{th} October). Therefore, because the timeline extends across the entire horizontal width of the page 52, a meeting or milestone graphical component 30 occupies 7% of 91 days=6.4 days. Since these graphical components 30 are aligned relative to the timeline to indicate when the meeting/milestone is scheduled, the dynamic formatting algorithm 280 can infer that if every meeting/milestone to be displayed is at least seven days from another, then there will be no overlap between the graphical components representing the meetings 60 and milestones 64, and so it is possible to fit the respective series of meeting/milestones onto one row. If there are two meetings 60 or two milestones 64 within six or fewer days from one another, then more than one row is necessary. The DFA 280 can retrieve this information about meetings/milestones from the database 158 to find out the date spacing between meetings/milestones.

In the present example, the date spacing between each meeting is at least seven days and the date spacing between each milestone is also at least seven days, and so only one row each is required for the key meetings and key milestones display regions 70, 72. However, this is the point where the DFA 280 would reduce the key meeting or milestone row height if needed to get the content on the page—see above.

Since a single row has a predefined vertical height of 8% of the total page height, then the DFA determines that the total cumulative height so far is 53% of the page height:

| | | Cumulative Height |
|---|---|---|
| Component | Height (% of page) | (% of page) |
| Header section | 22.8% | 22.8% |
| Timescale rows | 5.5% | 28.3% |
| 3 section labels (timeline, key | 3 × 2.9% = 8.7% | 37.0% |
| meetings, key milestones) | | |
| Key Meeting and Milestone | 2 × 8% = 16% | 53.0% |
| rows | | |

Therefore, the DFA determines that the remaining available height as a percentage of the total vertical height of the page in which to accommodate the Activity Group display region is 47%.

Upon further query of the database 158, the DFA determines that seven Activity Group rows need to be provided together with eight ‘spacers’ above and below the rows—spacers being set as a default 15% of the height of the Activity Group rows themselves. Thus, the DFA splits the remaining 47% in the following way:

47%=7×(rows)+8×(spacers)

One spacer=0.15×(row height)

Therefore:

One Activity Group row=(47%/(7+(8×0.15)))=5.7% of total page height; and

One Activity Group spacer=15% of 5.7%=0.86% of total page height.

Therefore, the total height of the page is occupied by the components to be display as follows:

| | | Cumulative |
|---|---|---|
| | | Height |
| Component | Height (% of page) | (% of page) |
| Header section | 22.8% | 22.8% |
| Timescale rows | 5.5% | 28.3% |
| Three section labels (timeline, | 3 × 2.9% = 8.7% | 37.0% |
| key meetings, key milestones) | | |
| Key Meeting and Milestone | 2 × 8% = 16% | 53.0% |
| rows | | |
| Activity Group rows | 5.7% × 7 = 40.1% | 93.1% |
| Activity Group spacers | 0.86% × 8 = 6.9% | 100% |

Once the dynamic formatting process has executed and worked out the relative sizing, spacing and arrangement of each of the graphical components, this data is passed to the page display module 142, which then prepares to render the items to the GUI screen. As the screen comprises an absolute number of pixels, then when calculating how many pixels are to be allocated for each of the components, the amount is rounded down. For example, if the total height of the page is 800 pixels, then each Activity Group row will occupy:

<Round down>(5.7%×800)=45 pixels.

As a result, there are extra pixels left over at the end to be redistributed evenly amongst graphical components as appropriate—some with 45 pixels, some with 46 pixels.

Still referring to FIG. 15a, if additional space for three more graphical components 30 relating to Activity Groups are required, for example, between the existing Activity Groups entitled “Assess Market Environment” and “Competitor Analysis” then the height of every one of the rows (and spacers) along which the existing graphical components associated with Activity Groups are aligned is shrunk by a uniform amount to accommodate the three extra rows and spacers.

Referring now to FIG. 15b, the user has inserted three new Activity Group rows 300 at location A and the DFA 280 has recalculated the heights of each row. Whilst the DFA recalculates the heights and display on each user row insertion, for the purposes of this example, the insertion of the three rows 300 is treated as a single action. Firstly, the page display module 142 establishes the need for repagination due to the insertion of extra rows 300. It knows that following are selected for display: a) the header section 44, b) a timescale date row 56, c) key meetings 60 and milestones 64 just on page 1, and d) seven rows of Activity Groups 58 plus three new rows 300=ten rows total.

The DFA next determines whether the content can be displayed? The page display module 142 informs the DFA that nothing has changed that will affect this question and so the DFA skips this step.

Assessing how many rows of key meetings 60 and milestones 64 are needed. The page display module 142 informs the DFA that again nothing has changed that will affect this question and so the DFA skips this step too.

The DFA looks at the heights of the various components 30 to identify how much of the page 52 is left over for Activity Group rows. The tables and commentary below illustrate the data and the process:

| | | Cumulative |
|---|---|---|
| | | Height |
| Component | Height (% of page) | (% of page) |
| Header | 22.8% | 22.8% |
| Timescale rows | 5.5% | 28.3% |
| Section labels (3): timeline, key | 3 × 2.9% = 8.7% | 37.0% |
| meetings, key milestones) | | |
| Key Meeting and Milestone rows | 2 × 8% = 16% | 53.0% |
| Height Remaining for Activity Group | | 47.0% |
| Rows and Spacing Between | | |

The DFA has worked through the components with fixed/user determined heights, and identifies that 47% of the page is left for Activity Group rows and the spaces between them.

It then looks at the number of Activity Group rows (ten), the user setting for the gap between rows (default is 15% of the Activity Group row height) and divides the remaining space into a height for each of the Activity Group rows (47.0%/(10+(11×0.15))=4.03%) and a height for each spacing (15%×4.0%=0.6%). It is to be noted that regarding the calculation: the 0.15 relates to the row spacing. There are eleven spaces at the top/bottom of the ten Activity Group rows hence the 47% needs to be divided between 10 Activity Group rows and 11 spaces. The remaining height is thus allocated as follows:

| | | Cumulative Height |
|---|---|---|
| Component | Height (% of page) | (% of page) |
| Activity Group Rows | 4.03% × 10 = 40.3% | 93.3% |
| Activity Group Row | 0.61% × 11 = 6.7% | 100.0% |
| spacing | | |

So it is clear that the height of the Activity Group rows has shrunk (see Location B) relative to the rows of FIG. 15a, from 5.6% to 4.03%. Also as can be seen at Location B, the font sizes for the text in each Activity Group are now set by the DFA within the minimum and maximum font size constraints, and, in this example, the font sizes are reduced relative to the font sizes of FIG. 15a.

Also the heights of the ten rows, the graphical components 30 relating to Activity Groups, and the label font 75 of each of the graphical components 30 are reduced by the same amount so as to maintain the uniform appearance of the displayed graphical components 30, and also to keep all the graphical components to be displayed on a single page 52. However, at the top of the page 52 the header 44, timeline 56, key meetings and key milestones rows 70,72 have not changed in size. It is possible to keep the graphical components 30 displayed on a single page because the minimum size constraints of the graphical components 30 have not been broken.

Thus the vertical sizing and arrangement of the graphical components 30 has been managed by the presentation module 144 without requiring user intervention, the user only needing to specify which additional components are required, and not the formatting.

The presentation module 144 can also manage horizontal sizing and arrangement of the graphical components 30 on the page. For example, if the user desires to extend the time over which events take place during a project, the user can do so by extending the date range of the timeline 56. An example of this is provided with reference to FIG. 15c, where the user has added (at Location C) four weeks onto the end of the timeline date range as previously displayed in FIG. 15b. Since the page 52 has a fixed, predetermined width, in order for this additional date range information to be displayed, the timeline 56, and the graphical components 30 aligned with the timeline have to be altered (shrunk and shifted) as is described below.

The page display module 142 identifies that an action (adding length to the timeline) has occurred and that there is a need for a repagination. It knows that the following are selected for display: a) the header section 44, b) a timescale date row 56, c) key meetings and milestone rows 70, 72 just on the first page, and d) seven rows of Activity Groups plus three rows 300=ten activity group rows 74 in total.

The DFA 280 next determines whether the content can be displayed? The page display module 142 informs the DFA that nothing has changed that will affect this question and the DFA skips this step.

Assessing how many rows of key meetings 60 and milestones 64 are needed. Here the page display module 142 informs the DFA that this needs to be reassessed.

From the lookup table, the DFA identifies that the user has set the width of a meeting or milestone to 7% of the page. It identifies that the timeline date range is now 119 days (16^{th} July to November 11^{th}), and determines that a meeting 60 or milestone 64 takes up 8.3 days of time. So now the DFA knows that if one milestone is nine days after another, it can be placed on the same row, but if they are eight days apart, or less, there will be an overlap and two rows will be needed.

The DFA 280 then works through the meetings 60 to determine whether any of them would overlap, and concludes that they won't (since the four meetings 60 in FIG. 15c are at least two weeks from each other) and so they are all placed on one row.

The DFA repeats the exercise for milestones 64, and this time identifies that two milestones 64 (those on August 13^{th} and 21^{st}) are less than nine days apart and will overlap. Accordingly, the DFA determines that two rows are needed for the milestones 64 at Location D.

The DFA looks at the heights of the various elements to identify how much of the page is left over for Activity Group rows. The tables and commentary below illustrate the data and the process:

| | | Cumulative |
|---|---|---|
| | Height | Height |
| Component | (% of page) | (% of page) |
| Header | 22.8% | 22.8% |
| Timescale rows | 5.5% | 28.3% |
| Section labels (3): timeline, key | 3 × 2.9% = 8.7% | 37.0% |
| meetings, key milestones) | | |
| Key Meeting and Milestone rows | 3 × 8% = 24% | 61.0% |
| Height Remaining for Activity | | 39.0% |
| Group Rows and Spacing Between | | |

The DFA works through the elements with fixed/user determined heights, and identifies that 39% of the page is left for Activity Group rows and the spaces between them. It then looks at the number of Activity Group rows (ten), the user setting for the gap between rows (default is 15% of the Activity Group row height) and divides the remaining space into a height for each of the Activity Group rows (39%/(10+(11×0.15))=3.35%), and a height for each spacing (15%*3.3%=0.5%). The remaining height is thus allocated as follows:

| | | Cumulative |
|---|---|---|
| | | Height |
| Component | Height (% of page) | (% of page) |
| Activity Group Rows | 3.35% × 10 = 33.5% | 94.5% |
| Activity Group Row spacing | 0.5% × 11 = 5.5% | 100.0% |

In this case the DFA has both created a new key milestone row and further shrunk the height of the Activity Group rows from 4.03% to 3.35%, as shown at Location E. Further the length of the Activity Group component is reduced to reflect the new date range of the display. The font sizes for the text in each Activity Group are now set by the DFA within the minimum and maximum font size constraints, and, in this example, the font sizes are reduced relative to those of FIG. 15b.

As can be seen in FIG. 15c, the second display region 72 (for milestone components) has been expanded in the vertical direction, since the page 52 has fixed vertical height then the third display region 74, accommodating the Activity Group graphical components, has reduced in size to accommodate for the increase in size of the second display region 72 associated with the Key Milestones 64.

Accordingly, the vertical height of the rows accommodating the Activity Group graphical component, and the graphical components themselves, have each been reduced in order to fit all the relevant information within the confines of the page. Since the minimum size constraints associated with the resized Activity Group graphical components has not been broken then it is still possible to fit all the previously presented information on the page 52 even though extending the timeline 56 has caused reduction in the horizontal and vertical sizing of the graphical components such that all information required to be presented on the page 52 is kept within the confines of the page 52.

Here both vertical and horizontal dynamic resizing of the components within the body 46 of the page 52 in response to extension of the data range is shown.

Other alterations by the user, for example to add, remove or make space for graphical components on the page 52 cause the presentation module 144 to dynamically assess the positioning and arrangement of the graphical components on the page.

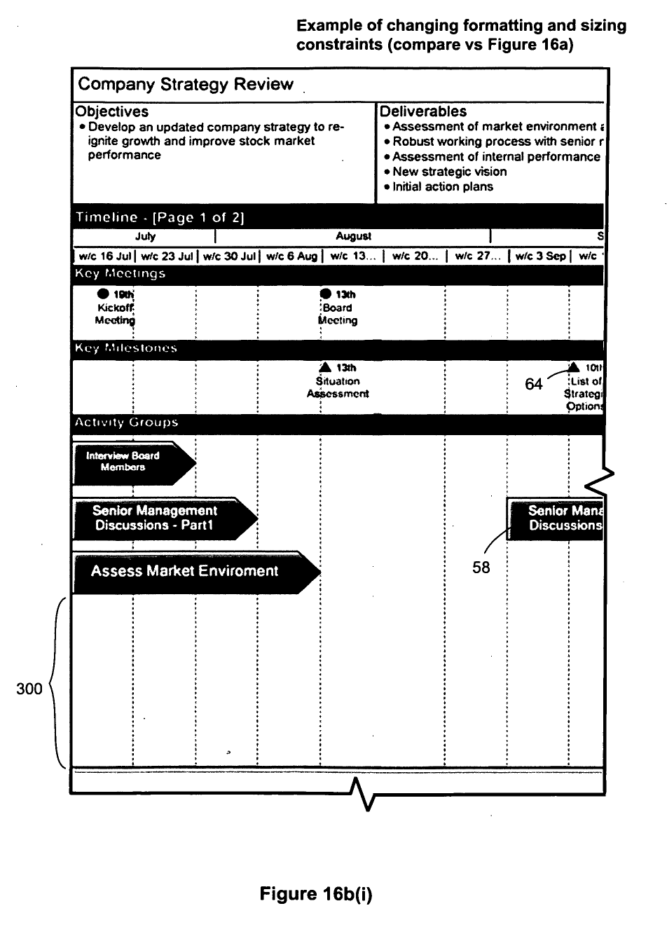

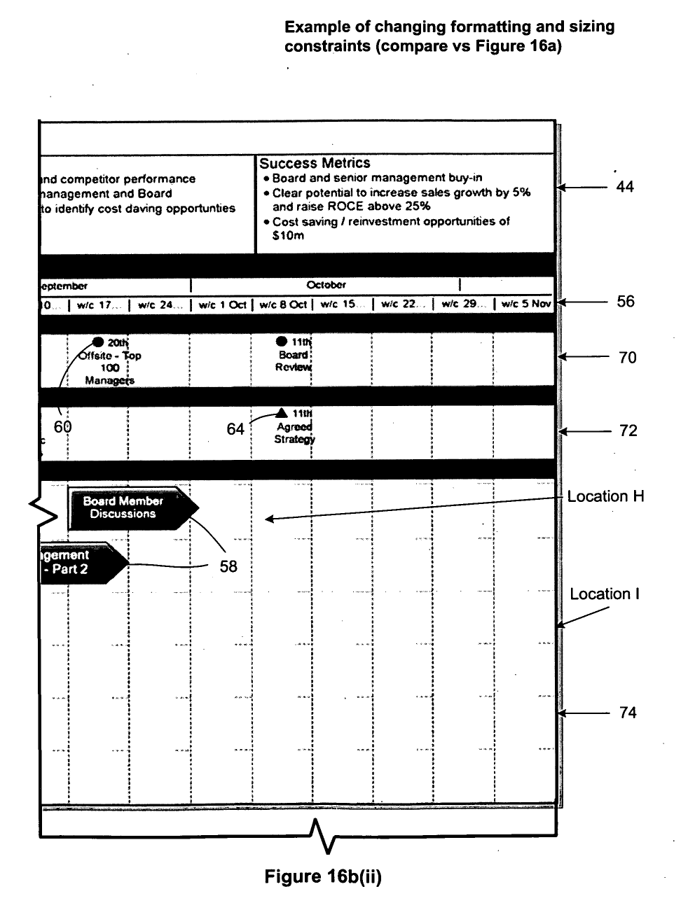

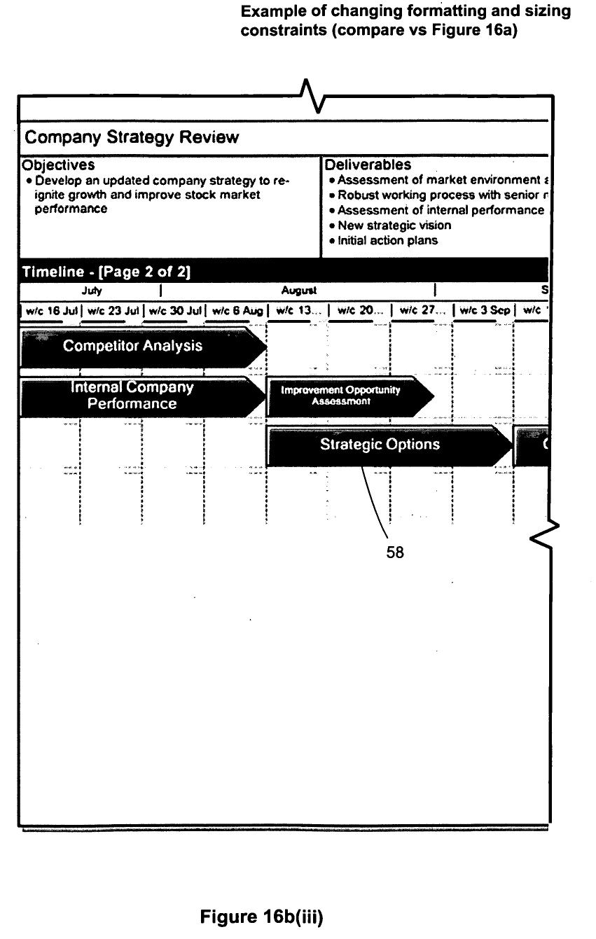

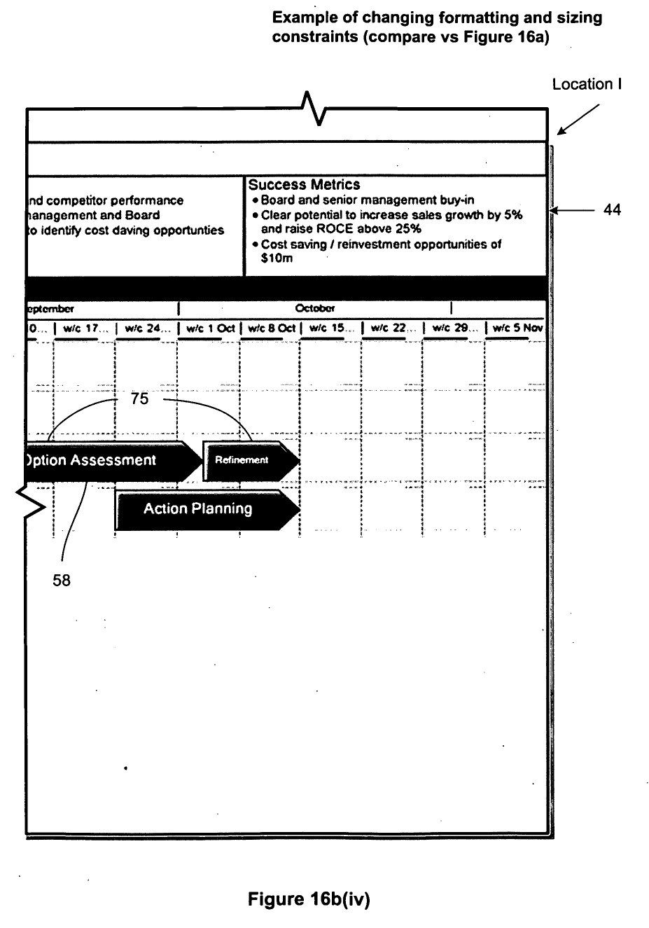

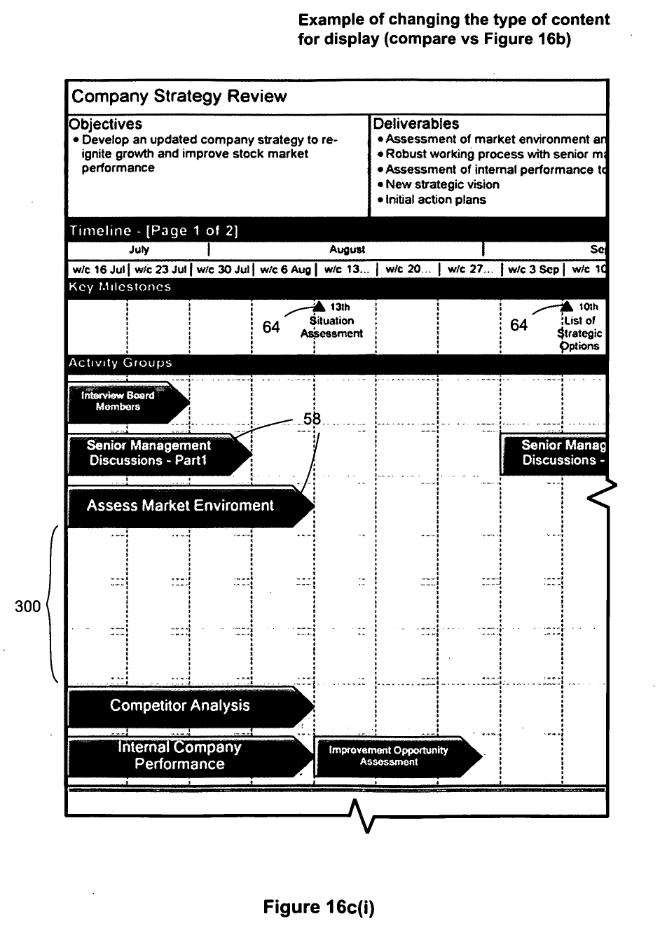

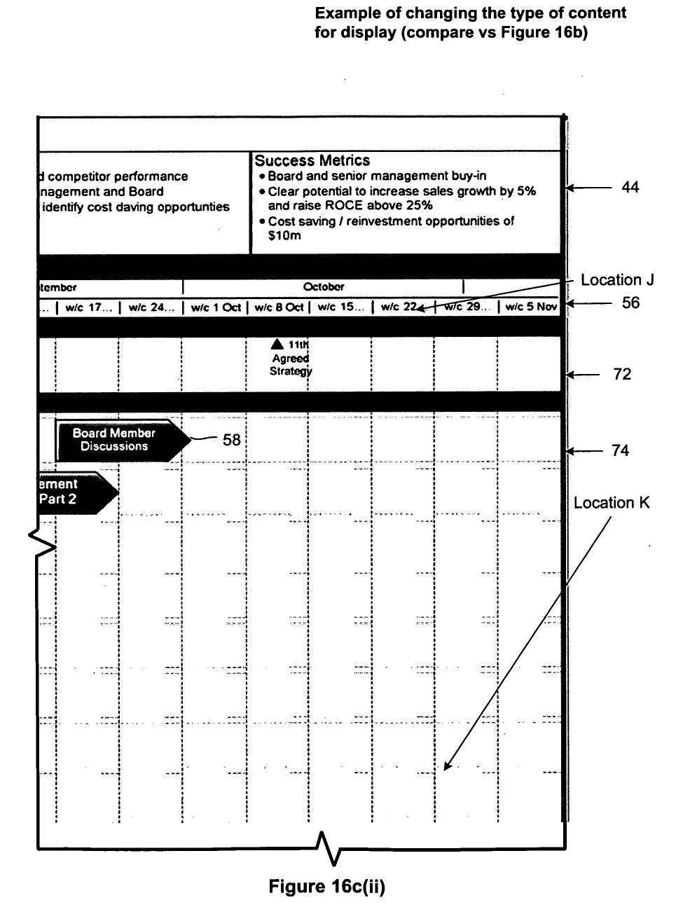

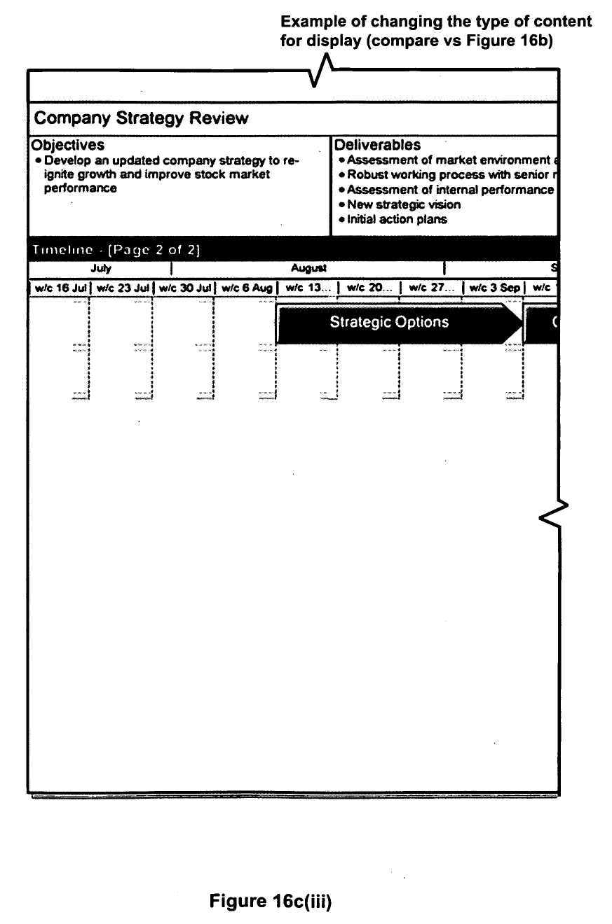

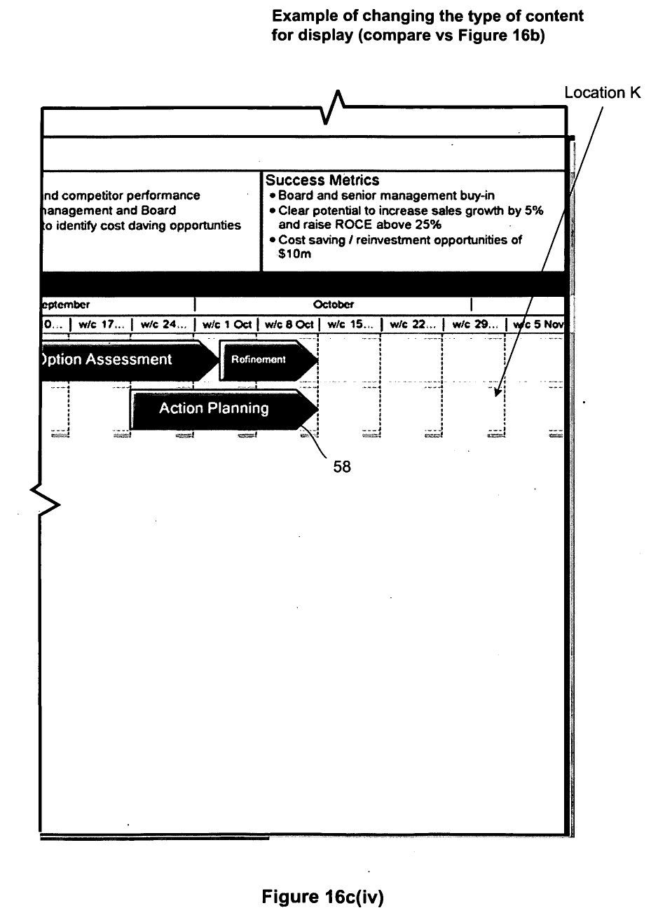

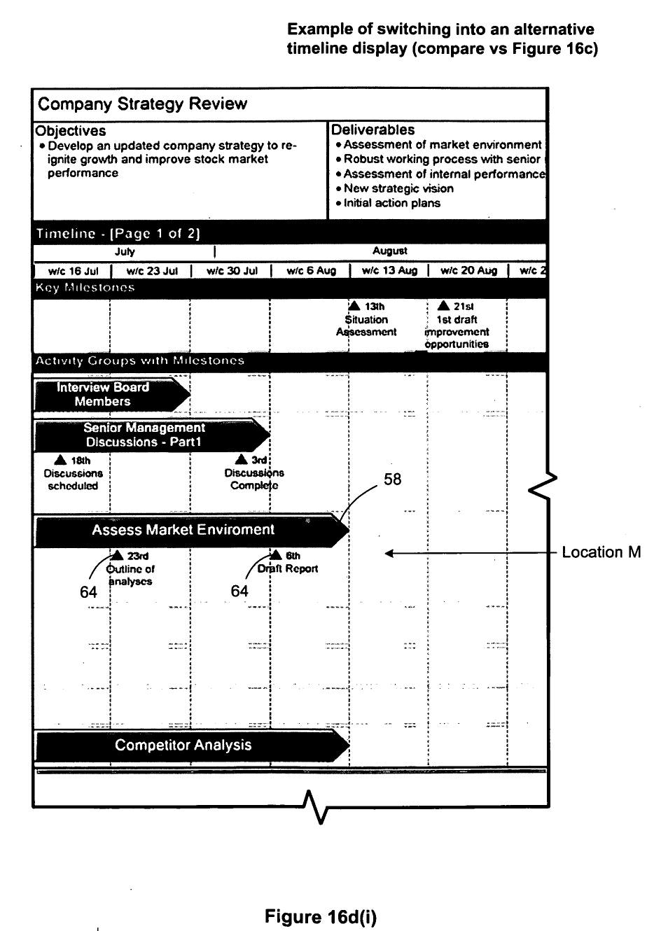

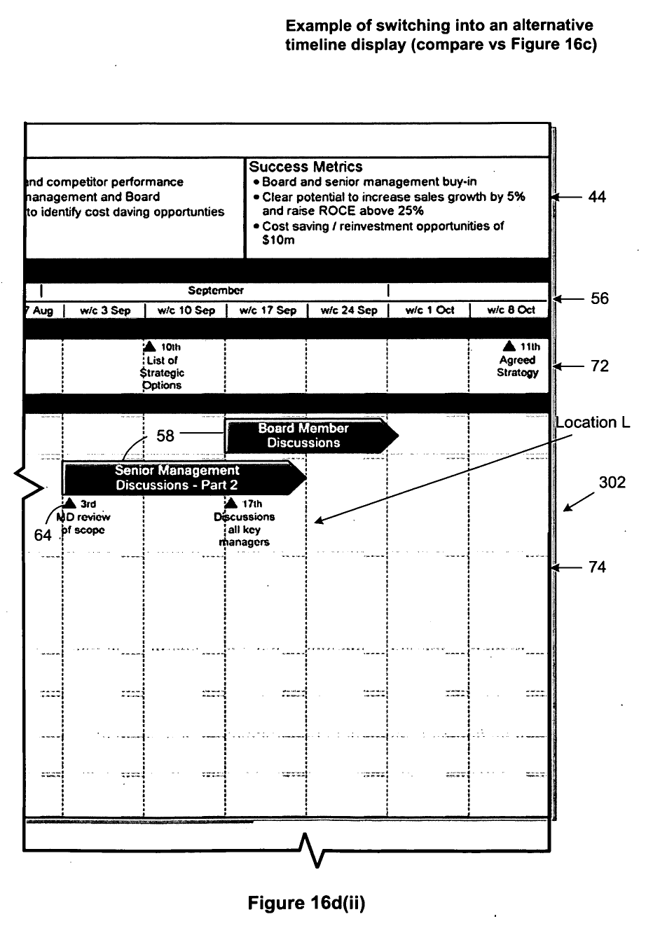

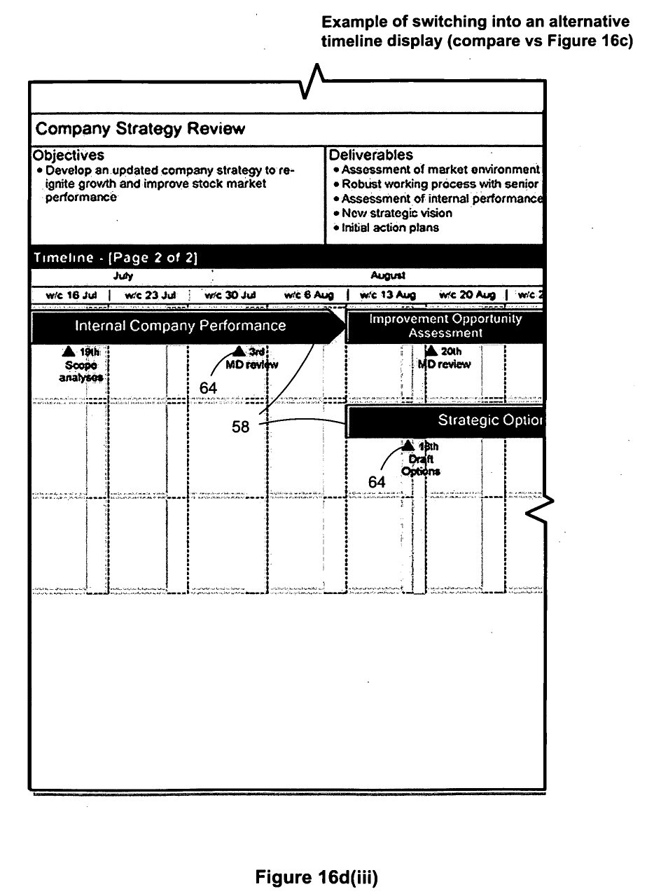

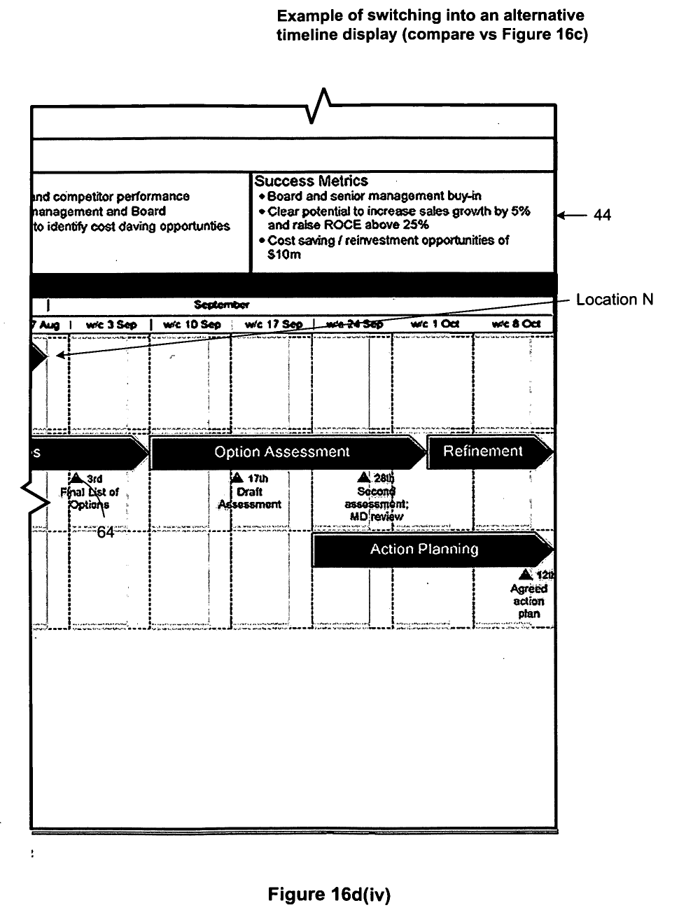

Considering the components displayed in FIG. 15c, if the user deletes the graphical component of the milestone event 64 associated with the “1st draft improvement opportunities” at Location D, then there is no longer a problem about clashing with the adjacent graphical component of the “Situation Assessment” milestone 64, and so only one row is required under the milestones section 72. Therefore, the presentation module 144 reduces the size of the milestone section 72 as can be seen at Location F in FIG. 16a.

This also has the effect of increasing the available space for the Activity Groups section 74 within the page 52. As a result, the DFA 280 in the pagination helper module 150 recalculates the size of each Activity Group row such that the activity row graphical components each have increased heights to fill the available space evenly as is shown at Location G. Also the font size 75 within each Activity Group graphical component 58 is increased proportionately.

In addition to adding and removing content, the user can also influence the way in which the presentation module 144 displays information in other ways as is described below.

A user can change the minimum and maximum size constraints of the graphical components. By way of example, referring to FIG. 16a, the set of Activity Group graphical components 58 displayed are sized to fit onto a single page 52. If the user, in an effort to make the Activity Group components 58 easier to see, increases the minimum size constraint of these graphical components so that, for example, the minimum vertical size of the Activity Group graphical components 58 exceeds the amount permitting all the graphical components 58 to be displayed on one page, then the DFA of the presentation module 144 reformats the layout of the graphical components 58 over two (or more) pages. Specifically in this example, the presentation module 144 calculates that two pages are necessary to accommodate the graphical components, and then, distributes the graphical components over these two pages, as can be seen in FIG. 16b. Here the height of each of the Activity Group components 58 and the size of the font 75 within each component has increased as shown at Location H. The two pages have similar formats with the height of the Activity Group components 58 being identical across both pages as shown at Location I. The heights of the components are determined using the constraints and the page content, as has been described before.

Another way that the user can influence the behaviour of the presentation module 144 is by choosing whether display regions, dedicated to accommodating particular graphical components types (e.g. associated with Key Milestones and Activity Groups event types), are revealed or hidden. For example, a user can choose to hide the first display region 70 associated with the Key Meeting event types. Doing so increases the available space on the page 52 for the other display regions, such as the third display region 74 accommodating Activity Group components 58. As can be seen when comparing FIGS. 16b and 16c, hiding the first display region 70, at Location J, means more of the graphical components associated with the Activity Groups 58 can fit onto the first page 52. More specifically, as can be seen at Location K, the presentation module 144 has determined that two more rows of the Activity Group section can be accommodated on Page 1, and therefore two Activity Group rows are moved from Page 2 to Page 1. Therefore there are more Activity Group rows in Page 1 and less in Page 2 as compared to that of FIG. 16b.

Yet another way in which the user can influence the behaviour of the presentation module 144 is by selecting an alternative presentation configuration. For example, as shown in FIG. 16d, an interlaced mode configuration 302 (described in detail later) displays content additional to that which is shown in FIG. 16c in that the graphical components of milestone event items 64, which are linked to the individual Activity Group event items, are shown, for example at Location L, alongside the respective graphical component 58 of the Activity Groups. In this case, the presentation module 144 has created the space for the graphical components 64 of the milestone event items (i.e. including the icons, date and label text) to be displayed on rows adjacent to the Activity Group graphical components 58 and shrunk the height of the Activity Group graphical components 58 as shown at Location M. Also the presentation module 144 has ensured that the Activity Group graphical components 58 and the associated milestone graphical components 64 appear adjacent to one another on the same page (see Location N), and divided the Activity Group and milestone graphical components between the first and second pages, in this case pushing an additional row onto Page 2.

There are a plurality of alternative presentation configurations. Generally, each of the alternative presentation configurations interlace relatively low-level information into the high-level timeline view module 110, for example interlaced information may include: Activity Group milestones 64, meetings 60, milestones 64 and meetings 60 together, Activity Group objectives, critical questions, deliverables, success metrics, budget and comments.

Examples of how such low-level information may be interlaced with the high-level information are now described with reference to FIGS. 17a, 17b, 17c, 17d and 17e. In FIG. 17a, a standard timeline 304 is shown for the purposes of comparison. This displays a page header 44, key meetings 60 and milestones 64 (although in this example Key Meetings 60 are not selected for display), and the Activity Groups 58. This can be considered to be the top level of the display hierarchy.

When the user selects the timeline interlaced with milestones view 306, as shown in FIG. 17b, the presentation module 144 changes the timeline display to show within the Activity Group section the milestone icons 64 which are linked to the individual activity groups. More specifically, as can be seen at Location O, the milestone icons 64 with their associated text 64a are displayed interlaced between the activity group graphical components 58. This gives the user an important editable display 302 with important information further down the hierarchy. It is to be appreciated that whilst the presentation module 144 has determined that the content needs to be displayed over two pages, FIG. 17b only shows the first page.

FIG. 17c shows another interlaced view (timeline interlaced with meetings) 308 which can be selected by the user. Here at location P, the timeline display shows the meetings 60 that are linked to individual activity groups 58, with the meeting icons 60 and associated text 60a being interlaced between the activity group graphical components 58. This also gives the user an important editable display with important information further down the hierarchy. It is to be appreciated that whilst the presentation module 144 has determined that the content needs to be displayed over two pages, FIG. 17c only shows the first page.

When the user selects the timeline interlaced with meeting and milestones view 310, as shown in FIG. 17d, the presentation module 144 changes the timeline display to show within the Activity Group section, the milestone icons 64 and meeting icons 60 which are linked to individual activity groups 58. More specifically, as can be seen at Location Q, both the meeting icons 60 with their associated text 60a and the milestone icons 64 with their associated text 64a, are displayed interlaced between the activity group graphical components 58 to which they relate. This gives the user an important integrated and editable display with this important information further down the hierarchy. It is to be appreciated that whilst the presentation module 144 has determined that the content needs to be displayed over two pages, FIG. 17d only shows the first page 52.

FIG. 17e shows another interlaced view (timeline interlaced with deliverables) 312 which can be selected by the user. Here at location R, the timeline display shows the deliverables that are assigned to individual activity groups, with the deliverable text box 312 being provided adjacent to the associated activity group component 58, interlaced between the activity group graphical components 58. This also gives the user a view that they can use for creating editing or displaying the specific deliverables of each activity group within the timeline view. Again the provision of this information from different parts of the information hierarchy on a single screen. It is to be appreciated that whilst the presentation module 144 has determined that the content needs to be displayed over two pages, FIG. 17e only shows the first page.

Other possible interlaced views relating to the display of activity group objectives, critical questions, success metrics, budget etc, take the same graphical format as that described in FIG. 17e. Accordingly, these displays do not need to be described further.

A user can select alternative presentation configurations via the page body format button 40, via the toolbar 32, or by dragging and dropping a meeting 60 or milestone 64 into an Activity Group 74 when in the timeline view module 110.

Another feature of the present embodiment, is its ability to provide a configurable view of data relating to a lower level timeline function. This feature is now described with reference to FIGS. 18, 19a and 19b.

The Action List Over Time module 116 offers a variety of different “display modes”, which allow the user to vary how data from the lower level “Activity Group Detail” is displayed. This display of data is similar to a cross-tab query on the underlying data with the data displayed in the GUI 14 allowing both clear display and simple editing of the data, and the addition of new data as required. The Action List Over Time display 320 can be changed on two dimensions to give a number of different “display modes”.

The first dimension relates to the time period for the display. Here there are three options:
a. Four week display: each column 322 represents a week (shown in FIG. 18);
b. One week display—five days: each column 322 represents a day (typically Monday to Friday);
c. One week display—even days: each column 322 represents a day of the week.

The second dimension relates to data grouping. There are two options here:
a. Show data by its Activity Group;
b. Show data by the person/contact responsible for the action, meeting or milestone.

The examples set out in FIGS. 18, 19a, and 19b illustrate these options:

In FIG. 18, the Action List Over Time 320 is displayed with a four-week display ordered by Activity Group. In this example, the display shows all of the meetings 60, milestones 64 and actions 58 (for example at Location S), that are associated with a particular activity group. The display is ordered by activity group (see left hand column) 324, such that the relevant actions etc., can be linked to their key associated activity. The due date 326 and person responsible 328 is also shown for each meeting 58, milestone 64 and action 60 as illustrated at Location T. Also in this view, four weeks of data are shown per page with each column 322 representing a week. In the example shown in FIG. 18, two vertical pages are required to display the content required for the eight-week time period selected for display.

In FIG. 19a the Action List Over Time 320 is displayed with a four-week display ordered by person/contact. Here again the display shows all of the meetings 60, milestones 64 and actions 58, that are associated with a particular person/contact. The display is ordered by person 330 (see Location U—left hand column), so that a group of users making up a team can see who is required to do what action by which date. Again four weeks of data are shown per page with each column 322 representing a week. In this example, only one page is required to show all of the content.

In FIG. 19b the Action List Over Time 320 is displayed with a one week display (five days) ordered by Activity Group. Here the display has been configured to show only one week of data per page, with each column 322 representing a day (see Location V). As with the example shown in FIG. 18, the display shows all of the meetings 60, milestones 64 and actions 58 which relate to individual activity groups and accordingly are ordered by activity group as can be seen at Location W. In this particular example, there are only two items due, a board meeting and a situation assessment milestone. Both of these items are due on Monday 13^{th} August. Furthermore, FIG. 19b only shows one page though other pages for other weeks could be generated.

In each of the above view modes, the user can review or amend data, create new data and scroll left/right or up/down to look at different pages of the view.

The user can select the view mode for the Action List Over Time 320 in a variety of ways. Firstly, the user could select this view through using the page body format dialogues 38, 40 accessed by clicking on the appropriate arrow icon to the left of the view. Also it is possible to use the corresponding short-cut icon in the toolbars; finally when already in the Action List Over Time 320 for the four week display, by double clicking on the date at the top of the column 322 to get into the one week view for that date.

The page display module 142 in the Action List Over Time module 116, identifies which display mode has been selected by the user. The page display module 142 then works with the pagination helper module 150 to pass the relevant data to the data viewer object 146 for the Action List Over Time module 116, which then renders the pages to the screen 12.

The most significant benefit of this function is that it allows quick and easy tailoring of the data display for different audiences and situations, and has the ability to edit/add data in these different situations. For example:
a. The four week display by Activity Group can create clarity for the team and for over-seeing managers on what has to happen over the next few weeks.
b. The four week display by person is useful in a team context or in a one to one meeting to focus on the specific tasks and deliverables of each individual.

The one week display by person or by Activity Group allows a drill into a shorter time period when a day-by-day focus is required.

In summary, the presentation module 144 and its dynamic formatting process provide the project management application 16 with a number of benefits as is highlighted when comparison with other known applications are made. For example, if a user were using PowerPoint® to create a timeline, the user would have to do all the formatting which is both distracting and time consuming. And if the user decides to update/amend a PowerPoint® timeline by adding more weeks onto the project timeline, or adding more rows to accommodate new activities, they would have to individually move and format multiple objects which can be hugely time consuming. Also PowerPoint® does not have any facility to use the data behind the graphical components to perform scheduling calculations, as is key with project management applications 10.

If the user were using Microsoft Excel® to create a timeline for example, they would again have to do all the formatting and they could be concerned about how to fit it best to a page for printing or review.

If the user were using Microsoft Project® for example, content does not automatically fit to the screen or the page so it is harder to see the whole picture as the user is working. Users tend to plan in Microsoft Project® for example and then determine how to use the output for communication, or develop separate documents in PowerPoint® for communication purposes.

In general, the project management application 16 allows the user to switch quickly between displaying different kinds of information on the timeline (and in other modules) to facilitate their review of the data or to facilitate communication with different audiences, and always have the content displayed in a way that fits the page/screen and that can easily be printed or exported.

An automated report-generating feature of the project management application 16 is now described.

The project management application 16 is arranged to automatically generate reports about the status of a project. This is the function of the status reports module 128, 88. The items being reported about can be event items, and so it is possible to automatically generate reports about events falling within specified timeframes because the event items that are stored in the database 158 have a date, or date range associated with them.

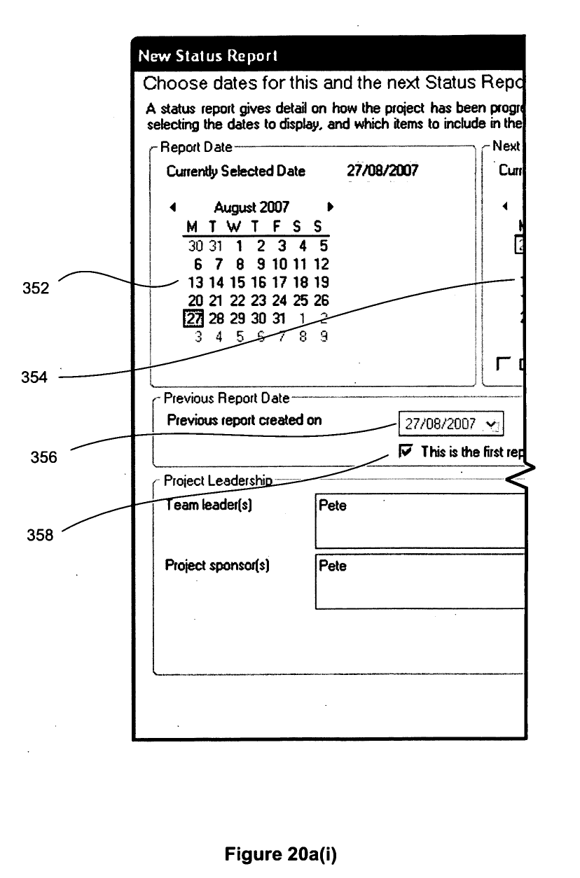

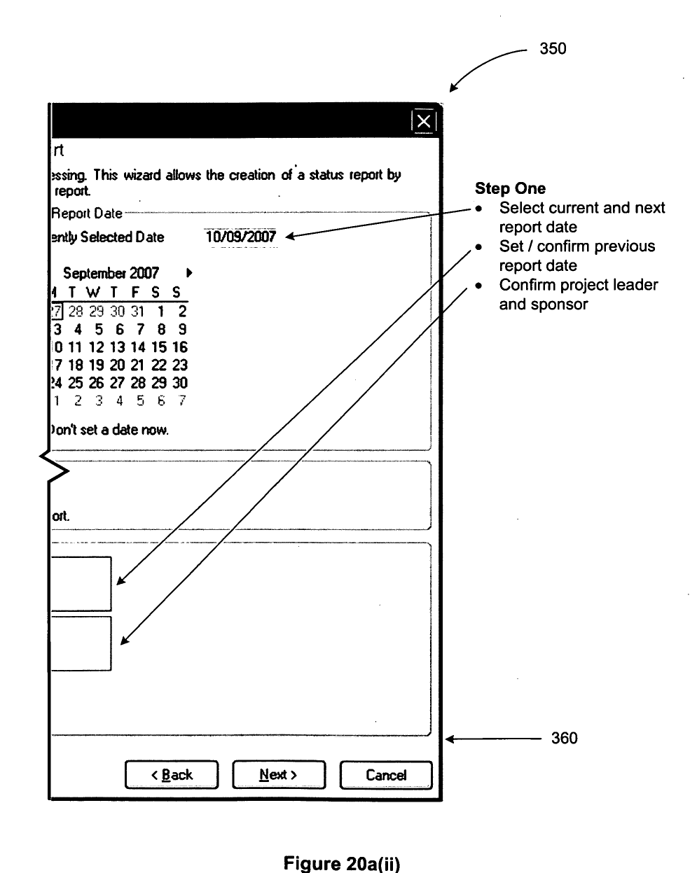

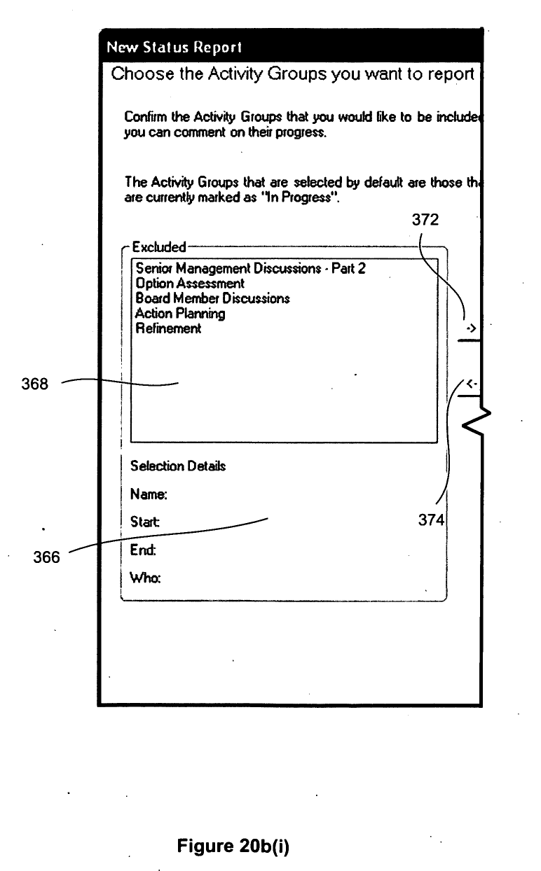

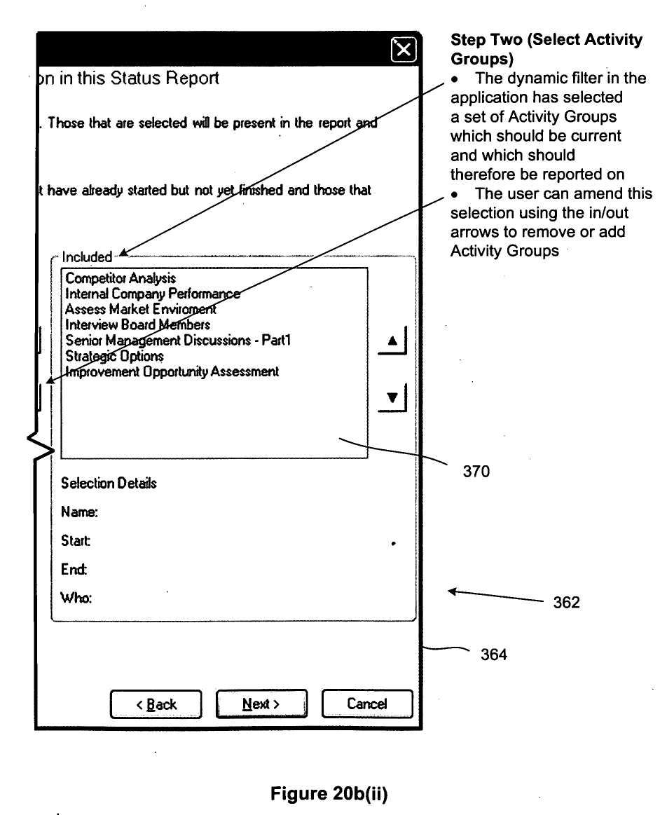

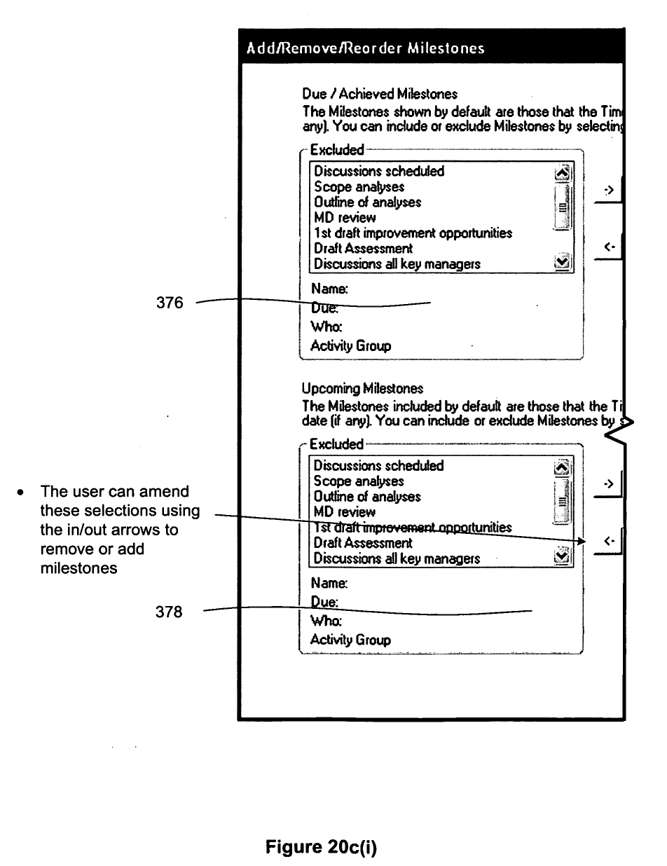

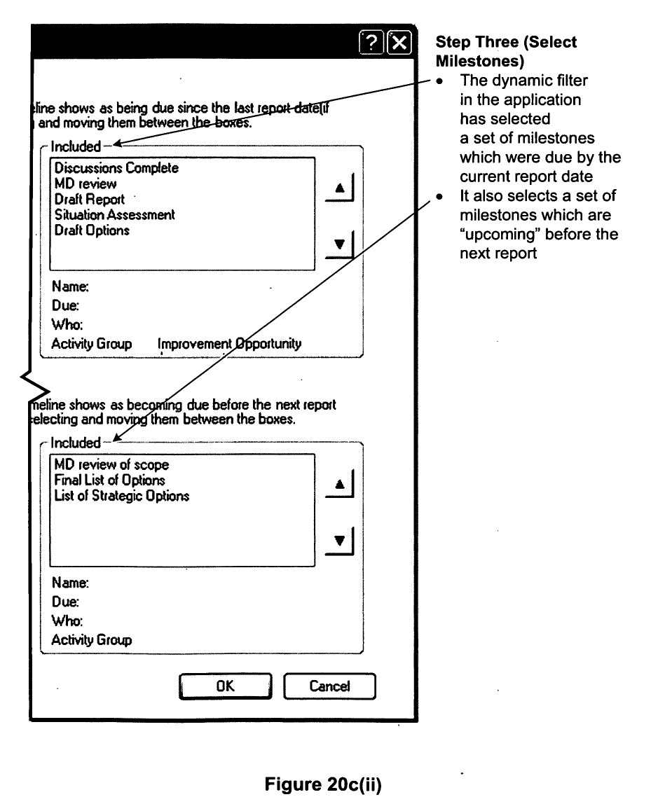

Referring to FIG. 20a, the interface module 152 is arranged to display to the user a date range selection module 350. The date range selection module 350 comprises a first calendar module 352 for inputting the current report date, a second calendar module 354 for inputting the next report date and a previous report date selector 356 which can be activated or deactivated via user selection of a first report tick box 358. The date range selection module 350 also comprises other fields in which to confirm a team leader and project sponsor, and control buttons 360 as are known in the art.

In use, a user selects the dates for the current and next report dates via the respective calendar modules 352, 354. If no previous reports have been generated, then the user disables the previous report date selector 356 by ticking the first report tick box 358. In such a case, a report is generated, as described below on only one report date range delimited by the current and next report dates—denoted as reporting window ‘B’.

If there has been a previous report generated (for example, on the second or subsequent time a report is generated for a project) then the interface module 152 queries the database 158, determines when this occurred and suggests this as the date displayed in the previous report date selector 356. Advantageously, this minimises the user time having to remember and input this date. If, however, the user desires a different previous report date, then the user can set this via the previous report date selector 356. The date range delimited by the previous and current report dates is denoted as reporting window (timeframe)‘A’.

Once reporting window ‘B’ and possibly reporting window ‘A’ have been confirmed by the user activating one of the appropriate control buttons 360, the information is passed to a list generator 362 (event item selector). The list generator 362, then queries the database 158 for event items having an event date, or an endpoint of an event date range falling within one of the two reporting windows A or B.

The list generator 362 comprises an event item filter 364 which is arranged to present the user with options to select or deselect certain event items before a report is generated.

Referring to FIG. 20b, the event item filter 364 comprises a first selection screen 366 which is arranged to display Activity Group event items which the user can select or deselect. The first selection screen 366 comprises an excluded list panel 368 and an included list panel 370. The first selection screen 366 also comprises an inclusion control button 372 and an exclusion control button 374.

Listed in the included list panel 370 are Activity Group event items that have been retrieved from the database 158 which have a date range endpoint falling within reporting window A. All other Activity Group event items are listed in the excluded list panel 368. The user can move Activity Group event items listed in the excluded list panel 368 to the included list panel 370 by clicking on the inclusion control button 372, and can move Activity Group event items from the included list panel 382 to the excluded list panel 368 by clicking on the exclusion control button 374.

Referring to FIG. 20c, the event item filter 364 also comprises a second selection screen 376 in which due/achieved milestone event items can be selected/deselected, and a third selection screen 378 in which upcoming milestones 64 (occurring in window B) can be selected/deselected in the same way as described in respect of the first selection screen 366.

In the second selection screen 376, the milestone event items that are automatically selected by the event item filter are those which have an event date falling within reporting window A. In the third selection screen 378, the milestone event items that are automatically selected by the event item filter are those which have an event date falling within reporting window B.

Once a user is happy with the selections, the list generator 362 then generates a report about the selected event items. It is often the case that the user will not change the automatically selected events (activity groups and milestones 64) and for the report to be generated without any user action whatsoever.

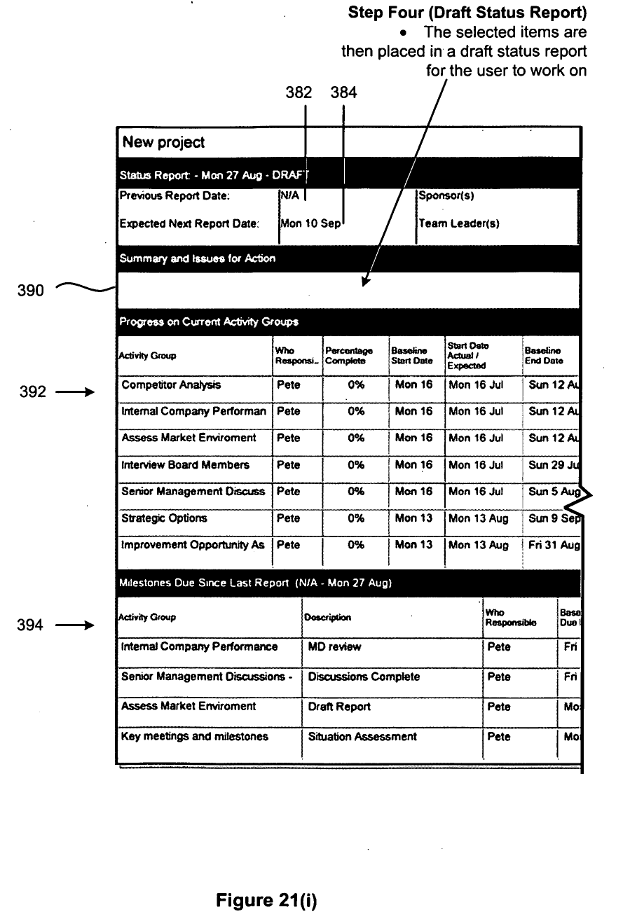

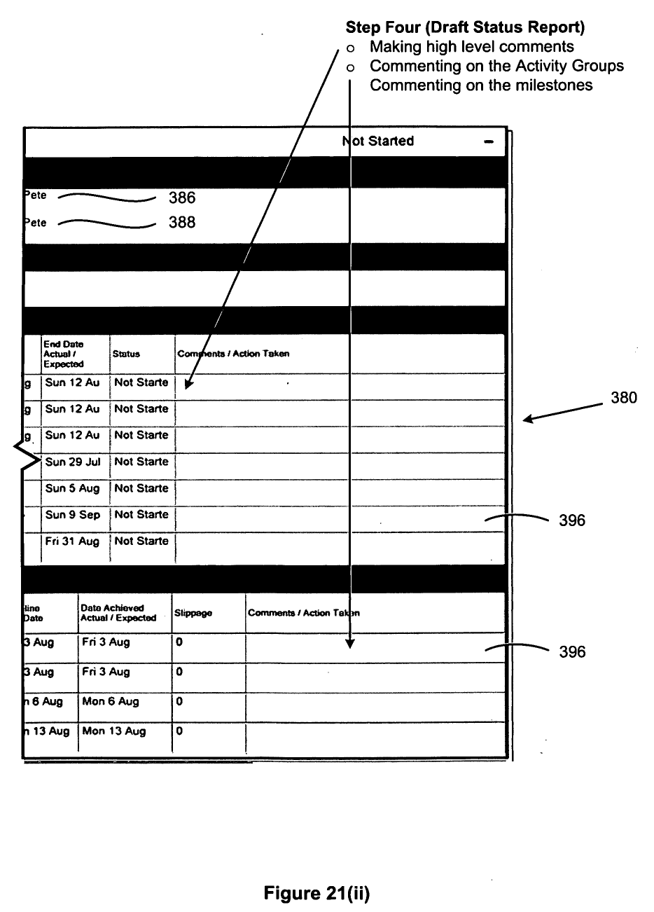

Referring to FIG. 21, the selected items are listed in a draft report 380, and against, which the user can record further comments. The status report 380 sets out the information derived from the data input screen 362 of FIG. 20a, namely the previous report date 382, next expected report date 384, the sponsor 386 and the team leader 388. An editable section 390 is provided for summary and issues for action. The next section 392 sets out the progress on current activity groups and lists the activity, the responsible person, the percentage completion, the base start date, the actual or expected start date, the baseline end date, the expected or actual end date, and the status of each listed event. Also a comments field 396 is provided for each activity group event.

The last section 394 lists row-by-row the milestones due since the last report. In each row, the following information is provided: the activity group to which the milestone relates, its description, the responsible person, the baseline due date, the actual or expected completion date, and the amount of time slippage. Also a comments field is provided for each milestone event 396.

When the report 380 is finalised, any changes the user has made to Activity Group or Milestone start/end dates, status or percentage completion are automatically fed back into the rest of the application 16 and the Timeline and other views are updated accordingly.

Forthcoming milestones can also be displayed as a separate section of the report, though this is not shown in FIG. 21.

The arrangement of the draft report is managed by the presentation module 144 using the dynamic formatting process 250 as described above.

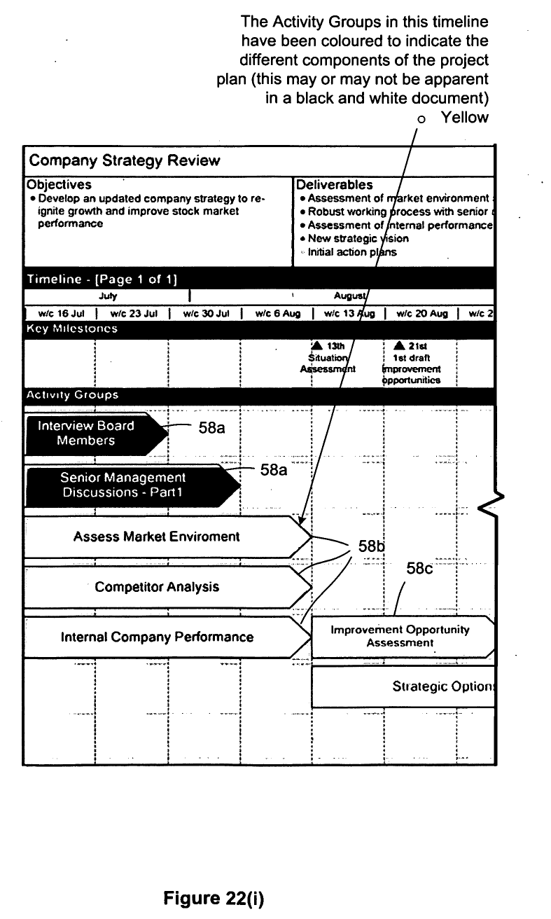

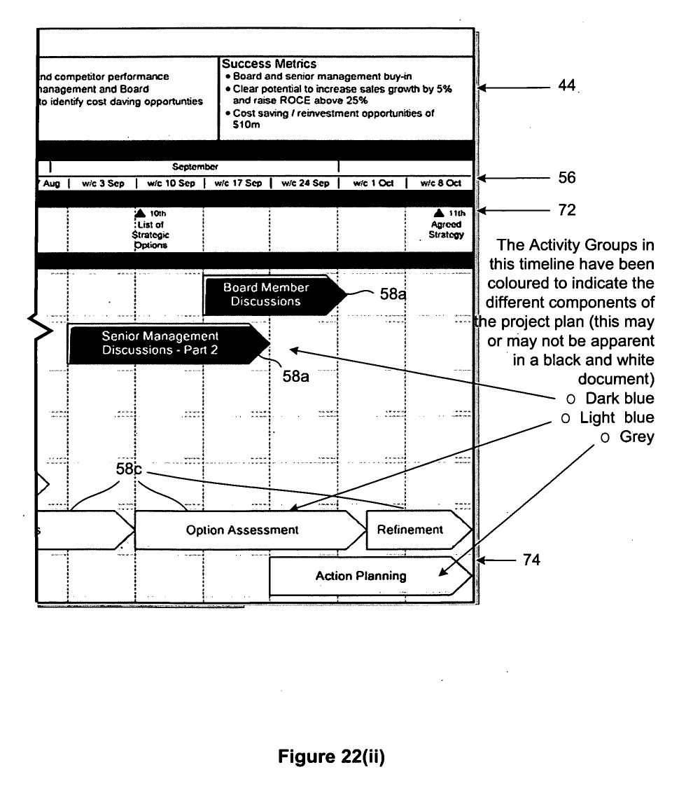

An image-processing feature of the project management application 16 is now described with reference to FIGS. 22 to 24.

When graphical components 30 are generated to represent different event items, different colours may be used to distinguish between different types of event items. On a colour display 12, a user has no problems in distinguishing between the different graphical components. However, there can be problems when trying to generate an output of that display image for a printer for example.

Referring to FIG. 22, Activity Group graphical components 58 are coloured when displayed on the GUI 14 (even though shown in black and white in this document) to indicate the different components of a project plan. Specifically, the Activity Group graphical components 58a labelled “Interview Board Members”, “Board Member Discussions”, “Senior Management Discussions—Part 1” and “Senior Management Discussions—Part 2” are filled with a dark blue colour. The Activity Group graphical components 58b labelled “Assess Market Environment”, “Competitor Analysis” and “Internal Company Performance” are filled with a yellow colour. The Activity Group graphical components 58c labelled “Improvement Opportunity Assessment”, “Strategic Options”, “Option Assessment” and “Refinement” are filled with a light blue colour. Finally, the Activity Group graphical component 58d labelled “Action Planning” is filled with a grey colour.

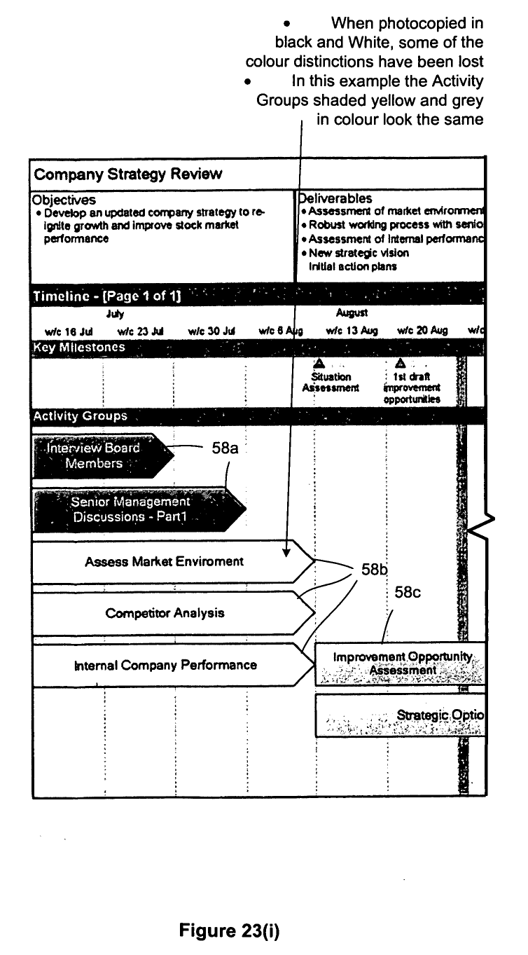

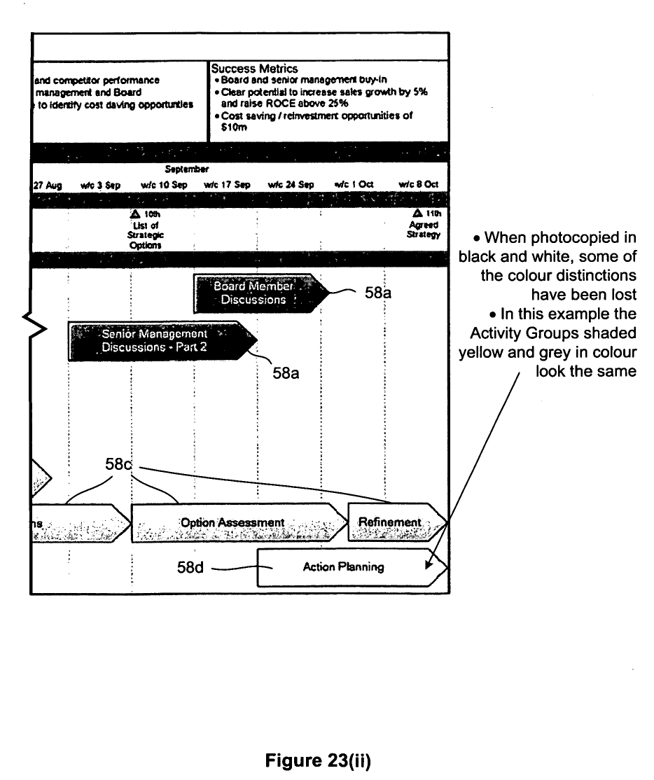

If FIG. 22 is been printed on a monochrome printer 22, or has been photocopied via a monochrome photocopying machine, the graphical components 58b, 58d that are meant to be filled with the yellow and grey colours will have virtually indistinguishable greyscale fills as shown in FIG. 23.

To aid distinguishing between such graphical components 58, the output module comprises a conversion module (not shown) arranged to convert each coloured region of each graphical component 58 into a corresponding monochrome (typically black and white) pattern. Each individual monochrome pattern represents a separate colour, or set of similar colours, and so different colours are represented by easily distinguishable monochrome patterns.

This is readily achieved by means of a look-up (printing conversion) table of colours and shading patterns (not shown but stored in database 50). Here each component fill colour in the application has a dedicated entry into the table to a pre-defined monochrome shading pattern (graphical fill pattern) or shade of grey fill colour. In use, the replacement graphical fill pattern for the graphical component to be displayed can be looked up in the predetermined printing conversion table and substituted for the fill colour. Thus, when the user selects the option of ‘print (or export) with monochrome shading’, the data viewer object 146 redraws the page substituting the associated monochrome options obtained from the printing conversion table for the colours of the image and then sends the output to the print/export sub-routine.

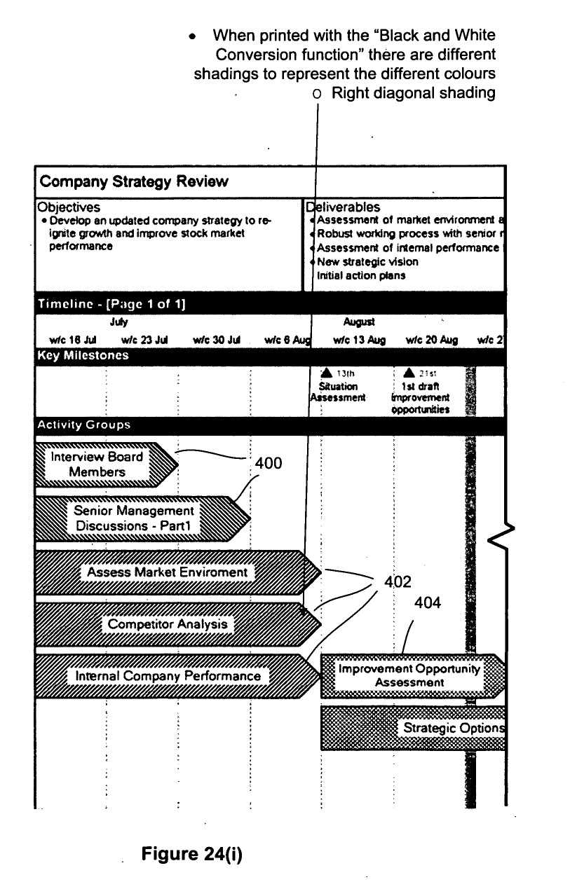

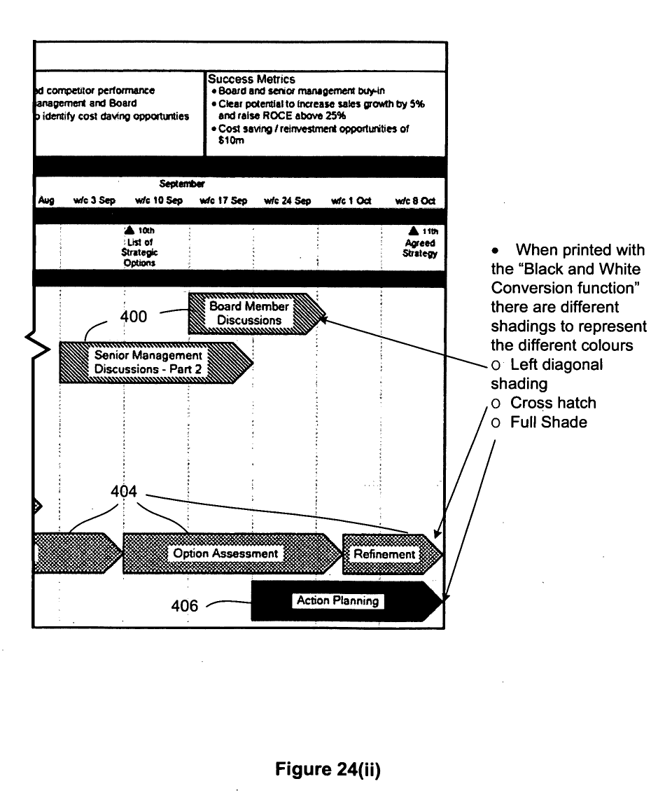

For example, referring to FIG. 24, the dark blue fill of the Activity Group graphical components 58a is converted to left diagonal hatching 400, the yellow fill of the activity components 58b is converted to right diagonal hatching 402, the light blue fill of components 58c is converted to cross hatching 404 and the grey fill of components 58d is converted to full shading 406.

Therefore, whenever the output module is used to transmit selected output pages containing graphical components thereon as a data file (for example for printing via the print module, or exporting to a PDF, PowerPoint® or GIF file) the user has the option of activating the conversion module to convert each coloured region of each graphical component 30 into a corresponding monochrome pattern.

An example of how some of the different features of the present embodiment can be used is now described in the following example of a user usage situation. More specifically, the following example situations illustrate how the software and these functions might be used, and found useful, in real life:

1) A manager is asked by his/her superiors to produce a plan for a new product launch:
a. The manager opens the application and starts with the timeline module. They start by adding the project objectives, deliverables and measures of success in the page header.
b. They then go the page body section of the timeline, extend the date range to six months, and put down a series of activities across the six rows that are available. They also put in some high level milestones and meetings in the key meetings and milestones section of the page.
c. They look at the overall page and decide they need more space to add more activities. They insert three more lines for Activity Groups and the DFA keeps the content all on one page.
d. They then remember some specific tasks around project setup (the first Activity Group in the plan), and go into the Activity Group detail module to detail these tasks.
e. They then go back to the timeline module to see if the overall plan looks good and has all the main elements they want.

In this process, the application has used several of the above described functions to make life easier and better for the manager:
a. The Hierarchical View on a Page GUI function. This allowed them to add and see both the high level objectives, deliverables and success metrics and the main activities in one “big picture” view in the timeline module.
b. The Dynamic Resizing GUI function. This kept everything on the one page as they added content and inserted three new lines on the timeline, making like quick and easy for the manager—they did not have to worry about formatting, only about capturing the content they wanted for their plan.
c. The Multiple Information Level Configurable GUI function. When the manager worked in the Activity Group Detail module, this allowed him/her to add the detailed tasks for Project Setup in this module and keep them separate from the higher level information in the timeline module.

2) The manager reviews the plan with his/her superiors and gets further input, using the application “real time” as a tool to help get this done:
a. They want to add another month to the timeline. This is done and the DFA continues to keep the timeline content all on one page.
b. They then want to look at deliverables and milestones for the key Activity Groups and switch into the interlaced timeline mode to add this level of detail.
c. This leads them to adjust the timing of some of the activities, with the DFA keeping the content well displayed on the page(s) in both the interlaced and standard timeline modes.

In addition to the functions already noted above, the software has used the “Multiple Configurable View relating to Lower Level Timeline” function, to allow the manager and their boss to view, create and edit lower level information relating to the Activity Groups, without losing sight of the higher level timeline. This has allowed them to move between a “big picture” view and a lower level of detail with ease and to focus on certain output focused elements of the underlying activities (e.g. deliverables, milestones) without getting lost in too much detail.

3) The manager has a kick off meeting with the project team.
a. They use the meeting module to create the agenda which they then email out;
b. They print off the timeline with monochrome hatching, and make photocopies for the team.
c. They review the high-level timeline with the team, and then go to the Action List over Time four-week display to look specifically at what needs to be done for some of the shorter term deadlines. They add actions and responsibilities and ensure everyone knows what is expected.

In this process, the application software has used several of the above described functions to make life easier and better for the manager (in addition to ones already mentioned in 1 and 2 above), namely:
a. The Meeting Module function;
b. The Configurable View of Data Relating to Lower Level Timeline—Action List over Time function; and
c. Monochrome Printing Conversion function.

4) A couple of weeks later, the manager has a meeting with the team to review progress and then sends the first project status report to his/her superiors:
a. During the meeting they take minutes and at the end, save the actions back into the project plan (using the Meeting Module function).
b. After the meeting they create a status report. In working through the dialogues to create the draft status report, the application uses the Dynamic Filtered Reporting function, which suggests which Activity Groups and milestones should be reported on, and the project manager uses these suggestions to create a draft status report very quickly. They go on to complete a short status report and email it out, saving the status report to the project file.

Overall, the application and the various above described functions are saving the project manager time and giving them good tools for managing different audiences and situations and improving communication, all in an easy-to-use package.

Having described particular preferred embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example, whilst the modules which have been described above appear to be distinct, they are to be considered functional. Thus in software, these modules could readily be merged in different ways to form desired combined functionality. This is not described further as it would be within the scope of the skilled addressee's knowledge.

Furthermore, there are a variety of ways the above described functions can be implemented, in addition to the one described above (which is for a desktop PC/laptop software system):

The software, or some of its components, could be run on a client server with a “thin client” on remote terminals (either PCs or dumb terminals).

Alternatively, the software, or some of its components, could be run as a web-based system and accessed via a web-browsers.

It would also be possible for components, either individually or in combination, to be deployed in “stripped down” systems with a narrower range of functionality than described above. For example:
a. A “Timeline only” product could be developed using the “Dynamic Formatting Algorithm” to deliver easy-to-create, high-quality Timelines for planning and communication with teams, management and other audiences.
b. An “Objectives and Timeline” product could be developed using the Timeline and the “Dynamic Formatting Algorithm”, and the Objectives and Scope view. This would be a product focused on the “high-level direction” of the projects without the underlying detail of who has to do what by when.

Other combinations are also possible, for example:
a. Timeline and action list functionality only;
b. Timeline and action list functionality combined with the Meeting Agenda and Minutes function.

Components could also be deployed as part of:
a. A “project portfolio” product which would “add up and integrate key information from different, separate project files to deliver a view, or set of views on the portfolio of projects.
b. A “viewer” which would allow individuals who did not have a full version of the application to still look at the data or views.

What is claimed is:

1. A Graphical User Interface (GUI) for use in project management, the GUI comprising:
an interface module arranged to receive low-level user information relating to project events and high-level information relating to at least one project overview attribute; and
a page generation module arranged to generate on a single hierarchical display page of the GUI:
a structured detailed view portion for displaying editable project details within a data compilation with the low-level event-related user information represented as graphical components within the data compilation; and
a management overview portion for displaying an editable project overview with the high-level information provided therein.

2. A GUI according to claim 1, wherein the page generation module is arranged to display any user-determined changes to the high-level information independently of the displayed low-level information.

3. A GUI according to claim 1, wherein the page generation module is arranged to display any user-determined changes to the low-level information independently of the displayed high-level information.

4. A GUI according to claim 1, wherein the page generation module is arranged to generate an action list in the structured detailed view portion of the single hierarchical display page.

5. A GUI according to claim 1, wherein the page generation module is arranged to generate an action list over time in the structured detailed view portion of the single hierarchical display page.

6. A GUI according to claim 4, wherein the action list describes the action, a user responsible for the action, a due date and the status of the action.

7. A GUI according to claim 1, wherein the page generation module is arranged to generate an issue log, listing important project management issues, in the structured detailed view portion of the single hierarchical display page.

8. A GUI according to claim 1, wherein the data compilation comprises a timeline and the low-level event-related user information is represented as graphical components along the timeline.

9. A GUI according to claim 1, wherein the data compilation represents a detailed element list and the low-level event-related user information is represented as individual rows or columns within the list.

10. A GUI according to claim 1, wherein the at least one project overview attribute comprises an element taken from the group of elements comprising an objective, a critical question, a deliverable, a measure of success, a risk, a priority and a budget figure.

11. A GUI according to claim 1, wherein the at least one project overview attribute comprises a plurality of different project overview attributes.

12. A GUI according to claim 11, wherein the plurality of different project overview attributes comprise an objective, a deliverable and a measure of success.

13. A GUI according to claim 1, wherein the graphical components represent project activities.

14. A GUI according to claim 8, wherein the graphical components represent project activities and the size and positioning of the graphical components along the timeline indicates the timing and duration of the activities.

15. A GUI according to claim 8, further comprising a portion of the timeline which is dedicated to key milestones and the page generation module is arranged to displays key milestone graphical components uniquely identifying key milestones.

16. A GUI according to claim 8, further comprising a portion of the timeline which is dedicated to key meetings and the page generation module is arranged to display key meeting graphical components uniquely identifying key meetings.

17. A GUI according to claim 1, wherein each graphical component comprises a text portion.

18. A GUI according to claim 1, wherein the page generation module is arranged to enable user-configurable graphical formatting of the detailed view portion independently of user-configurable graphical formatting of the management overview portion.

19. A GUI according to claim 1, wherein the GUI is arranged to display two different GUI pages sequentially, with each page concerning a different data compilation, the page generation module being arranged to generate on each hierarchical display page of the GUI:
a different structured detailed view portion expressing a related data compilation; and
a consistent management overview portion for displaying the same high-level information as the editable project overview.

20. A Graphical User Interface (GUI) arranged to receive user information and display graphical components corresponding to the received user information, the GUI comprising:
a page display module for displaying at least one page, each page being directly representative of a corresponding output page and comprising a plurality of existing graphical components;
an interface module arranged to receive user information generated by user interaction with the GUI; and;
a presentation module arranged, in response to the received user information, to generate new graphical components to be displayed on the at least one page and to size and arrange the new and existing graphical components in a display configuration on the at least one page, the presentation module being arranged to:
calculate a minimum number of pages required to accommodate the new and existing graphical components to be displayed in the display configuration, the graphical components having size attributes at a chosen minimum limit; and
set the size attributes of the new and existing graphical components from between the minimum limit and a chosen maximum limit to maximise the space occupied by the graphical components on the calculated minimum number of pages;
wherein the page display module is further arranged to display all the graphical components with the size attributes, determined by the presentation module, on the minimum number of pages.

21. A GUI according to claim 20, wherein the presentation module and the page display module are arranged to generate the new components and display all the graphical components, in real-time, in response to the interface module receiving the user information.

22. A GUI according to claim 20, wherein the presentation module and the page display module are arranged to generate the new graphical components and display all the graphical components, as an automated response to the interface module receiving the user information.

23. A GUI according to claim 20, wherein the interface module is arranged to receive user information having user-defined numerical attributes and in response thereto to generate corresponding graphical components each having a graphical attribute corresponding to the numerical attribute of the received information.

24. A GUI according to claim 23, wherein the interface module is arranged to enable user-manipulation of graphical components to create the user-defined numerical attribute.

25. A GUI according to claim 23, wherein the numerical attribute is representative of time.

26. A GUI according to claim 23, wherein the numerical attribute is representative of height or width of a graphical component.

27. A GUI according to any of claims 23, wherein the graphical user interface comprises a timeline.

28. A GUI according to claim 27, wherein the graphical attribute corresponds to position along the timeline.

29. A GUI according to claim 20, further comprising a relational database arranged to store the received user information according to the user-defined numerical attributes.

30. A GUI according to claim 20, wherein the graphical components comprise two-dimensional images.

31. A GUI according to claim 20, wherein the graphical components are able to be manipulated along first and/or second transversely extending axes.

32. A GUI according to claim 31, wherein the graphical attribute of at least one of the graphical components comprises the length of the graphical component along the first axis.

33. A GUI according to claim 31, wherein the size attribute of at least one of the graphical components comprises the length of the graphical component along the second axis.

34. A GUI according to claims 31, wherein the graphical components are sizable along the first axis in response to a user-defined numerical attribute and the visual arrangement of the graphical components along the second axis is controlled by user input.

35. A GUI according to claim 20, further comprising means for enabling the user to set the size attributes.

36. A GUI according to claim 20, wherein the size attributes are represented as a percentage of the available space on a page.

37. A GUI according to claim 20, wherein the presentation module is arranged to continuously size and arrange graphical components in response to user-inputted information.

38. A GUI according to claim 20, further comprising an output module arranged to transmit selected output pages containing the first set of graphical components thereon in the display configuration as a data file for processing external to the GUI, wherein the data file stores a representation of the output pages that is in exact proportion to the image generated by the display means.

39. A GUI according to claim 38, wherein the output module comprises a print module arranged to transmit print instructions to a printer to print out the selected output pages.

40. A GUI according to claim 20, wherein at least two of the pages displayed by the page display module comprise a formatting scale equal to one another.

41. A GUI according to claim 20, wherein the graphical components are one of a plurality of graphical component types, where each component type is graphically distinguishable from another.

42. A GUI according to claim 41, wherein each graphical component type represents a different type of information to be displayed by the GUI.

43. A GUI according to claim 41, wherein each graphical component type represents an event type, for example, an Activity Group, a meeting, a milestone, an action, an issue or a contact.

44. A GUI according to claim 41, wherein the presentation module is arranged to allocate an individual display region for each graphical component type.

45. A GUI according to claim 44, wherein each display region is distributed along the length of the timeline.

46. A GUI according to claim 20, wherein the interface module comprises a controller arranged to receive control input from a user and, in response thereto, to pass information to other modules to control the display of each display region.

47. A GUI according to claim 46, wherein the controller is arranged to hide or reveal selected display regions.

48. A GUI according to claim 20, wherein the interface module comprises a view selector arranged to receive a user view selection and to present a view of a selected set of graphical components corresponding to a selection of the user inputted information.

49. A GUI according to claim 48, wherein the view selector is arranged to present a plurality of views.

50. A GUI according to claim 49, wherein the plurality of views are arranged in a hierarchy with at least one view being a generalised view, and another view being a specific view, and wherein the generalised view is of a selected set of graphical components corresponding to a selection of user inputted information relating to general information and the specific view is of a selected set of graphical components corresponding to a selection of user-inputted information relating to information specific about selected general information.

51. A GUI according to claim 50, wherein the interface module is arranged to receive only user information relating to general information when in the generalised view.

52. A GUI according to claim 50, wherein the interface module is arranged to receive only user information relating to a specific selection of the general information.

53. A GUI according to claim 20, wherein one or more of the graphical components comprise a view selector.

54. A GUI according to claim 53, wherein the graphical component represents an item of general information and comprises a view selector which, when selected, triggers the page display module to generate a new page comprising a set of graphical components corresponding to specific information associated with the item of general information.

55. A Graphical User Interface (GUI) arranged to receive user information about events and display graphical components relating to the user information, the GUI comprising:
a page display module arranged to display one or more pages, each page having a uniform predetermined dimension and comprising a timeline extending along a first axis;
an interface module arranged to receive the user information relating to events having a time-related attribute; and
a presentation module arranged to:
generate graphical components corresponding to the received user information;
position and size the graphical components along the timeline in dependence on the time-related attribute, and
determine the position and size of the graphical components along a second axis, in dependence on the number of graphical components and predetermined minimum and maximum size constraints associated with each of the graphical components so that the graphical components occupy maximum space within the one or more pages without exceeding their respective minimum and maximum size constraints.

56. A Graphical User Interface (GUI) for use in project management, the GUI comprising:
an interface module arranged to receive user information relating to project events and user GUI control commands;
a page generation module arranged to generate, on a first display page of the GUI, a timeline portion for displaying an editable project management timeline with the event-related user information represented as graphical components along the timeline; and
an expanded detailed view module arranged to detect user-selection of a particular graphical component along the timeline via the interface module and to generate, for display on a second new display page relating to the specific event of the selected graphical component, an expanded timeline relating to the selected event and detailed user information items relating to the event not previously displayed by the first page.

57. A GUI according to claim 56, wherein the expanded detailed view module is arranged to display within the second page a structured detailed view portion for displaying editable project details within a data compilation.

58. A GUI according to claim 57, wherein the expanded detailed view module is arranged to display within the data compilation the status of each event.

59. A GUI according to claim 57, wherein the data compilation represents a detailed element list with individual event information represented as individual rows or columns within the list.

60. A GUI according to claim 56, wherein the expanded detailed view portion comprises a list of project event details.

61. A GUI according to claim 56, wherein the expanded detailed view module is arranged to generate different graphical components representing different types of project events and to display the components at appropriate positions along the timeline.

62. A GUI according to claim 57, wherein the expanded detailed view module is arranged to display editable project details for each different project event with the displayed data compilation.

63. A GUI according to claim 56, wherein the graphical components represent project activities.

64. A GUI according to claim 63, wherein the size and positioning of the graphical component along the timeline indicates the timing and duration of the activities.

65. A GUI according to claim 56, further comprising a portion of the expanded timeline for displaying key milestones and the presentation module is arranged to displays key milestone graphical components uniquely identifying key milestones.

66. A GUI according to claim 56, further comprising a portion of the expanded timeline of displaying key meetings and the presentation module is arranged to display key meeting graphical components uniquely identifying key meetings.

67. A GUI according to claim 56, wherein each graphical component comprises a text portion.

68. A Graphical User Interface (GUI) for use in project management, the GUI comprising:
a displaying module arranged to display a plurality of different options for selecting a desired display view;
an interface module arranged to receive a user-selected option for a desired display view;
a database storing information regarding a plurality of different types of events, each type of event having a time-related attribute;
a presentation module arranged to use the selected option to construct the selected display view from the stored information and to display the view; the view comprising one or more pages with each page including a timeline and graphical components representing the type of events related to the selected display view positioned along the timeline in dependence upon the time-related attribute.

69. A GUI according to claim 68, wherein the display module is arranged to display a plurality of icons, each icon relating to a particular selectable display view.

70. A GUI according to claim 68, wherein the presentation module is arranged to construct a plurality of different views, each having a different timeline scale.

71. A GUI according to claim 68, wherein the selected desired display view acts as a user-determined cross-tab query on the stored information to provide an efficient manner of selecting the information to be displayed in the display view.

72. A GUI according to claim 68, wherein the presentation module is arranged to display the timeline along one axis and another type of stored information related to the selected display view along a second axis.

73. A GUI according to claim 72, wherein the other type of stored information comprises one of the group comprising an activity group, a meeting, a milestone, an action and a person responsible for the action.

74. A GUI according to claim 68, further comprising editing means arranged to enable user editing of the graphical components and for updating the corresponding information stored within the database.

75. A GUI according to claim 68, wherein the presentation module is further arranged to position graphical components of different types of event in an interlaced manner along the second axis.

76. A GUI according to claim 68, wherein the presentation module is arranged to position graphical components relating to different types of event adjacent each other when the specific components of the different types of event are linked together as a pair of components, with pairs of components having overlapping time-related attributes being interlaced with each other.

77. A Graphical User Interface (GUI) for use in project management, the GUI comprising:
a page display module arranged to display one or more pages, each page comprising a timeline extending along a first axis;
an interface module arranged to receive user information relating to a plurality of different types of events, each type of event having a time-related attribute, and to generate graphical components corresponding to the received user information and identifying each of the plurality of different types of event; and
a presentation module arranged to position the graphical components along the timeline in dependence on the time-related attribute, and also to position the graphical components along a second axis to avoid overlap of components having overlapping time-related attributes,
wherein the presentation module is further arranged to position graphical components of different types of event in an interlaced manner along the second axis.

78. A GUI according to claim 77, wherein the presentation module is arranged to position graphical components relating to different types of event adjacent each other when the specific components of the different types of event are linked together as a pair of components, with pairs of components having overlapping time-related attributes being interlaced with each other.

79. A GUI according to claim 77, wherein the plurality of different types comprises at least three different types of event and the GUI further comprises a selection means for selecting which types of event are to be displayed by the page display module and the presentation means in an interlaced manner.

80. A GUI according to claim 79, wherein the selection means acts as a user determined cross-tab query on the received user information, to provide an efficient manner of selecting data to be displayed.

81. A GUI according to claim 77, wherein one of the plurality of types of component relates to an activity group.

82. A GUI according to claim 77, wherein one of the plurality of types of component relates to a meeting or a milestone.

83. A GUI according to claim 77, wherein the graphical components relating to one type of event comprise a text box interlaced with the other selected graphical components.

84. A GUI according to claim 83, wherein the text box graphical components relate to one of the group comprising: activity group objectives, critical questions, project deliverables, success metrics, budget, and comments.

85. A GUI according to claim 83, wherein the user interface module is arranged to enable the text box graphical components to be edited by the user and for the edited text to be stored within a component database.

86. A Graphical User Interface (GUI) for use in project management, the GUI comprising:
a page display module arranged to display one or more pages;
an interface module arranged to receive a plurality of user information items relating to project meetings and user GUI control commands;
a presentation module arranged, to operate with the interface and display modules, to generate on a first display page a meeting agenda template or a minutes template for recording the information user items relating to project meetings, each template having a plurality of predefined regions for recording each different user information item; and
recordal means for recording the plurality of information items to a database model, wherein the recordal means is arranged to map the information item recorded at each different predefined region to a corresponding predefined portion of the data model.

87. A GUI according to claim 86, wherein the presentation module in generating a minutes template is arranged to list a plurality of predetermined agenda points and to present a subset of the plurality of predefined regions in positional correspondence with each of the displayed agenda points.

88. A GUI according to claim 87, wherein the user information items comprise decision items taken in relation to specific agenda points.

89. A GUI according to claim 87, wherein the user information items comprise new user-determined events in relation to specific agenda points, which arise from the meeting.

90. A GUI according to claim 89, wherein the new user-determined events comprise one or more of the group comprising new actions, new meetings and new milestones.

91. A GUI according to claim 87, wherein the user information items comprise a plurality of responsibility items identifying a responsible person for each of a corresponding plurality of user-determined events.

92. A GUI according to claim 87, wherein the user information items comprise a plurality of date items identifying a date of each of a corresponding plurality of user determined events.

93. A GUI according to claim 87, wherein the presentation module is arranged to read the plurality of information items stored in the database model and to generate a new GUI page listing the items as actions.

94. A GUI according to claim 87, wherein the presentation means is arranged to modify the new GUI page to indicate graphically those actions items which have been carried out.

95. A GUI according to claim 86, wherein the presentation module, in generating a meeting agenda template, is arranged to generate a GUI page having a user-editable first portion for listing a plurality of agenda items, wherein the plurality of agenda items are arranged to be used by the presentation module as the agenda points.

96. A GUI according to claim 95, wherein the presentation module is arranged to record the attendees of the meeting and to store this within the data model.

97. A GUI according to claim 95, wherein the presentation module is arranged to display a second portion of identifying information for identifying the meeting itself.

98. A GUI according to claim 97, wherein the identifying information comprises one or more elements taken form the group of elements comprising a meeting date, a meeting purpose, a meeting time, a meeting duration, and a meeting venue.

99. A GUI according to claim 95, wherein the presentation module is arranged to display a plurality of different meeting agendas, each having their own first and second portions on a GUI page.
